(19) United States
(12) Patent Application Publication
(10) Pub. No.: US 2026/0282079 A1
(43) Pub. Date: Sep. 17, 2026

(54) METHOD FOR TRANSMITTING/RECEIVING DATA BY USING TRANSMISSION OPPORTUNITY, AND WIRELESS COMMUNICATION TERMINAL USING SAME

(71) Applicant: WILUS INSTITUTE OF STANDARDS AND TECHNOLOGY INC., Gyeonggi-do (KR)

(72) Inventors: Sanghyun KIM, Gyeonggi-do (KR); Juhyung SON, Gyeonggi-do (KR); Geonjung KO, Gyeonggi-do (KR); Jinsam KWAK, Gyeonggi-do (KR)

(21) Appl. No.: 19/165,120

(22) PCT Filed: Mar. 13, 2024
(86) PCT No.: PCT/KR2024/003208

§ 371 Date: Sep. 13, 2025

(30) Foreign Application Priority Data
Mar. 13, 2023 (KR) 10-2023-0032691
Apr. 13, 2023 (KR) 10-2023-0049037
Jul. 6, 2023 (KR) 10-2023-0087976

(51) Int. Cl. H04W 74/0808; H04W 72/0453

(52) U.S. Cl. CPC H04W 74/0808; H04W 72/0453

(57) ABSTRACT

An operation method and device of a wireless communication terminal are disclosed. Particularly, the wireless communication terminal according to the present invention can perform a first channel access procedure through a specific secondary subchannel included in a specific secondary channel. An entire bandwidth supported by the wireless communication terminal can be composed of one primary channel, and one or more secondary channels which include the specific secondary subchannel. Thereafter, the wireless communication terminal can acquire a first transmission opportunity (TXOP) through the first channel access procedure, and the range on a frequency axis in which the first TXOP is acquired is limited to the specific secondary subchannel.

### TECHNICAL FIELD

The disclosure relates to a method for obtaining a transmission opportunity (TXOP) and occupying a channel to improve efficiency of a wireless LAN.

### BACKGROUND ART

Technology that can provide a rapid wireless Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11n has come into the spotlight. Among them, IEEE 802.11ac supports a wide bandwidth (80 to 160 MHz) in the 5 GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHz), more MIMO spatial streams (a maximum of 8), multi-user MIMO, and high-density modulation (a maximum of 256 QAM). Further, as a scheme that transmits data by using a 60 GHz band instead of the existing 2.4 GHz/5 GHZ, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band.

Recently, discussions on an ultra-high reliability (UHR) wireless LAN communication technology have started to overcome a reliability issue that has been pointed out as limitations of a wireless LAN as a wireless LAN standard subsequent to 802.11be. An ultra-high reliability wireless LAN standard is being developed with a goal of supporting low latency and low jitter in wireless LAN traffic with a high probability (e.g., 99.9999% or more).

### DISCLOSURE OF INVENTION

### Technical Problem

The present disclosure is to provide an ultra-high reliability wireless LAN service for new multimedia applications by strengthening a channel occupation method of a wireless LAN.

Technical tasks to be achieved in the specification are not limited to the technical tasks mentioned above, and other technical tasks that are not mentioned may be clearly understood by those skilled in the art on the basis of the following descriptions.

### Solution to Problem

In a non-access point (AP) multi-link device (MLD) including multiple stations in the present disclosure, a processor is configured to: perform a first channel access procedure through a specific secondary subchannel included in a specific secondary channel, wherein an entire bandwidth supported by the wireless communication terminal includes one primary channel and one or more secondary channels including the specific secondary subchannel; and acquire a first transmission opportunity (TXOP) through the first channel access procedure, wherein a frequency-domain range in which the first TXOP is acquired is limited to the specific secondary subchannel.

In addition, in the present disclosure, the first channel access procedure is performed when a channel state of a primary subchannel included in the one primary channel is busy.

In addition, in the present disclosure, the first channel access procedure is performed when the primary subchannel is occupied by an overlapping basic service set (OBSS) terminal.

In addition, in the present disclosure, the processor is configured to transmit a trigger frame indicating transmission of a frame to one or more terminals through multiple subchannels constituting the specific secondary channel during the TXOP.

In addition, in the present disclosure, when the one or more terminals operate in the one primary channel, the trigger frame indicates a change from the primary channel to the specific secondary channel.

In addition, in the present disclosure, a bandwidth of the specific secondary channel is not supported as an operating bandwidth for the one or more terminals, and the trigger frame includes a field indicating the change from the primary channel to the specific secondary channel.

In addition, in the present disclosure, the processor is configured to receive, from a specific terminal, a frame for sharing a second TXOP, and the second TXOP is acquired through a second channel access procedure of the specific terminal in a primary subchannel included in the one primary channel.

In addition, in the present disclosure, a frequency-domain range in which the second TXOP is acquired is a bandwidth supported by the specific terminal among the entire bandwidth, and end time points of the first TXOP and the second TXOP are identical.

In addition, the present disclosure provides a method including: performing a first channel access procedure through a specific secondary subchannel included in a specific secondary channel, wherein an entire bandwidth supported by the wireless communication terminal includes one primary channel and one or more secondary channels including the specific secondary subchannel; and acquiring a first transmission opportunity (TXOP) through the first channel access procedure, wherein a frequency-domain range in which the first TXOP is acquired is limited to the specific secondary subchannel.

### Advantageous Effects of Invention

An embodiment of the present disclosure provides a wireless communication method for efficiently managing a TXOP and a wireless communication terminal using the same.

According to an embodiment of the present disclosure, a station can share (or transfer) a transmission opportunity (TXOP) acquired by the station to another station.

In addition, according to an embodiment of the present disclosure, a station can allocate a time interval within a TXOP acquired by the station to another station.

In addition, according to an embodiment of the present disclosure, when acquiring an opportunity to acquire a TXOP by a station, the station can support another station to acquire a TXOP.

In addition, according to an embodiment of the present disclosure, a station can perform transmission/reception during a TXOP through handover/transfer of a TXOP acquired by another station.

In addition, according to an embodiment of the present disclosure, a station can attempt TXOP acquisition based on a frame transmitted by another station.

Advantageous effects which can be acquired from the present disclosure are not limited to the above-described advantageous effects, and other unmentioned advantageous effects can be clearly understood by those skilled in the art to which the present disclosure belongs from the description below.

### BRIEF DESCRIPTION OF DRAWINGS

FIG. 1 illustrates a wireless LAN system according to an embodiment of the present disclosure.

FIG. 2 illustrates a wireless LAN system according to another embodiment of the present disclosure.

FIG. 3 illustrates a configuration of a station according to an embodiment of the present disclosure.

FIG. 4 illustrates a configuration of an access point according to an embodiment of the present disclosure.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates various physical layer protocol data unit (PPDU) formats by standard generation according to an embodiment of the present disclosure;

FIG. 8 illustrates an EHT/UHR PPDU format according to an embodiment of the present disclosure;

FIG. 9 illustrates a transmission/TXOP protection method using an RTS frame and a CTS frame according to an embodiment of the present disclosure;

FIG. 10 illustrates a transmission/TXOP protection method using an MU-RTS frame and a CTS frame according to an embodiment of the present disclosure;

FIG. 11 illustrates a format of a trigger frame according to an embodiment of the present disclosure;

FIG. 12 illustrates a format of a Common Info field of a trigger frame according to an embodiment of the present disclosure;

FIG. 13 illustrates a format of a User Info field of a trigger frame according to an embodiment of the present disclosure;

FIG. 14 illustrates an example of a frame exchange sequence performed between STAs during a TXOP according to an embodiment of the present disclosure;

FIG. 15 illustrates an example of a frame exchange sequence in which a STA transfers a right to obtain a TXOP to another STA after completing a backoff procedure according to an embodiment of the present disclosure;

FIG. 16 illustrates an example of a frame exchange sequence for transferring a right to obtain a TXOP after a backoff procedure of an STA and an NAV state of other STAs according to an embodiment of the present disclosure;

FIG. 17 illustrates an example of a format of an initiating frame and a trigger frame according to an embodiment of the present disclosure;

FIG. 18 illustrates an example of TXOP sharing between STAs and a bandwidth (BW) extension procedure according to an embodiment of the present disclosure;

FIG. 19 illustrates an example of a TXOP sharing procedure and a TXOP holder operation of an STA according to an embodiment of the present disclosure;

FIG. 20 illustrates an example of a format for a frame for transferring a right to obtain a TXOP or sharing a TXOP according to an embodiment of the present disclosure; and

FIG. 21 illustrates an example of a method of performing channel access by using a subchannel according to an embodiment of the present disclosure.

FIG. 22 illustrates another example of a method of performing channel access by using a subchannel according to an embodiment of the present disclosure.

FIG. 23 illustrates an example of a method for initiating a channel access procedure by using a subchannel according to an embodiment of the present disclosure.

FIG. 24 illustrates an example of a method for acquiring a transmission opportunity (TXOP) by using a shared TXOP according to an embodiment of the present disclosure.

FIG. 25 illustrates an example of a format of a parameter set element for TXOP sharing according to an embodiment of the present disclosure.

FIG. 26 illustrates an example of configuration and a connection state of an AP MLD and a non-AP MLD according to an embodiment of the present disclosure.

FIG. 27 illustrates an example of an element for sharing a TXOP according to an embodiment of the present disclosure.

FIG. 28 illustrates an example of a frame including an element for sharing a TXOP according to an embodiment of the present disclosure.

FIG. 29 illustrates an example of a response frame format for a frame for TXOP sharing according to an embodiment of the present disclosure.

FIG. 30 illustrates an example of a method for minimizing performance degradation of an overlapping basic service set (OBSS) by the AP when a bandwidth of a shared TXOP is extended according to an embodiment of the present disclosure.

FIG. 31 illustrates an example of an operation of an AP, in which TXOP sharing between APs is performed and BW extension is performed during a shared TXOP according to an embodiment of the present disclosure.

FIG. 32 illustrates an example of an operation of a station according to an embodiment of the present disclosure.

### MODE FOR CARRYING OUT THE INVENTION

Terms used in the specification adopt general terms which are currently widely used by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively.

Hereinafter, in the present disclosure, a field and a subfield may be interchangeably used.

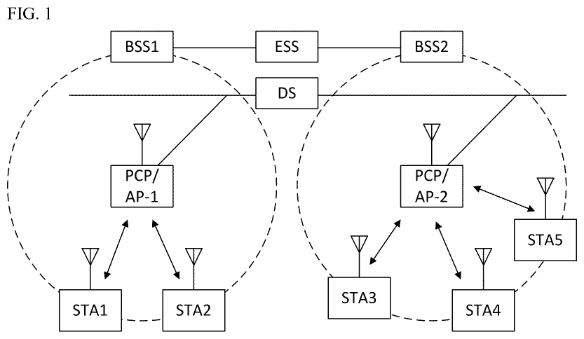

FIG. 1 illustrates a wireless LAN system according to an embodiment of the present disclosure.

FIG. 1 is a diagram illustrating a wireless LAN system according to an embodiment of the present disclosure. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present disclosure, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present disclosure, the AP is used as a concept including a personal BSS coordination point (PCP) and may include concepts including a centralized controller, a base station (BS), a node-B, a base transceiver system (BTS), and a site controller in a broad sense. In the present disclosure, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

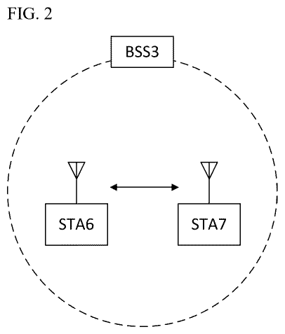

FIG. 2 illustrates an independent BSS which is a wireless LAN system according to another embodiment of the present disclosure. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

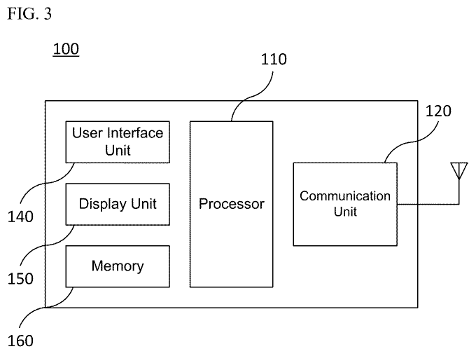

FIG. 3 is a block diagram illustrating a configuration of a station 100 according to an embodiment of the present disclosure. As illustrated in FIG. 3, the station 100 according to the embodiment of the present disclosure may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHZ, 6 GHz and 60 GHz. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present disclosure, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present disclosure may execute various commands or programs and process data in the station 100. Further, the processor 110 may control the respective units of the station 100 and control data transmission/reception among the units. According to the embodiment of the present disclosure, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present disclosure may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present disclosure. A detailed embodiment thereof will be described below.

The station 100 illustrated in FIG. 3 is a block diagram according to an embodiment of the present disclosure, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present disclosure, some components of the station 100, for example, the user interface unit 140 and the display unit 150 may be optionally provided in the station 100.

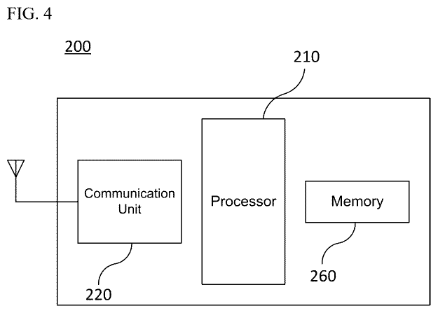

FIG. 4 is a block diagram illustrating a configuration of an AP 200 according to an embodiment of the present disclosure. As illustrated in FIG. 4, the AP 200 according to the embodiment of the present disclosure may include a processor 210, a communication unit 220, and a memory 260. In FIG. 4, among the components of the AP 200, duplicative description of parts which are the same as or correspond to the components of the station 100 of FIG. 2 will be omitted.

Referring to FIG. 4, the AP 200 according to the present disclosure includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present disclosure may include two or more communication modules among different frequency bands, for example, 2.4 GHz, 5 GHZ, 6 GHz and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present disclosure, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present disclosure, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present disclosure. A detailed embodiment thereof will be described below.

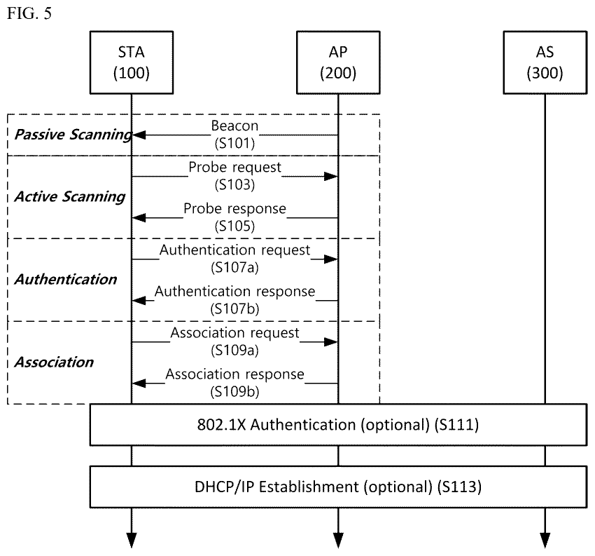

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present disclosure is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

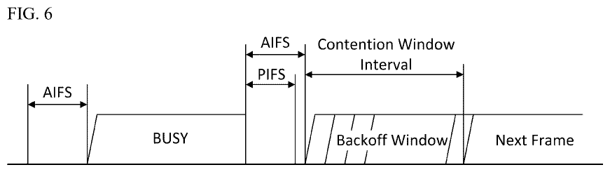

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval. In this case, the random number may be referred to as a backoff counter. That is, an initial value of the backoff counter is configured by an integer corresponding to a random number acquired by the terminal. When the terminal detects that the channel is idle during a slot time, the terminal may reduce the backoff counter by 1. In addition, when the backoff counter reaches 0, the terminal may be allowed to perform channel access in the corresponding channel. Therefore, when the channel is idle for a slot time of the backoff counter or an AIFS time, transmission of the terminal may be allowed.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

### <Examples of Various PPDU Formats>

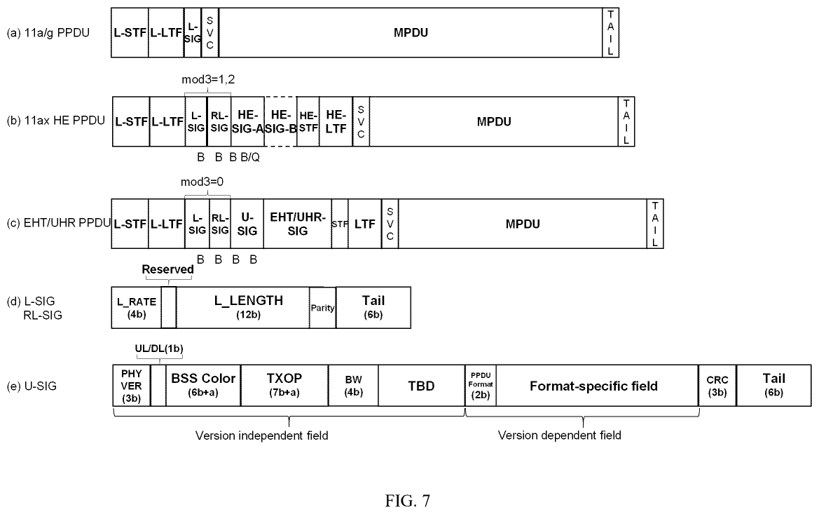

FIG. 7 illustrates various physical layer protocol data unit (PPDU) formats by standard generation according to an embodiment of the present disclosure.

Specifically, FIG. 7(a) illustrates an embodiment of a legacy PPDU format based on 802.11a/g, FIG. 7(b) illustrates an embodiment of an HE PPDU format based on 802.11ax, and FIG. 7(c) illustrates an embodiment of a non-legacy PPDU (i.e., EHT PPDU) format based on 802.11be. In addition, FIG. 7(d) illustrates a detailed field configuration of an L-SIG and an RL-SIG commonly used in the above PPDU formats.

Referring to FIG. 7(a), a preamble of a legacy PPDU includes a Legacy Short Training field (L-STF), a Legacy Long Training field (L-LTF), and a Legacy Signal field (L-SIG). In an embodiment of the present disclosure, the L-STF, the L-LTF, and the L-SIG may be referred to as a legacy preamble.

Referring to FIG. 7(b), a preamble of an HE PPDU further includes a Repeated Legacy Short Training field (RL-SIG), a High Efficiency Signal A field (HE-SIG-A), a High Efficiency Signal B field (HE-SIG-B), a High Efficiency Short Training field (HE-STF), and a High Efficiency Long Training field (HE-LTF) in addition to the legacy preamble. In an embodiment of the present disclosure, the RL-SIG, the HE-SIG-A, the HE-SIG-B, HE-STF, and the HE-LTF may be referred to as an HE preamble. A specific configuration of the HE preamble may be modified according to HE PPDU formats. For example, the HE-SIG-B may be used only in an HE MU PPDU format.

Referring to FIG. 7(c), a preamble of an EHT PPDU further includes an Repeated Legacy Short Training field (RL-SIG), a Universal Signal field (U-SIG), an Extremely High Throughput/Ultra High Reliability Signal A field (EHT/UHR-SIG-A), an Extremely High Throughput/Ultra High Reliability Signal B field (EHT/UHR-SIG-A), an Extremely High Throughput Short Training field (EHT-STF), and an Extremely High Throughput Long Training field (EHT-LTF) in addition to the legacy preamble. In an embodiment of the present disclosure, the RL-SIG, the EHT-SIG-A, the EHT-SIG-B, the EHT-STF, and the EHT-LTF may be referred to as an EHT preamble. A specific configuration of the non-legacy preamble may be modified according to EHT PPDU formats. For example, the EHT-SIG-A and the EHT-SIG-B may only be used in some of the EHT PPDU formats.

A PPDU used in the UHR standard may have a format similar to that of the PPDU used in the EHT standard, because the EHT PPDU format defined in 802.11be includes the U-SIG field that a plurality of wireless LAN generations has agreed to use in common. Here, the value of a PHY Version Identifier field of the U-SIG field included in the EHT PPDU may be 0, and the value of a PHY Version Identifier field of a U-SIG field included in the UHR PPDU may have a non-zero value, for example, 1. The EHT PPDU includes an Extremely High Throughput Short Training field (EHT-STF) in an STF and an Extremely High Throughput Long Training field (EHT-LTF) in an LTF. The UHR PPDU includes an Ultra High Reliability Short Training field (UHR-STF) in an STF and an Ultra High Reliability Long Training field (UHR-LTF) in an LTF.

64 FFT OFDM is applied to the L-SIG field included in the preamble of the PPDU, and the L-SIG field includes a total of 64 subcarriers. Among the 64 carriers, 48 subcarriers excluding a guard subcarrier, a DC subcarrier, and a pilot subcarrier are used for L-SIG data transmission. Since BPSK and a modulation and coding scheme (MCS) with rate=1/2 are applied to the L-SIG, the L-SIG may include a total of 24 bits of information. FIG. 7(d) shows a 24-bit information configuration of the L-SIG.

Referring to FIG. 7(d), the L-SIG includes an L_RATE field and an L_LENGTH field. The L_RATE field includes 4 bits, and indicates an MCS used for data transmission. Specifically, the L_RATE field indicates one value of transmission speeds of Jun. 9, 2012/18/24/36/48/54 Mbps which combine a modulation scheme, such as BPSK/QPSK/16-QAM/64-QAM, and an inefficiency, such as 1/2, 2/3, and 3/4. The total length of the corresponding PPDU may be indicated by combining information in the L_RATE field and that in the L_LENGTH field. In the non-legacy PPDU format, the L_RATE field is configured to a minimum speed of 6 Mbps.

The L_LENGTH field is in a unit of byte, is allocated a total of 12 bits, allowing up to 4095 to be signaled, and may indicate the length of the corresponding PPDU in combination with the L_RATE field. Here, a legacy terminal and a non-legacy terminal may interpret the L_LENGTH field by different methods.

First, a method by which the legacy terminal or the non-legacy terminal interprets the length of the PPDU by using the L_LENGTH field is as follows. When the value of the L_RATE field is configured to indicate 6 Mbps, 3 bytes (i.e., 24 bits) may be transmitted for 4 μs, which is the duration of one symbol of 64 FFT. Therefore, 3 bytes corresponding to an SVC field and a Tail field are added to the value of the L_LENGTH field and then divided by 3 bytes, which is the transmission amount of one symbol, thereby obtaining the number of symbols based on 64 FFT after the L-SIG. The number of symbols obtained is multiplied by 4 μs, which is the duration of one symbol, and then 20 μs required for transmission of the L-STF, the L-LTF, and the L-SIG is added thereto, thereby obtaining the length of the corresponding PPDU, i.e. reception time (RXTIME), which is expressed as Equation 1.

$$RXTIME ( us ) = ( ⌈ \frac{L\_LENGTH + 3}{3} ⌉ ) \times 4 + 20 \qquad [ Equation 1 ]$$

Here, ┌x┐ is a minimum natural number equal to or greater than x. Since the maximum value of the L_LENGTH field is 4095, the length of the PPDU may be configured to a maximum of 5.484 ms. The non-legacy terminal transmitting the corresponding PPDU needs to configure the L_LENGTH field as shown below in Equation 2.

$$L\_LENGTH ( byte ) = ( ⌈ \frac{TXTIME - 20}{4} ⌉ ) \times 3 - 3 \qquad [ Equation 2 ]$$

Here, TXTIME is a total transmission time forming the corresponding PPDU, which is as shown below in Equation 3. Here, TX denotes a transmission time of X.

$$TXTIME ( us ) = {T}_{L - STF} + {T}_{L - LTF} + {T}_{L - SIG} + {T}_{RL - SIG} + {T}_{U - SIG} + ( {T}_{EHT - SIG - A} ) + ( {T}_{EHT - SIG - B} ) + {T}_{EHT - STF} + {N}_{EHT - LTF} \cdot {T}_{EHT - LTF} + {T}_{D A T A} \qquad [ Equation 3 ]$$

Referring to the foregoing equations, the length of the PPDU is calculated based on the rounded-up value of L_LENGTH/3. Therefore, for a random value of k, three different values of L_LENGTH={3k+1, 3k+2, 3 (k+1)} indicate the same PPDU length.

Referring to FIG. 7(e), the Universal SIG (U-SIG) field continues to exist in the EHT/UHR PPDU and a subsequent-generation wireless LAN PPDU, and functions to distinguish the generation of a PPDU including EHT/UHR. In addition, the U-SIG field may function to facilitate spatial reuse of EHT/UHR and subsequent-generation wireless LANs. The U-SIG is two OFDM symbols based on 64 FFT, and may transmit information of a total of 52 bits. Among 52 bits, 43 bits excluding 9 bits of CRC/Tail are largely divided into a Version Independent (VI) field and a Version Dependent (VD) field.

VI bits continue to maintain a current bit configuration henceforth, and thus even through a subsequent-generation PPDU is defined, current EHT/UHR terminals may obtain information about the corresponding PPDU through VI fields of the corresponding PPDU. To this end, the VI field includes PHY version, UL/DL, BSS Color, TXOP, and Reserved fields. The PHY version ID field is 3 bits, and functions to sequentially distinguish EHT/UHR and subsequent-generation wireless LAN standards by version. The PHY Version ID field of the EHT (11be) PPDU has a value of 000b, and the PHY Version ID field of the UHR PPDU has a value other than 000b. The UL/DL field distinguishes whether the corresponding PPDU is an uplink/downlink PPDU. The BSS Color refers to an identifier for each BSS defined in 11ax, and has a value of 6 bits or more. The TXOP refers to transmit opportunity duration transmitted in a MAC header, is added to a PHY header, thus inferring the length of the TXOP including the corresponding PPDU without needing to decode an MPDU, and has a value of 7 bits or more.

The VD field of EHT is signaling information useful only for the PPDU of the 11be version, and may include a field commonly used for any PPDU format, such as a PPDU format and a BW, and a field defined differently for each PPDU format. The PPDU format is an identifier that distinguishes EHT single-user (SU), EHT multiple-user (MU), EHT trigger-based (TB), and EHT extended-range (ER) PPDUs.

The BW field largely signals five basic PPDU BW options (a BW that may be expressed as an exponential form of 20*2 may be referred to as a basic BW) of 20, 40, 80, 160 (80+80), and 320 (160+160) MHz and various remaining PPDU BWs configured through preamble puncturing. Further, signaling may be performed in a form in which signaling is performed via 320 MHZ and then some 80 MHz is punctured. In addition, a channel form modified by puncturing may be signaled directly in the BW field, or may be signaled using the BW field and a field (e.g., a field in the EHT-SIG field) following the BW field together. When the BW field is 3 bits, a total of 8 BWs may be signaled, and thus up to 3 puncturing modes may be signaled. When the BW field is 4 bits, a total of 16 BWs may be signaled, and thus up to 11 puncturing modes may be signaled.

The VD field of UHR is a field that indicates pieces of signaling information useful only for the UHR PPDU. Here, information indicated by each field included in the VD field of the UHR PPDU may be the same as or more extended than information indicated by a field functioning the same as the VD field of EHT (11be). For example, a field indicating a puncturing pattern included in the VD field of the UHR PPDU may indicate more various forms of patterns than a field indicating a puncturing pattern included in the VD field of the EHT PPDU. Alternatively, the field indicating the puncturing pattern included in the VD field of the UHR PPDU may be interpreted in combination with the BW field. Accordingly, more various forms of puncturing patterns may be indicated.

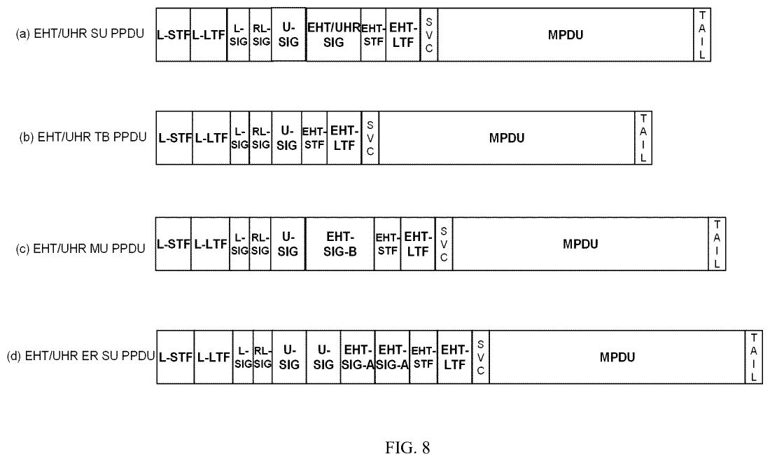

FIG. 8 illustrates an EHT/UHR PPDU format according to an embodiment of the present disclosure.

The EHT/UHR PPDU format may be indicated by a PPDU Format field of a U-SIG field of a PPDU. (a) of FIG. 8 shows an EHT/UHR SU PPDU according to an embodiment of the present disclosure. The EHT/UHR SU PPDU is a PPDU used for single-user transmission between an AP and a single STA, and may include an EHT-SIG-A field for additional signaling after a U-SIG.

(b) of FIG. 8 shows an EHT/UHR trigger-based PPDU according to an embodiment of the present disclosure. The EHT/UHR trigger-based PPDU is an uplink PPDU used for transmission in response to a trigger frame, and may have no separate EHT/UHR-SIG-A field after a U-SIG.

(c) of FIG. 8 shows an EHT/UHR MU PPDU according to an embodiment of the present disclosure. The EHT/UHR MU PPDU is a PPDU used for transmission to one or more terminals. The EHT/UHR MU PPDU format may include an HE-SIG-B after a U-SIG field.

(d) of FIG. 8 shows an EHT/UHR ER SU PPDU according to an embodiment of the present disclosure. The EHT/UHR ER SU PPDU is used for single-user transmission to STAs in an extended range. The EHT/UHR ER SU PPDU format may have a U-SIG repeated on a time axis.

The EHT/UHR MU PPDU illustrated in (c) of FIG. 8 may be used for an AP to perform downlink transmission to a plurality STAs. Here, the EHT/UHR MU PPDU may include scheduling information for the plurality of STAs to simultaneously receive the PPDU. The EHT/UHR MU PPDU may transmit AID information about a receiver or a transmitter of the corresponding PPDU through a user-specific field of an EHT/UHR-SIG-B. A STA receiving the EHT/UHR MU PPDU may perform a spatial reuse operation, based on the AID information obtained from a preamble of the PPDU. More specifically, a resource unit allocation (RA) field of the EHT/UHR-SIG-B may include information about a resource unit (RU) partitioning form in a specific bandwidth (e.g., 20 MHz) in a frequency domain. In addition, information about a STA assigned to each partitioned resource unit may be transmitted through the user-specific field of the EHT/UHR-SIG-B. The user-specific field may include one or more user fields corresponding to each partitioned resource unit.

An AID of the receiver or the transmitter may be inserted in a user field corresponding to a resource unit in which data transmission is performed among a plurality of partitioned resource units. A pre-designated null STA ID may be inserted in a user field corresponding to remaining resource units in which data transmission is not performed.

Two or more PPDUs illustrated in FIG. 8 may be indicated with the same PPDU format. For example, the value of a U-SIG PPDU format subfield indicating the EHT/UHR SU PPDU and the value of a U-SIG PPDU format subfield indicating the EHT/UHR MU PPDU may be the same.

Some of the fields included in the formats of the PPDUs described above or some information of the fields may be omitted, which may be referred to as a compression mode or a compressed mode.

### <Channel Access Method of Wi-Fi Terminal>

Since Wi-Fi terminals (AP, non-AP STA, or the like) perform communication using an unlicensed band, the Wi-Fi terminals identify whether a channel on which the Wi-Fi terminals want to perform transmission is being used by another device before transmitting a frame. Carrier sense multiple access (CSMA) is a channel access method in which a terminal to transmit a packet performs carrier sensing to identify whether a channel is being used by another device and performs transmission only when determining that the channel is not being used (idle) by the other device. Since a terminal using CSMA may perform an operation of not attempting transmission when determining that at least another device is using a medium (channel) (when determining that the channel is busy), transmission already started may be protected from other devices.

However, a plurality of terminals recognizing that the medium is occupied by the other device simultaneously attempts packet transmissions when identifying that occupancy of the medium by the other device terminates (the medium changes to idle), thus experiencing a transmission collision. That is, when a specific terminal attempts to transmit a packet and at the same time a plurality of other terminals attempts packet transmissions together, a terminal that needs to receive the packet transmitted by the specific terminal is unable to properly receive and decode the packet that the terminal needs to receive due to interference caused by the transmissions performed by the plurality of other terminals.

As described above, CSMA with collision avoidance (CSMA/CA) is a channel access mechanism for preventing a plurality of terminals detecting that a medium has changed to be idle from simultaneously attempting packet transmissions. Terminals accessing a medium (channel) by using CSMA/CA wait for a random time and then attempt transmission when the medium that the terminals observe changes to an idle state. The random time may be aSlotTime (generally 9 μs) as long as a random number (random backoff counter) generated by each terminal to attempt transmission. That is, since the terminals accessing the medium by using CSMA/CA attempt transmission after waiting for different random times, the terminals attempt transmission at different times unlike when only CSMA is used. Here, when a specific terminal having waited for the shortest random time attempts transmission first after the medium changes to idle, other terminals may recognize that the medium has been occupied (changed to busy) by the specific terminal and then stop a channel access procedure. Here, the specific terminal may perform an operation of reducing a backoff counter maintained by the specific terminal by 1 every aSlotTime while the medium is maintained idle, and may attempt transmission when the backoff counter becomes 0 or when aSlotTime has elapsed after the backoff counter becomes 0. The specific terminal performing the transmission may generate a new random number (new backoff counter) after the transmission is terminated, and may attempt transmission when the new random number becomes 0 again or after the new random counter becomes 0.

CSMA/CA and random backoff procedures briefly described above are generally applied to a distributed coordination function (DCF) and enhanced distributed channel access (EDCAF), which are basic functions used by Wi-Fi terminals when attempting channel access, and are well-known and widely used unlicensed band channel access methods, and thus a more detailed description thereof is omitted.

DCF and EDCAF, which are utilized by a MAC of a Wi-Fi terminal, evaluate a channel status considering not only a channel state (idle/busy) identified by each terminal performing physical carrier sensing (CS) but also a virtual CS result. Specifically, even though the result of performing physical CS on a channel is idle, when the result of virtual CS is busy, the Wi-Fi terminal considers the channel to be in a busy state. The virtual CS is a channel evaluation method that determines a channel as busy when a network allocation vector (NAV) is not 0. The NAV may be a value maintained for future traffic that is expected to occupy a medium. Specifically, when receiving an RTS/CTS frame, the Wi-Fi MAC may configure an NAV (NAV count), based on duration information about the received frame, for example, a value in a duration field, and may maintain the NAV as a non-zero value for a time for which the medium is expected to be occupied after the RTS/CTS frame is exchanged. That is, the value maintained as the NAV decreases over time. An NAV value for a specific MAC being 0 may be interpreted a state in which future traffic recognized by the specific MAC is no longer occupying the medium. When the NAV is 0, the MAC may determine a virtual CS result as idle. Here, the Wi-Fi MAC may configure the NAV, based on a duration value obtained from not only the RTS/CTS frame but also another received MAC frame.

The channel evaluation method (determine the state of the medium) considering the results of both physical CS and virtual CS briefly described above is also one well-known Wi-Fi MAC function, and thus a detailed description thereof is omitted.

### <EDCA and TXOP>

EDCA provides a mechanism that manages traffic by differentiating the traffic into four types of access categories (ACs) according to traffic characteristics. The four types of ACs are AC voice (AC_VO), AC video (AC_VI), AC best effort (AC_BE), and AC background (AC_BK), and the respective AC may have different contention windows (CWs), transmit opportunities (TXOP), and AIFSN parameters. In short, EDCA is a mechanism that differentiates CWs, TXOPs, and AIFSN parameters for the four types of ACs to adjust the transmission priority of traffic transmitted using each AC. To this end, EDCA may map traffic (MSDU) that a MAC needs to service to one of the four ACs according to a traffic category (TC) or traffic stream (TS). Here, the traffic mapped to one of the four ACs by EDCA is divided and managed in four queues for the respective ACs. The four queues may be logically separated rather than physically separated.

AC_VO is an AC that may be used for traffic having a low absolute traffic amount and vulnerable to transmission delay, such as voice traffic, and has relatively small CW and AIFSN parameter values to increase a probability of being serviced with priority over traffic of other ACs. A TXOP parameter of AC_VO is limited to a relatively small value compared to TXOP parameters of the other ACs, and thus guarantees only a shorter transmission time than the other ACs.

AC_VI is an AC that may be used for traffic more robust to transmission delay than voice traffic but still requiring low-delay transmission and needing large-amount traffic processing, such as video. AC_VI has CW and AIFSN parameter values greater than those of AC_VO but smaller than those of the other ACs and has a TXOP about twice as long as that of AC_VI.

AC_BE is an AC that may be used for traffic robust to transmission delay, and most general traffic except for voice data and streaming video data may be classified as AC_BE. AC_BE uses CW and AIFSN parameters greater than those of AC_VO and AC_VI. In addition, AC_BE does not have a separate TXOP. Therefore, traffic corresponding to AC_BE may not be used for a TXOP transmission sequence of transmitting a PPDU, receiving an ACK response, and then transmitting a PPDU again after SIFS.

AC_BK is an AC may be used for traffic robust to transmission delay similar to AC_BE but having a lower priority than that of BE traffic. AC_BK uses the same CW parameter value as that of AC_BE, and uses an AIFSN parameter value greater than that of AC_BE. In addition, traffic corresponding to AC_BK does not have a separate TXOP like AC_BE, and thus may not be used for a TXOP transmission sequence.

The foregoing four types of EDCA ACs are mapped to a user priority (UP) of 802.1D, and an EDCA AC is determined according to an UP value of traffic received through a wire or a TID of an MSDU indicated from a higher layer. When the TID of the MSDU indicates a value of 0 to 7, the value indicated by the TID may correspond to the UP one-to-one.

Further, the foregoing four types of EDCA ACs each have default CW (CWmin, CWmax), AIFSN, and TXOP parameters defined in the standard, and the parameter values for each AC may be changed by an AP so that different values may be used for each BSS.

Using the EDCA mechanism, Wi-Fi traffic is stored in one of the four queues corresponding to the four ACs, and may be transmitted to a destination device only when an AC including the traffic wins channel access contention with other ACs. In the channel access contention between the ACs, each AC performs contention by utilizing an access parameter (CW[AC] and AIFSN[AC]) assigned thereto, and a channel access contention operation performed by each AC is the same as the DCF. Here, when a specific AC does not have any traffic to transmit in the queue, the specific AC may not participate in the contention.

However, as described above, since the respective ACs utilize different CW and AIFSN parameter values, AC_VO with the smallest CW and AIFSN parameters has a high probability of winning the channel access contention with the other ACs, and therefore traffic of AC_VO is more likely to be serviced with priority than traffic of the other ACs.

In addition, although the EDCA mechanism stipulates an internal contention rule, such as allowing an AC with a higher priority to win or increasing a CW of another AC causing a collision when the (internal) collision occurs between ACs, and a rule of constructing a PPDU including traffic of an AC other than an AC (primary AC) winning contention, which are not closely related to the proposal of the present disclosure, a detailed description is omitted.

As described above, EDCA provides an EDCA transmission opportunity (EDCA TXOP) function along with a function of operating differentiated ACs according to the type of traffic (frame, packet, or the like) to enhance QoS. An EDCA TXOP refers to time in which an EDCA function (EDCAF) of a specific AC is able to control a medium without being disturbed by other devices for TXOP duration when obtaining a channel access opportunity, i.e., when the EDCAF becomes a TXOP holder. Here, the EDCA TXOP may be limited by a TXOP limit advertised by the AP. The TXOP holder needs to ensure that transmission thereof and transmission of a response frame in response to the transmission thereof may be terminated within the TXOP limit.

The TXOP holder may transmit a plurality of frames (a plurality of PPDUs) for the EDCA TXOP duration. When transmission of each frame is performed within the obtained TXOP duration, the TXOP holder may consecutively transmit the plurality of frames without performing a separate channel access procedure, such as a backoff procedure, between transmissions of each frame. Here, when the plurality of frames is an MPDU or aggregated MAC protocol data unit (A-MPDU) that does not require an immediate ACK, transmission of the plurality of frames may be performed at an interval of short interframe space (SIFS) or reduced interframe space (RIFS). When there is an MPDU or A-MPDU requiring an immediate ACK among the plurality of frames, the TXOP holder may transmit a frame requiring an immediate ACK, receive the ACK, and transmit the next frame after SIFS.

Here, traffic (packet, frame, or the like) of an AC other than the specific AC as the TXOP holder may also be transmitted together within the TXOP obtained by the TXOP holder (specific AC) when satisfying a specific condition. Transmission of the traffic of the AC other than the TXOP holder in the TXOP may be an operation due to TXOP sharing between the ACs, and details related to the specific condition are not related to the present disclosure and thus are omitted.

As described above, the TXOP holder may perform consecutive frame transmissions in the TXOP without performing a separate channel access procedure, which may be an operation that may be achieved when other terminals understand and protect the TXOP duration obtained by the TXOP holder. That is, for the TXOP holder to obtain a medium control right to the EDCA TXOP duration, a procedure for reporting the obtained TXOP duration to allow other terminals to recognize the obtained TXOP duration may be required.

To this end, a terminal (AC) that has become the TXOP holder or initiates transmission after completing a channel access procedure may attempt to allow other terminals to recognize the TXOP duration by transmitting an RTS frame. The RTS frame refers to a frame in which a Type subfield of a Frame Control field (a fourth bit (B3) and a third bit (B2) of the Frame Control field) of a MAC frame header is configured to 01b (Type=Control frame) and a Subtype subfield of the Frame Control field (an eighth bit (B7), a seventh bit (B6), a sixth bit (B5), and a fifth bit (B4) of the Frame Control field) is configured to 1011b. The other terminals receiving the RTS frame from the TXOP holder may configure an NAV, based on information related to the duration included in the RTS frame, for example, a value in a Duration field. The configured NAV may be maintained at a non-zero value for a time corresponding to the TXOP of the TXOP holder. However, a terminal indicated as a destination device of the RTS frame needs to respond with a CTS frame instead of configuring an NAV, based on the information of the RTS frame. Here, the destination device of the RTS frame transmitted to start the TXOP is a TXOP responder, and needs to transmit the CTS frame in response to the RTS (after SIFS after receiving the RTS frame). Here, a Duration field of the responding CTS frame is configured to a value of the value indicated in the Duration field of the received RTS frame-CTS frame transmission time-SIFS. The terminals receiving the CTS frame may configure an NAV, based on the information related to duration included in the CTS frame (e.g., the value in the Duration field).

Therefore, the NAVs of the terminals receiving the RTS frame from the TXOP holder and the terminals receiving the CTS frame from the TXOP responder are configured to become 0 after the TXOP obtained by the TXOP holder terminates. Accordingly, the Wi-Fi MAC mechanism may protect the TXOP holder and the TXOP responder to exchange the plurality of frames without being interrupted during the TXOP.

However, when the TXOP holder transmits the RTS frame as a non-HT duplicate PPDU over a primary 80-MHz band but the CTS frame (non-HT duplicate PPDU) received from the TXOP responder is received only in a primary 40-MHz band, the TXOP holder may use only a bandwidth of primary 40 MHz or less than primary 40 MHz, for example, primary 20 MHz, for a frame exchange during the obtained TXOP. CH_BANDWIDTH (a type of TXVECTOR parameter) of the PPDU transmitted by the TXOP holder needs to be configured to a value equal to or smaller than CH_BANDWIDTH_IN-NON_HT (a type of RXVECTOR parameter) of the received CTS frame. Here, the RTS frame may be an RTS frame that allows the CTS frame to be received with a BW smaller than a BW in which the RTS frame is transmitted. The RTS frame may be an RTS frame transmitted with DYN_BANDWIDTH_IN_NON_HT (a type of TXVECTOR parameter) configured to dynamic. When the RTS frame is transmitted from the TXOP holder with DYN_BANDWIDTH_IN_NON_HT configured to static, the TXOP responder may need to respond with the CTS frame with the same BW as the BW in which the RTS frame is received.

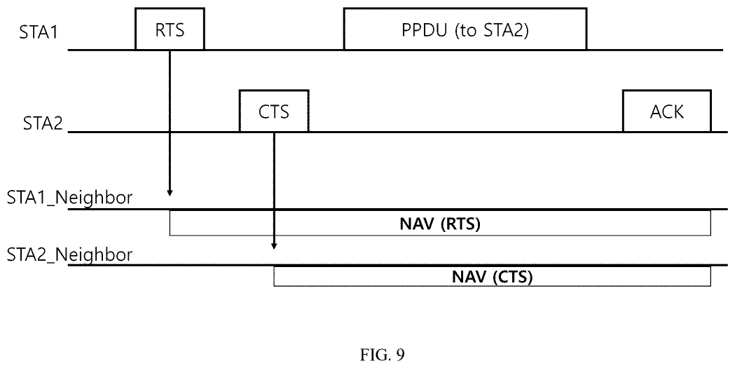

FIG. 9 illustrates a transmission/TXOP protection method using an RTS frame and a CTS frame according to an embodiment of the present disclosure.

Before transmitting a PPDU, a first station STA1 transmits an RTS frame to a second station STA2, which is a destination device of the PPDU, and the second station STA2 recognizes that the received RTS frame is an RTS frame destined for the second station and then responds with a CTS frame after SIFS.

STA1_Neighbor, which a neighbor station of the first station STA1, receives the RTS frame transmitted by the first station STA1, and then configures an NAV, based on a value indicated by a Duration field of the RTS frame. STA2_Neighbor, which is a neighbor station of the second station STA2, receives the CTS frame transmitted by the second station STA2, and then configures an NAV, based on information indicated by a Duration field of the CTS frame. STA1_Neighbor and STA2_Neighbor determine that virtual CS is busy and perform an operation of not decreasing a backoff counter while the NAV (counter) configured after receiving the RTS/CTS frame is maintained at a non-zero value. As a result, the neighbor terminals having received the RTS/CTS frame do not attempt transmission during a period when the NAV is maintained at the non-zero value. Therefore, the first station STA1 and the second station STA2 may not be interrupted by the neighbor terminals while exchanging the PPDU and an ACK frame.

Even though the first station STA1 and STA2_Neighbor is in a (hidden) relationship in which signals transmitted thereby are not detected by each other, STA2_Neighbor may perform an operation considering that a channel (wireless medium, WM) is being used while the first station STA1 transmits the PPDU.

### <TXOP Protection Using MU-RTS Trigger Frame>

11ax (6th-generation Wi-Fi, Wi-Fi 6, HEW, or High Efficiency WLAN) defines an MU-RTS trigger/CTS frame exchange procedure to add a function of allowing an AP to initiate a TXOP and to protect a TXOP frame exchange procedure by using an MU-RTS trigger frame (hereinafter, an MU-RTS or MU-RTS frame). The MU-RTS frame is a type of trigger frame, and stations which receive the MU-RTS frame and of which LSB 12 bits of an association ID (AID12) is indicated in a User field included in the MU-RTS frame simultaneously respond with CTS frames. When the AP protects the TXOP by using the MU-RTS frame, since the plurality of stations responds with the CTS frames, the TXOP may be protected from neighbor devices of the plurality of stations as destination devices of a downlink multi-user PPDU (DL MU PPDU). Further, the MU-RTS frame may be used to protect a UL MU PPDU. In more detail, before requesting a trigger-based (TB) PPDU from the plurality of stations through a trigger frame, the AP may transmit the MU-RTS frame so that the plurality of stations to respond with the TB PPDU may respond with the CTS frames. Here, the CTS frames with which the plurality of stations responds induce a neighbor station of each station to configure an NAV for protecting the TB PPDU and an ACK frame (ACK, block ACK, or the like) to be transmitted after the TB PPDU, and thus legacy stations unable to recognize (interpret or decode) the trigger frame and the TB PPDU may also not perform channel access for packet exchange sequence duration (or TXOP) initiated by the trigger frame.

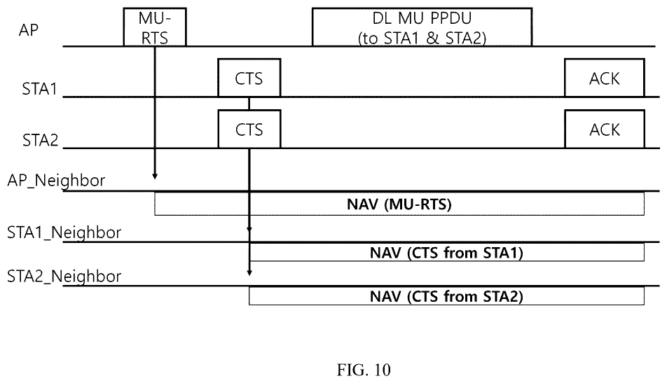

FIG. 10 illustrates a transmission/TXOP protection method using an MU-RTS frame and a CTS frame according to an embodiment of the present disclosure.

In the embodiment of FIG. 10, before transmitting an MU PPDU, an AP transmits an MU-RTS frame to a first station STA1 and a second station STA2, which are destination devices of the MU PPDU, and the first station STA1 and the second station STA2 receive the MU-RTS frame and each respond to the MU-RTS frame with a CTS frame after SIFS.

STA1_Neighbor, which is a neighbor station of the first station STA1, receives the CTS frame transmitted by the first station STA1, and then configures an NAV, based on information indicated by a Duration field of the CTS frame. STA2_Neighbor, which is a neighbor station of the second station STA2, receives the CTS frame transmitted by the second station STA2, and then configures an NAV, based on information indicated by a Duration field of the CTS frame. STA1_Neighbor and STA2_Neighbor determine that virtual carrier sensing (CS) is busy and perform an operation of not decreasing a backoff counter while the NAV (counter) configured after receiving the CTS frame is maintained at a non-zero value. Therefore, the neighbor terminals having received the CTS frame do not attempt transmission during a period when the NAV is maintained at the non-zero value. Accordingly, the AP may transmit the MU PPDU and the first station STA1 and the second station STA2 may transmit an ACK frame, without being interrupted by the neighbor terminals.

The foregoing trigger frame is a frame type defined in 11ax, in which Type (fourth bit (B3) and third bit (B2)) and Subtype (eighth bit (B7), seventh bit (B6), sixth bit (B5), and fifth bit (B4)) subfields of a Frame Control field are configured to 01b and 0010b, respectively. The trigger frame is a control-type frame in which the Type subfield of the Frame Control field is 01b, and a subtype value of 0010 indicates a trigger frame type. In 11ax, a trigger frame is defined so that an AP may request response frames from a plurality of stations at once, and an MU-RTS frame is used for an AP to request CTS frames from a plurality of stations (non-AP STAs). Other trigger types excluding the MU-RTS frame include a basic trigger frame for requesting a UL MU PPDU, a beamforming report poll (BRP) trigger frame for requesting a beamforming report, an MU-BAR trigger frame (for requesting a block ACK), a buffer status report poll (BSRP) trigger frame for requesting a buffer status report, a GCR MU-BAR trigger frame, a bandwidth query report poll (BQRP) trigger frame, and an NDP feedback report poll trigger frame. The other trigger types excluding the MU-RTS frame are not related to the content of the present disclosure, and thus a detailed description thereof is omitted.

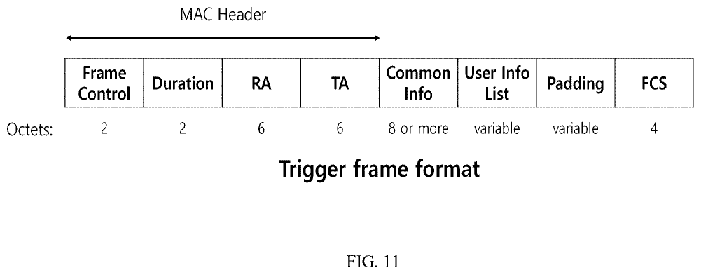

FIG. 11 illustrates a format of a trigger frame according to an embodiment of the present disclosure.

The trigger frame includes a MAC header including a Frame Control field, a Common Info field, a User Info List field, a Padding field, and an FCS field.

The Frame Control field includes Type and Subtype subfields, and the values of the two subfields in the trigger frame are configured to 01b and 0010b, respectively.

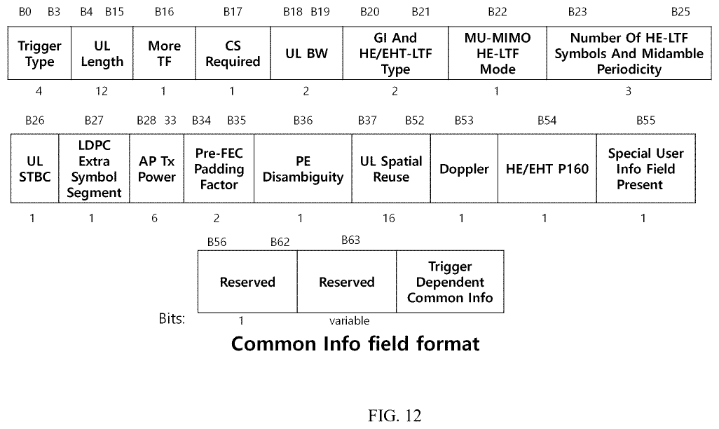

The Common Info field includes a Trigger Type subfield indicating the type of the trigger frame and a UL Length subfield indicating the length of responding UL transmission, which are described in detail through an embodiment of FIG. 12.

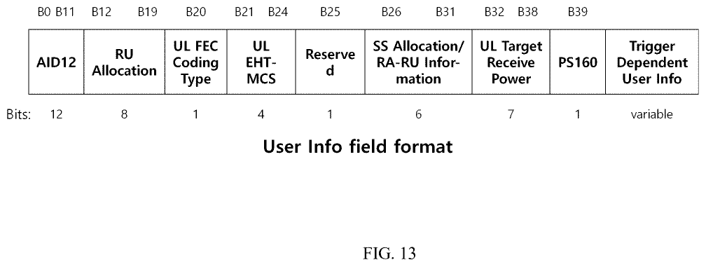

The User Info List field may include a User Info field including information indicating a destination device of the trigger frame. In addition to the information indicating the destination device, the User Info field includes information about a parameter, such as UL DCM or UL MCS, used by the destination device to transmit a response frame after receiving the trigger frame depending on the type of the trigger frame. Details of the User Info field are described in detail with reference to FIG. 13.

The Padding field is a field configured to secure time for a station receiving the trigger frame to prepare to transmit a response frame, for example, a UL TB PPDU and a CTS frame. An AP transmitting the trigger frame may adjust the length of the Padding field considering the performance of destination devices. Further, in 11be (Wi-Fi 7 or EHT), the Padding field may be added/adjusted to align the end time of a PPDU including the trigger frame with another PPDU, which is not described in detail.

The Frame Check Sequence (FCS) field includes a 32-bit cyclic redundancy code (CRC), and is a value calculated by including the MAC header and a Frame Body field. A function and a configuration method of the FCS field of the trigger frame are the same as a function and a configuration method of an FCS field included in a conventional MAC frame, which are not separately described.

FIG. 12 illustrates a format of a Common Info field of a trigger frame according to an embodiment of the present disclosure.

A Trigger Type subfield indicates the type (type or variant) of the trigger frame. When the value of the Trigger Type subfield is 0, the Trigger Type subfield indicates a basic trigger frame. When the value of the Trigger Type subfield is 1, the Trigger Type subfield indicates a beamforming report poll (BFRP) trigger frame. When the value of the Trigger Type subfield is 2, the Trigger Type subfield indicates an MU-BAR frame. When the value of the Trigger Type subfield is 3, the Trigger Type subfield indicates an MU-RTS frame. When the value of the Trigger Type subfield is 4, the Trigger Type subfield indicates a BSRP frame. When the value of the Trigger Type subfield is 5, the Trigger Type subfield indicates a GCR MU-BAR frame. When the value of the Trigger Type subfield is 6, the Trigger Type subfield indicates a bandwidth query report poll (BQRP) frame. When the value of the Trigger Type subfield is 7, the Trigger Type subfield indicates an NDP feedback report poll (NFRP) frame.

A UL Length subfield indicates a value to be configured in an L-SIG LENGTH field of a TB PPDU that is transmitted in response to the trigger frame.

A More TF subfield indicates whether there are more trigger frames to be transmitted after the trigger frame including the More TF subfield.

A CS Required subfield indicates whether a destination device of the trigger frame needs to perform CS (physical & virtual CS, ED & NAV) when transmitting a response frame. When the value of the CS Required subfield is 1, a station receiving the trigger frame including the CS Required subfield needs to perform CS before transmitting a response frame to the trigger frame.

A UL BW subfield indicates the value of a BW field that a STA responding with the TB PPDU after receiving the trigger frame needs to configure in a preamble, for example, HE-SIG-A or U-SIG.

A GI And HE/EHT-LTF Type subfield indicates guard interval (GI) and HE (EHT)-LTF values of the TB PPDU to be transmitted in response.

An MU-MIMO HE (EHT)-LTF Mode subfield indicates information related to an HE (EHT)-LTF mode that needs to be applied to the TB PPDU to be transmitted in response.

When the value of a Doppler subfield is 0, a Number Of HE (EHT/UHR)-LTF Symbols And Midamble Periodicity subfield indicates the number of HE (EHT)-LTF symbols that needs to be applied to the TB PPDU. When the value of the Doppler subfield is 1, the Number Of HE (EHT/UHR)-LTF Symbols And Midamble Periodicity subfield indicates information related to the number of HE (EHT)-LTF symbols and the periodicity of a midamble.

A UL STBC subfield indicates whether STBC encoding needs to be applied to the TB PPDU that is a response to the trigger frame including the UL STBC subfield. When STBC encoding needs to be applied, the value of the UL STBC subfield is configured to 1. The value of the UL STBC subfield of the trigger frame that triggers the EHT/UHR TB PPDU is reserved.

An LDPC Extra Symbol Segment subfield indicates whether an LDPC extra symbol segment needs to be present in the TB PPDU that is the response to the trigger frame including the LDPC Extra Symbol Segment subfield. When the value of the LDPC Extra Symbol Segment subfield is 1, the TB PPDU that is the response to the trigger frame including the LDPC Extra Symbol Segment subfield includes the LDPC extra symbol segment.

An AP Tx Power subfield indicates a value related to transmission power that an AP transmitting the trigger frame uses when transmitting the trigger frame. The station receiving the trigger frame may adjust transmission power for a response frame to the trigger frame, based on the value indicated by the AP Tx Power subfield.

Pre-FEC Padding Factor and PE Disambiguity subfields indicate whether a pre-FEC padding factor is 1, 2, 3, or 4 and information for clarifying the length of a packet extension (PE).

A UL Spatial Reuse subfield includes four Spatial Reuse subfields, and indicates a value to be configured in a Spatial Reuse field of the TB PPDU that is the response to the trigger frame including the UL Spatial Reuse subfield.

The Doppler subfield indicates whether a midamble is included in the TB PPDU that is the response to the trigger frame including the Doppler subfield. The trigger frame that triggers the EHT/UHR TB PPDU may have the value of the Doppler subfield configured to reserved. Here, the subfield being configured to reserved may indicate that the station operates without considering the presence and value of the Doppler subfield after receiving the trigger frame.

A Special User Info Field Present subfield indicates whether an AID12 subfield in a User Info field indicates a User Info field that is indicated as 2007 or a pre-designated value.

A Trigger Dependent Common Info subfield is a field included in the trigger frame only when the type of the trigger frame indicated by the Trigger Type field is a basic trigger frame or an NFRP trigger frame.

FIG. 13 illustrates a format of a User Info field of a trigger frame according to an embodiment of the present disclosure.

An AID12 subfield indicates information related to which station the User Info field including the AID12 subfield is about. A station having an AID that is the same as an AID indicated by the AID12 subfield may determine that the trigger frame including the AID12 subfield includes the station as a destination device. Here, the AID12 subfield may be configured to 1 to 2006 (1 to 2007 when the trigger frame is an HE trigger) when indicating one associated station.

When the value of the AID12 subfield is 0, the AID12 subfield may indicate that one or more random access RUs (RA-RUs) are allocated to a station associated with the AP transmitting the trigger frame. When the trigger frame received by the station associated with the AP transmitting the trigger frame does not include a User Info field including an AID12 subfield indicating the AID of a station and includes a User Info field including an AID12 subfield having a value of 0, the station may attempt to transmit a TB PPDU using the RA-RUS.

When the value of the AID12 subfield is 2045, the AID12 subfield may indicate that one or more random access RUs (RA-RUs) are allocated to a station unassociated with the AP transmitting the trigger frame. When the trigger frame received by the station unassociated with the AP includes a User Info field including an AID12 subfield having a value of 2045, the station may attempt to transmit a TB PPDU using the RA-RUs.

When the value of the AID12 subfield is 4095, a station receiving the trigger frame may determine that a padding field starts from the AID12 subfield. In this case, the station may not attempt to parse a remaining part of a MAC frame after the AID12 subfield with the value of 4095.

When the value of the AID12 subfield is 2046, the AID12 subfield may indicate that the User Info field including the AID12 subfield indicates information about an unallocated RU, which is an RU that is not allocated to any station.

An RU Allocation subfield of other trigger frames excluding an MU-RTS trigger frame indicates information about the size and location of a resource unit (RU)/multiple resource unit (MRU) allocated to the destination device of the User Info field including the RU Allocation subfield. The station may determine the information about the RU/MRU allocated to the station by interpreting the RU Allocation subfield and a PS160 subfield included in the User Info field together. The station may determine the information about the RU/MRU allocated to the station by interpreting the RU Allocation subfield and the PS160 subfield and a PS320 subfield included in the User Info field together. The PS320 subfield indicates whether the allocated RU is included in a primary 320-MHz band or a secondary 320-MHz band of a 640-MHz band. The PS160 subfield indicates whether the allocated RU is included in a 160-MHz band at a high frequency-axis position or in a 160-MHz band at a low frequency-axis position within the 320-MHz band (primary 320 MHz or secondary 320 MHz) indicated by the PS320 subfield. However, when the 320-MHz band indicated by the PS320 subfield is the primary-320 MHz, information indicated by the PS160 subfield is not about the high/low positions on the frequency axis but may indicate whether the allocated RU is included in a primary-160 MHz or a secondary-160 MHz. Specifically, the 320-MHz band indicated by the PS320 subfield may be the primary 320 MHz. In this case, when the value of the PS160 subfield is 0, the PS160 subfield may indicate that the allocated RU is included in the primary 160-MHz band. When the value of the PS160 subfield is 1, the PS160 subfield may indicate that the allocated RU is included in the secondary 160-MHz band. Here, the value of the PS160 subfield is an example. When the value of the PS160 subfield is 1, the PS160 subfield may indicate that the allocated RU is included in the primary-160 MHz band. When the value of the PS160 subfield is 0, the PS160 subfield may indicate that the allocated RU is included in the secondary-160 MHz band.

A method for indicating the location of the allocated RU within each 160 (and 320) MHz band indicated in this manner may be the same as or similar to a method for indicating an RU Allocation subfield of a trigger frame defined in EHT.

An RU Allocation subfield of the MU-RTS indicates a channel on which the destination device of the User Info field responds with a CTS frame. Specifically, the RU Allocation subfield of the MU-RTS frame indicates whether the destination device transmits the CTS frame only on a primary 20-MHz channel or on a primary-40 MHz channel, a primary 80-MHz channel, a primary 160-MHz channel, an 80+80-MHz channel, a primary 320-MHz channel, or a primary-640 MHz channel when transmitting the CTS frame. An MRU refers to an RU in which two or more RUs are combined, and an MRU with a 52+26, 106+26, 484+242, 996+484, 996+484+242, 2×996+484, 3×996, 3×996+484, 4×996, or 4×996+4×996-tone size may be used in UHR.

A UL FEC Coding Type subfield indicates the code type of the TB PPDU to be transmitted in response. When the value of the UL FEC Coding Type subfield is 0 and the value of binary convolution coding (BCC) is 1, the UL FEC Coding Type subfield indicates a low density parity check (LDPC).

A UL EHT/UHR-MCS subfield indicates an EHT/UHR-MCS applied to transmission of the TB PPDU in response to the trigger frame.

An SS Allocation/RA-RU Information subfield may be used as an SS Allocation subfield when the AID12 subfield indicates that no RA-RU is allocated. The 6-bit SS Allocation subfield may include a 4-bit Starting Spatial Stream subfield and a 2-bit Number Of Spatial Streams subfield. When the value of the AID12 subfield is 0, 2044, or 2045, the User Info field including the AID12 subfield indicates information about the RA-RU.

A UL Target Receive Power subfield indicates an expected signal power value with which the TB PPDU in response to the trigger frame is received at an antenna side of the AP. When the station transmits the TB PPDU, the station may adjust the transmission power of the TB PPDU according to a value in the UL Target Receive Power subfield. Accordingly, the AP may receive the TB PPDU with power expected by the AP.

The PS160 subfield indicates, together with the RU Allocation subfield, the information about the location and size of the RU/MRU allocated by the User Info field including the PS160 subfield.

A Trigger Dependent User Info (sub) field is not present in the MU-RTS frame, and thus a detailed description thereof is omitted.

### <Limitations of the Existing Channel Access Method>

As described above, in Wi-Fi, an AP may indicate information related to an RU that each non-AP STA needs to receive by using a signaling field included in a preamble, thereby instructing a plurality of non-AP STAs to simultaneously transmit a DL PPDU. The plurality of non-AP STAs may perform UL PPDU transmission, based on a trigger frame transmitted from the AP. A frame exchange sequence led by an AP and performed with a plurality of non-AP STAs is an evolution of a Wi-Fi wireless LAN technology designed to more efficiently use limited radio frequency resources.

However, an operation of the AP transmitting a DL MU PPDU or indicating/triggering UL MU PPDU transmission through a trigger frame has a limitation of being possibly used only when the AP obtains a TXOP. When a non-AP STA obtains a TXOP, a one-to-one frame exchange sequence in which the non-AP STA transmits a UL PPDU and the AP responds thereto (ACK, block ACK, or the like) is performed, which is the same as a frame exchange sequence used in an old-version wireless LAN. That is, since a multi-user operation in a recently defined Wi-Fi standard may be utilized only in a TXOP obtained by the AP, it is difficult to expect improvement in wireless LAN utilization efficiency due to the MU operation when the non-AP STA obtains a TXOP.

When the non-AP STA obtains a TXOP, there are more limitations in addition to not being able to perform an MU operation (operation utilizing a DL MU PPDU and a UL MU PPDU) with high efficiency, compared to when the AP obtains a TXOP.

For example, the amount of frequency resources available for a frame exchange is limited. In general, the non-AP STA has low capability compared to the AP, and thus an operating BW thereof is highly likely to be narrower than that of the AP. That is, the BW of a TXOP obtained by the non-AP STA after performing channel access is relatively higher than a BW in which the AP may obtain a TXOP when performing channel access. For example, even though the AP supports an operation for a 320-MHz BW, when the non-AP STA supports an operation only for an 80-MHz BW, the non-AP STA obtains a TXOP only for 80 MHz and then performs a frame exchange with the AP. In this case, the AP is unable to utilize a capability supportable through the remaining 240-MHz BW excluding 80 MHz of the 320-MHz BW, which means that an opportunity to support services for more traffic may be lost due to the TXOP obtained by the non-AP STA.

In another example, the number of spatial streams available for a frame exchange is limited. In general, the non-AP STA has a configuration including a small number of antennas compared to the AP, and thus has a smaller number of available antennas than that of the AP. That is, even though there are available antennas left in the AP, performing a more efficient operation using the available antennas is restricted during the time period of a TXOP obtained by the non-AP STA.

Even though not showing the foregoing examples related to the foregoing BW and number of antennas, it is easy to understand that expected utilization of a TXOP obtained by the AP is higher than that of a TXOP obtained by the non-AP STA, and thus a detailed description is omitted.

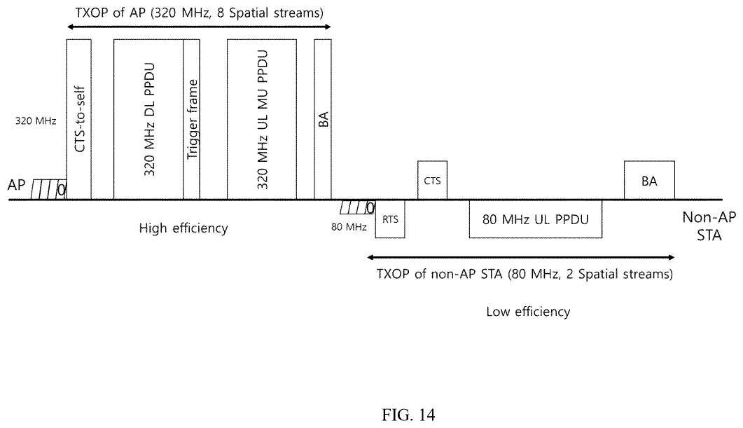

FIG. 14 illustrates an example of a frame exchange sequence performed between STAs during a TXOP according to an embodiment of the present disclosure.

Referring to FIG. 14, after obtaining a channel access right (completing a backoff procedure), an AP transmits a CTS-to-self frame in a 320-MHz band to obtain a TXOP for 320 MHz. During the TXOP obtained by the AP, the AP transmits a 320-MHz DL PPDU, and allows a response with a UL MU PPDU (TB PPDU) to be performed in the 320-MHz band by using a trigger frame. That is, the AP performs an MU operation using the 320-MHz band during the TXOP thereof, in which process a multi-antenna transmission/reception technology using eight antennas included in the AP is utilized.

A non-AP STA transmits an RTS frame in an 80-MHz band, and receives a CTS frame after obtaining a channel access right. Unlike the AP, which obtains the TXOP for the 320-MHz band, the non-AP STA obtains the TXOP only for the 80-MHz band due to a limited capability. During the obtained TXOP, the non-AP STA transmits a UL PPDU, and receives a BA in response. In this process, although the AP has eight antennas, an operation using only two spatial streams is performed because the non-AP STA has only two antennas.

As a result, the TXOP obtained by the AP is efficiently utilized through an MU PPDU exchange utilizing a wide bandwidth and a large number of antennas, while the TXOP obtained by the non-AP STA is relatively low in efficiency because only a relatively narrow bandwidth and a small number of antennas are used.

That is, it may be more efficient that the AP performs UL/DL transmission by obtaining a TXOP than that the non-AP STA performs UL/DL transmission by obtaining a TXOP. Therefore, the present disclosure proposes a method for efficiently utilizing a TXOP through a procedure of sharing a right to obtain a TXOP or an obtained TXOP between STAs.

Specifically, a STA (e.g., a non-AP STA or an AP) that has obtained a right to obtain a TXOP through a backoff procedure or has already obtained a TXOP may share the obtained right or TXOP with another STA (e.g., a non-AP STA or an AP) through a specific frame (e.g., an initiating frame). In this case, the other STA may transmit and receive a PPDU by using the right to obtain the TXOP or the obtained TXOP. The non-AP STA may share the right to obtain the TXOP or the obtained TXOP with an AP of an associated BSS. The non-AP STA may transmit the frame for sharing the right to obtain the TXOP or the obtained TXOP, including information (e.g., an access category related to the backoff procedure for obtaining the TXOP, the length of the TXOP, and buffer information) about the non-AP STA. The AP with which the right to obtain the TXOP or the TXOP is shared is able to transmit and receive a PPDU, and may indicate uplink transmission to non-AP STAs by transmitting a trigger frame. When the AP indicates uplink transmission to the non-AP STA sharing the right to obtain the TXOP or the TXOP through the trigger frame, a user information field including information about an AID of a resource allocated to the non-AP STA may be located first among user information fields included in a user-specific field. When performing channel access, the non-AP STA sharing the right to obtain the TXOP or the TXOP may perform the channel access by using EDCA parameters regardless of the value of an MU-EDCA timer.

After the TXOP expires, the AP may select a new backoff counter for channel access within a contention window. In this case, the size of the contention window for selecting the new backoff counter may be one of a minimum value or the size of a contention window for a current access category.

In the present disclosure, the length of the shared TXOP may be the same as or shorter than the length of the TXOP obtained by the sharing STA. That is, the STA may share all or part of the TXOP obtained through the backoff procedure.

Hereinafter, a method for sharing a right to obtain an TXOP or an obtained TXOP according to the present disclosure may be applied to not only a method for sharing of a non-AP STA with an AP but also methods for sharing between a non-AP STA and a non-AP STA, an AP and a non-AP STA, and an AP and an AP.

### <Channel Access of AP Performed Based on Initiation by Non-AP STA>

As described above, to efficiently utilize a wireless resource, it is more advantageous for an AP to obtain a TXOP than for a non-AP STA to obtain a TXOP, and increasing the proportion of the AP obtaining a TXOP is important for efficient wireless LAN resource utilization of a BSS and the entire network.

According to an embodiment of the present disclosure, after obtaining a channel access right, the non-AP STA may induce the AP to obtain a TXOP instead of the non-AP STA obtaining a TXOP. That is, the non-AP STA may transfer/offer an obtained opportunity to obtain a TXOP to the (associated) AP.

More specifically, the non-AP STA may perform a backoff procedure through DCF or EDCA, thereby obtaining a channel access right (completing the backoff procedure). Subsequently, the non-AP STA may indicate to the AP that the non-AP STA has obtained the channel access right through a pre-agreed procedure, thereby causing the AP to obtain a TXOP. Through this process, the AP may obtain the TXOP (becomes a TXOP holder), based on the non-AP STA obtaining the channel access right.

A simple sequence of operations in which the non-AP STA performs channel access and offers an opportunity to obtain a TXOP to the AP is as follows (See 1 to 5 below. A, B, and the like are additional operations and considerations applicable to each sequence). However, the sequence of the operations described below is only an example, and it should be considered that the main idea of the present disclosure is a method in which the AP obtains a TXOP through a series of processes after the non-AP STA obtains a right to obtain a TXOP (channel access right, i.e., completion of a backoff procedure). In addition, it should be understood that a method of utilizing an obtained TXOP similarly to a TXOP of which a TXOP holder is the AP (i.e., the AP transmits a DL MU PPDU or transmits a trigger frame to solicit a UL MU PPDU response) after the non-AP STA obtains the TXOP and a method in which the AP utilizes a BW larger than a BW of the TXOP obtained by the non-AP STA are not different from main functions to be provided by the present disclosure except that a subject obtaining a TXOP is different.

A procedure in which a STA (AP or non-AP) receives sharing of a right to obtain a TXOP or a TXOP from a STA (AP or non-AP STA) is as follows. Hereinafter, a procedure in which an AP receives sharing of a right to obtain a TXOP or a TXOP from a non-AP STA is described for illustration, but the present disclosure is not limited thereto, and may be applied to a procedure for granting a right to obtain a TXOP or sharing a TXOP between STAs.
1. A non-AP STA performs a backoff procedure through DCF or EDCA.
2. Upon completing the backoff procedure, the non-AP STA transmits, to an associated AP, a pre-agreed frame transmitted to offer an opportunity to obtain a TXOP to the AP, instead of transmitting a frame for initiating a TXOP of the non-AP STA (the associated AP refers to an AP of a BSS to which the non-AP belongs as a member).
3. Upon receiving the TXOP initiating frame from the non-AP STA, the AP transmits a frame for obtaining a TXOP on a channel identified as idle as a result of CCA within an operating BW of the AP.
4. The AP obtains a TXOP, and then transmits a trigger frame.
5. After obtaining the TXOP or when the TXOP expires, the AP generates a new backoff counter.

### (1. Execution of Backoff Procedure Through DCF or EDCA)

A non-AP STA may obtain a right to obtain a TXOP through a backoff procedure. In this case, the non-AP STA may perform the backoff procedure by using DCF, an EDCA parameter, or an MU EDCA parameter. When wanting to share the right to obtain the TXOP or an obtained TXOP with an associated AP, the non-AP STA may perform the backoff procedure by using the EDCA parameter regardless of the value of an MU EDCA timer. That is, the non-AP STA that wants to share the right to obtain the TXOP or the obtained TXOP with the associated AP may perform the backoff procedure by using the EDCA parameter even though the value of the MU EDCA timer does not become “0” when performing the backoff procedure. In other words, the non-AP STA that wants to share the right to obtain the TXOP or the obtained TXOP with the associated AP may perform the backoff procedure by using the EDCA parameter at any time regardless of the value of the MU EDCA timer.

That is, the non-AP STA that intends to share the TXOP with the AP after obtaining the TXOP or intends to transfer an opportunity to obtain a TXOP to the AP may perform channel access by utilizing the EDCA parameter regardless of the value of the MU EDCA timer. In addition, even though the non-AP STA performs the backoff procedure through MU EDCA, it is possible to transfer the opportunity to obtain the TXOP to the AP or to share the obtained TXOP. When the MU EDCA timer of the non-AP STA of conventional Wi-Fi is not 0, the non-AP STA needs to perform channel access by utilizing the MU EDCA parameter. However, when intending to transfer the opportunity to obtain the TXOP to the AP, the non-AP STA may perform the backoff procedure by applying the EDCA parameter, which may be an operation considered to allow the non-AP STA that transfers the opportunity to obtain the TXOP to the AP to have a channel access right under the same condition as a legacy non-AP STA that does not perform an uplink multi-user (UL MU) operation when performing channel access.

### (2. Transmission of Frame for Sharing Right to Obtain TXOP or TXOP)

Upon completing the backoff procedure, the non-AP STA may transmit a specific frame for granting (or sharing) the right (or opportunity) to obtain the TXOP to the AP instead of transmitting a frame for initiating the TXOP. Here, the AP receiving the specific frame is an AP associated with the non-AP STA, which is an AP of a BSS to which the non-AP STA belongs as a member. The specific frame may be referred to as an initiating frame, and may be referred to by various terms without being limited thereto. Alternatively, the initiating frame may be an existing frame, in which case the frame for granting the right to obtain the TXOP may be configured by a different method. For example, the initiating frame may be an RTS frame or a trigger frame. In this case, the RTX frame or the trigger frame for granting the right to obtain the TXOP right may be configured by a different method from an existing configuration method. For example, a format or a field value may be configured differently. That is, the initiating frame may be classified as a frame of the same type (and subtype) as a frame defined in existing Wi-Fi, but may be configured by a different method when used to grant the obtained right to obtain the TXOP to the AP.

The initiating frame may include at least one of duration/ID information, AC information, buffer status information, and/or at least one parameter (e.g., a MCS, a PPDU BW (RU size), and a PPDU length) related to PPDU transmission of the non-AP STA that has obtained the right to obtain the TXOP.
i. When the initiating frame is a CTS-to-AP frame, the CTS-to-AP frame refers to a CTS frame in which an RA field is configured to a MAC address of the AP. Here, the duration/ID of the CTS-to-AP frame may be configured to a length including a trigger frame to be transmitted by the AP receiving the initiating frame.
ii. The initiating frame may include information related to an access category (AC) related to the backoff procedure for the non-AP STA to obtain the right to obtain the TXOP and/or information related to the length of the TXOP obtained after completing the backoff procedure. The information related to the length of the TXOP may be included in a Duration/ID field of the initiating frame, which may be configured to the length including the trigger frame to be transmitted by the AP receiving the initiating frame. That is, the Duration/ID field may be configured to a value considering the length of the trigger frame when the AP granted the right to obtain the TXOP from the non-AP STA transmits the trigger frame. Alternatively, the information related to the length of the TXOP may be included and indicated in a frame body field rather than a MAC header of the initiating frame.
iii. The initiating frame may include information related to a buffer status (e.g., buffer status information) of the non-AP STA transmitting the initiating frame (i.e., granting the right to obtain the TXOP or sharing the obtained TXOP).
iv. The initiating frame may include information related to parameters (e.g., a MCS, a PPDU bandwidth (RU size), and a PPDU length) to be used by the non-AP STA transmitting the initiating frame (i.e., granting the right to obtain the TXOP or sharing the obtained TXOP) when transmitting an uplink PPDU.
v. The initiating frame may have a configuration including a user information field (the same (or similar) configuration as a user information field included in the trigger frame) that the non-AP STA wants to receive through the trigger frame. In this case, the AP may transmit the trigger frame including a user information field the same as the user information field included in the initiating frame to at least one non-AP STA including the non-AP STA that grants the right to obtain the TXOP or shares the obtained TXOP.
vi. The initiating frame may be transmitted via a non-HT PPDU or a non-HT duplicated PPDU. That is, the non-AP STA may transmit the initiating frame via the non-HT or the non-HT duplicated PPDU.

The initiating frame may include information related to an idle channel (e.g., channel state information) identified by the non-AP STA transmitting the corresponding frame. More specifically, the initiating frame may have a configuration including a field indicating by the STA transmitting the corresponding frame whether each identified subchannel is idle/busy. Whether each subchannel is idle or busy may be information utilized by the AP transmitting the trigger frame after receiving the corresponding frame. For example, when the AP allocates an RU to the STA transmitting the initiating frame through the trigger frame, the AP may allocate an RU included in the subchannel(s) indicated as idle by the STA. That is, when the AP selects an RU to allocate to the STA transmitting the initiating frame, the AP may need to allocate an RU included in the subchannel indicated as idle by the STA transmitting the frame.

The Duration/ID field of the initiating frame may be configured by a pre-designated method. More specifically, the Duration/ID field (duration field) of the initiating frame may be configured to a value indicating a time before the start time of the TB PPDU transmitted in response to the trigger frame transmitted by the AP receiving the corresponding frame. That is, even though a second STA receiving an initiating frame transmitted by a first STA configures a network allocation vector (NAV), based on the corresponding frame, the NAV is released at a time when the TB PPDU is transmitted in response to a trigger frame transmitted by the AP. Through this process, an unassociated non-AP STA may respond to a random access RU (RA-RU) indicated by the trigger frame of the AP with a TB PPDU (through a UL OFDMA-based random access (UORA) procedure).

The Duration/ID field of the initiating frame may be configured based on information indicated in advance by the AP. That is, the AP may notify non-AP STAs of a value to be configured in the Duration/ID field of the initiating frame through a management frame. This value may be a value determined in consideration of a time required for the AP to attempt to obtain a TXOP after receiving the initiating frame. For example, the AP may intend to adjust the length of a frame (e.g., an MU-RTS frame) transmitted to obtain a TXOP after receiving the initiating frame, and may announce a duration/ID field value determined in consideration of the adjusted transmission length. In a specific example of use, the AP may include padding considering a mode switch (eMLSR/low-power mode=>normal operating mode) time of non-AP STAs in an initial frame transmitted after receiving the initiating frame in view of the non-AP STAs operating in an eMLSR mode or a low-power listening mode. In this case, a time required for the AP to transmit a first trigger frame after obtaining a TXOP may be slightly longer than when transmitting a short initial frame (including no padding). Therefore, to ensure MAC-level protection until the non-AP STA transmitting the initiating frame responds with a TB PPDU to the trigger frame, the duration/ID field value of the initiating frame needs to be appropriately adjusted, and thus the AP needs to announce the duration/ID field value. Alternatively, the AP may need to maintain the length of the initial frame transmitted after receiving the initiating frame to be a pre-agreed length or shorter. In this case, the duration/ID field value of the initiating frame is configured in a pre-agreed manner, and the AP needs to adjust an initial frame sequence and the length of the initial frame in view of a time protected by the duration/ID field value.

The non-AP STA may need to transmit a CF-END frame when the frame transmitted by the AP (the frame transmitted by the AP to obtain the TXOP or the next frame of the initiating frame transmitted according to a pre-arranged frame exchange sequence) is not received from the AP within a preset time interval after transmitting the initiating frame. This procedure (CF-END frame transmission) may be for releasing NAVs of STAs of which the NAVs are configured due to the initiating frame when a procedure of transferring the TXOP to the AP through the initiating frame fails.

The non-AP STA may need to transmit the initiating frame when a time at which the non-AP STA obtains the channel access right (a time when the backoff procedure is completed) is within a restricted-target wake time (TWT) service period (R-TWT SP). The R-TWT SP refers to an SP configured to preferentially transmit low-latency traffic, and refers to a TWT that is a type of broadcast TWT. The start time of the R-TWT SP is the same as the start time as an overlapping quiet interval (duration of 1 TU).

For a 20 MHz-only non-AP STA that supports only a 20-MHz operation, a restriction of needing to an initiating frame when a backoff procedure is completed may be applied. That is, a restriction that the 20 MHz-only non-AP STA is unable to be a TXOP holder and needs to transfer a TXOP to the AP may be applied to the 20 MHz-only non-AP STA, which may be an operation restriction for the 20 MHz-only non-AP STA considered to prevent deterioration in performance of the BSS due to limited performance of the 20 MHz-only non-AP STA.

### (3. Attempt to Obtain TXOP by AP Obtaining Right to Obtain TXOP or Receiving TXOP Sharing)

Upon receiving the initiating frame from the non-AP STA to be granted the right to obtain the TXOP or to receive sharing of the obtained TXOP, the AP may transmit a specific frame for obtaining a TXOP on a channel identified as idle according to a result of CCA within an operating bandwidth (BW) thereof.
i. Here, a method for the AP to determine whether each channel is idle through CCA may be based on a result of CCA for PIFS after receiving the initiating frame (including virtual CCA). Here, a channel on which the initiating frame is received may be excluded from determining whether each channel is idle. Alternatively, a method for the AP to determine whether each channel is idle through CCA may be based on whether the channel has maintained an idle state for PIFS or SIFS after receiving the initiating frame (including virtual CCA). Here, the channel on which the initiating frame is received may be excluded from determining whether each channel is idle. Alternatively, a method for the AP to determine whether each channel is idle through CCA may be based on whether the channel has maintained the idle state for PIFS before receiving the initiating frame (including virtual CCA).
ii. The AP may also transmit the frame for obtaining the TXOP on a channel (in the idle state) other than the channel occupied by the PPDU including the initiating frame received from the non-AP STA. That is, a TXOP obtaining procedure of the AP may be performed through a PPDU having a wider BW than the PPDU including the initiating frame. In this case, the AP may obtain a TXOP for the BW wider than the BW in which the non-AP STA transmits the initiating frame. In addition, a subchannel (channel that is included in the BW of the PPDU transmitted by the non-AP STA but is punctured) which the non-AP STA transmitting the initiating frame determines as busy and on which the non-AP STA does not transmit the initiating frame may be identified as idle on the AP side, thus obtaining a TXOP of the AP. In this case, the AP does not allocate an RU of the subchannel (subchannel not occupied by the initiating frame) to the non-AP STA, and may utilize the subchannel for a frame exchange with another non-AP STA. However, for the subchannel (disabled subchannel) which is determined as idle on the AP side but which the BSS determines not to use, the AP does not attempt to obtain a TXOP. After receiving the initiating frame, the AP attempting to obtain the TXOP for the BW wider than the BW of the PPDU including the initiating frame may need to attempt BW extension in view of the resolution of BW extension and/or the ratio of idle subchannels for an additional BW. More specifically, the AP attempting to obtain the TXOP for the BW wider than the BW of a PPDU including the initiating frame may attempt BW extension only when a certain ratio or more of subchannels included in the extended BW are determined as idle. In this case, the certain ratio may be, for example, 50%. For example, the AP that receives the initiating frame through an 80-MHz PPDU may attempt to obtain a TXOP for a 160-MHz BW only when two or more of four subchannels included in a secondary 80-MHz BW are determined as idle. That is, when only one of the four subchannels included in the secondary 80-MHz BW is determined as idle, the AP may not need to attempt to obtain the TXOP for the 160-MHz BW. However, when six or more of twelve subchannels included in the secondary 80-MHz band and a secondary 160-MHz band are idle, the AP may attempt to obtain a TXOP for a 320-MHz band. However, even in this case, when less than four of the eight subchannels included in the secondary 160-MHz band are idle, the AP may not attempt to BW extension for the secondary 160-MHz band. The foregoing example considering the ratio of 50% is only for illustration, and the specific ratio value may be changed to any other value. That is, whether BW extension of the AP is allowed is determined based on whether a gain obtainable through an extended BW is sufficient, and a specific criterion for whether a gain is sufficient may be applied by any other method or by any other criteria.
iii. The frame for obtaining the TXOP transmitted by the AP may be a CTS-to-self frame, an MU-RTS frame, an RTS frame, or a trigger frame.
iv. The PPDU including the frame for obtaining the TXOP transmitted by the AP is transmitted after SIFS or PIFS from the end of the PPDU including the initiating frame received from the non-AP STA. That is, the AP having received the initiating frame transmits the frame for obtaining the TXOP after the SIFS or PIFS. Here, inter-frame space used when the AP transmits the frame for obtaining the TXOP after receiving the initiating frame may be the same as inter-frame space used by the AP to determine whether each subchannel is idle/busy. That is, the AP may perform CCA (PHY CCA and energy detection (ED)) for an operating BW thereof for the SIFS or PIFS immediately after receiving the initiating frame, and may perform channel access to subchannels determined as idle.
v. A Duration/ID field of the frame for obtaining the TXOP transmitted by the AP may be configured based on the received initiating frame. For example, the Duration/ID field of the frame for obtaining the TXOP transmitted by the AP may be configured to a value equal to or smaller than “Duration/ID field value of the initiating frame”−“SIFS or PIFS”−“length of the frame for obtaining the TXOP transmitted by the AP.” Alternatively, the AP may need to determine the length of the TXOP that the AP attempts to obtain, based on information indicated by another field included in the initiating frame. That is, the length of the TXOP obtainable by the AP may be determined (limited) based on the other field (field other than the Duration/ID field) included in the initiating frame.
vi. The frame for obtaining the TXOP transmitted by the AP may need to be transmitted in a non-HT PPDU or non-HT duplicated PPDU format. That is, after receiving the initiating frame, the AP needs to attempt to obtain a TXOP by using the non-HT or non-HT duplicated PPDU format.

### (4. Transmission of Trigger Frame by AP)

When the AP obtains a TXOP by performing channel access after receiving the initiating frame transmitted by the non-AP STA, the AP may transmit at least one trigger frame within the TXOP. Here, the trigger frame may be a trigger frame soliciting a UL PPDU (TB PPDU) by allocating an RU to the non-AP STA having transmitted the initiating frame. However, when it is determined that the non-AP STA having transmitted the initiating frame does not need to perform transmission, based on the information included in the initiating frame, the AP may not transmit the trigger frame within the obtained TXOP.

When the AP transmits the trigger frame to the non-AP STA having transmitted the initiating frame, the AP may transmit the trigger frame for indicating uplink transmission to at least one non-AP STA within the obtained TXOP after obtaining the TXOP from the non-AP STA. The at least one non-AP STA may include the non-AP STA that has granted the right to obtain the TXOP or has shared the obtained TXOP. When the trigger frame for uplink transmission is transmitted to the non-AP STA that has granted the right to obtain the TXOP or has shared the obtained TXOP (hereinafter, a TXOP-sharing non-AP STA), a user information field about the TXOP-sharing non-AP STA may be located first among at least one user field included in a user-specific field of the trigger frame, which for granting the AP the right to obtain the TXOP or for compensating the non-AP STA that has shared the obtained TXOP for sharing.
i. The trigger frame has a configuration including a user information field corresponding to an AID of the TXOP-sharing non-AP STA having transmitted the initiating frame. Here, among the user information fields included in the trigger frame, the user information field corresponding to the TXOP-sharing non-AP STA having transmitted the initiating frame may be indicated first (first except for a special user information field (User Info field in which an AID subfield is 2007 or a pre-agreed value)).
ii. The AP may configure the user information field about the TXOP-sharing non-AP STA included in the trigger frame, based on the information indicated through the initiating frame. That is, the User Info field corresponding to the non-AP STA having transmitted the initiating frame may be configured based on various parameters (MCS, UL length, BW/RU size information, and the like) included in the initiating frame. For example, the AP may configure a UL Length subfield included in the trigger frame, based on information indicated by the non-AP STA sharing the TXOP. When the non-AP STA indicates information related to the length of a TB PPDU that the non-AP STA wants to transmit, the AP may configure the UL Length field of the trigger frame to be equal to the indicated length or to a length longer than the indicated length. When the AP allocates an RU through the trigger frame transmitted during the TXOP obtained by receiving the initiating frame from the non-AP STA (when soliciting a TB PPDU response), the AP may preferentially schedule STAs that have transmitted/are scheduled to transmit an initiating frame. Here, a method for the AP to determine whether each STA is a STA that has transmitted/is scheduled to transmit an initiating frame may be based on a lapse of a preset time since transmission of the initiating frame by the non-AP STA. Alternatively, a method for the AP to determine whether each STA is a STA that has transmitted/is scheduled to transmit an initiating frame may be based on whether the STA configures a capability or operating element related to transmission of the initiating frame to true (or 1). When the AP allocates an RU to the TXOP-sharing non-AP STA having transmitted the initiating frame, the AP needs to allocate only an RU in a band occupied by the PPDU including the initiating frame transmitted by the TXOP-sharing non-AP STA. That is, the AP is not allowed to allocate an RU in a band not occupied by the initiating frame (PPDU including the same) to the TXOP-sharing non-AP STA having transmitted the initiating frame, which may be a RU allocation restriction considering that the band not occupied by the initiating frame (PPDU including the same) is a band identified as busy as a result of CCA by the non-AP STA having transmitted the initiating frame or a band falling outside an operating BW of the non-AP STA. Therefore, the size and location of an RU allocated to the non-AP STA having transmitted the initiating frame may be different from those requested by the non-AP STA depending on the CCA result of each subchannel identified by the AP.
vi. The AP needs to determine the location of an RU allocated to the TXOP-sharing non-AP STA having transmitted the initiating frame in view of the location of the primary 20-MHz channel. More specifically, the AP needs to allocate an RU within the primary 20-MHz channel or an RU including an RU in the Primary 20-MHz channel to the non-AP STA having transmitted the initiating frame.

### (5. Generation of Backoff Counter by AP)

The AP having obtained the TXOP may generate (or select) a new backoff counter after obtaining the TXOP or at a time when the TXOP expires. In this case, an AC for generating the backoff counter may be determined based on an AC indicated by the initiating frame. That is, the backoff counter generated after obtaining the TXOP or at the time when the TXOP expires may be a backoff counter of an AC that is the same as (or similar to) the AC indicated by the initiating frame. For example, when the AP identifies that AC_BE is indicated, based on information indicated through the initiating frame, the AP may generate a new backoff counter of AC_BE. When generating the new backoff counter, the AP may need to generate the new counter by using a minimum contention window (CW_min) of the corresponding AC. Alternatively, when generating the new backoff counter, the AP may need to generate the new counter by using a current CW of the corresponding AC. Alternatively, when the AP obtains the TXOP, based on the initiating frame, the AP may not change a backoff counter of EDCAFs. Alternatively, the AC for which the AP generates the new backoff counter may be an AC with the smallest remaining backoff counter among all ACs. That is, when selecting an AC for which a backoff counter is generated again, the AP may determine an AC for which a backoff counter is generated again, based on the size of a backoff counter of each AC, which may be understood as a backoff regeneration method considering that the AP may use any AC in a process of performing channel access to transmit a trigger frame. Here, when there are two or more ACs having the smallest backoff counter (i.e., two or more ACs having the same backoff counter), the AP may select one of the two ACs having the smallest backoff counter, and may generate a backoff counter of the corresponding AC again. Alternatively, the AP may determine an AC for which a new backoff counter is generated as any AC, which may also be a backoff regeneration method considering that the AP may use any AC in a process of performing channel access to transmit a trigger frame. While generating the new backoff counter, the AP may generate a new random number by using CWmin and add the remaining backoff counter of the corresponding AC thereto, thereby determining the new backoff counter. That is, when regenerating a new backoff counter in a situation in which a backoff counter of AC[VO] is 2, the AP may determine the new backoff counter of AC[VO] by adding 2 to a random number (natural number ranging from 0 to CWmin[VO]) generated using CWmin[VO].

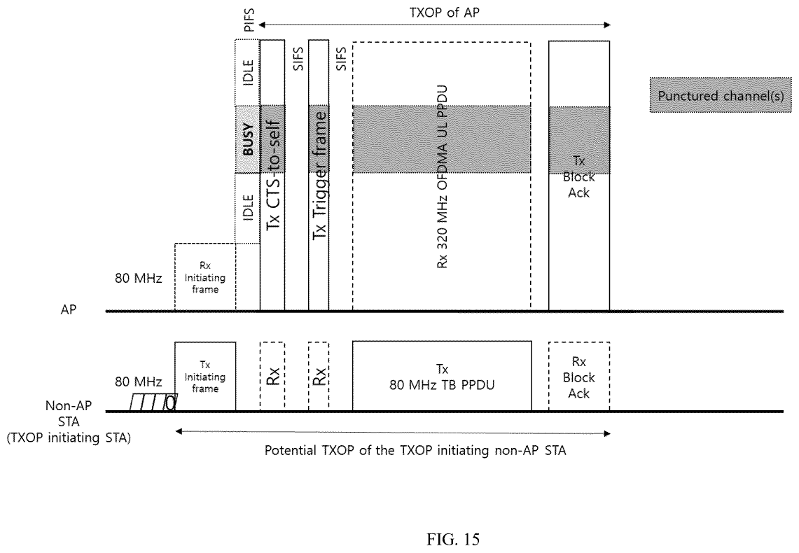

FIG. 15 illustrates an example of a frame exchange sequence in which a STA transfers a right to obtain a TXOP to another STA after completing a backoff procedure according to an embodiment of the present disclosure.

Referring to FIG. 15, a non-AP STA obtains a channel access right for an 80 MHz-band after completing a backoff procedure. The non-AP STA transmits an initiating frame to an AP instead of obtaining a TXOP. The initiating frame may have the same configuration as described in FIG. 14.

Upon receiving the initiating frame from the non-AP STA, the AP identifies CCA results of channels not only in an 80-MHz band in which the initiating frame is received but also in an operating BW thereof, and transmits a CTS-to-self frame to obtain a TXOP for a 320-MHz band. In the embodiment of FIG. 15, part of a band for which the AP obtains a TXOP is determined as busy, based on the CCA results, and is punctured by the AP.

After transmitting the CTS-to-self frame, the AP transmits a trigger frame to allocate an RU to one or more non-AP STAs. Here, the AP allocates an RU in the band occupied by a PPDU including the initiating frame to the non-AP STA having transmitted the initiating frame. The Non-AP STAs having received the trigger frame (including the non-AP STA having transmitted the initiating frame) respond with a TB PPDU, and the AP transmits a BlockAck to indicate whether reception is successful.

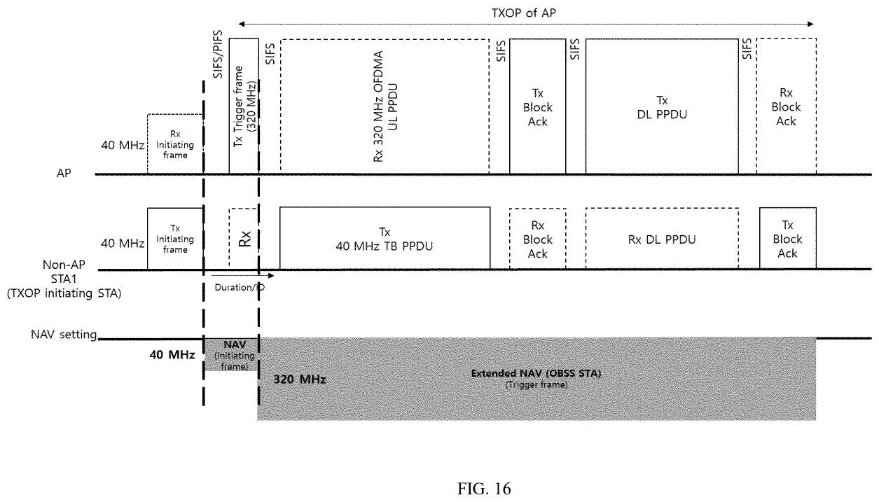

FIG. 16 illustrates an example of a frame exchange sequence for transferring a right to obtain a TXOP after a backoff procedure of an STA and an NAV state of other STAs according to an embodiment of the present disclosure.

Referring to FIG. 16, non-AP STA1 transmits an initiating frame to an AP. Here, non-AP STA1 is a non-AP STA that has obtained a channel access right (frame transmission right) according to an EDCA procedure. The initiating frame has a duration/ID field configuration for configuring an NAV for duration including a trigger frame that the AP transmits after obtaining a TXOP or transmits to obtain a TXOP. Therefore, as shown in FIG. 16, an NAV for a 40-MHz band in which the initiating frame is transmitted is configured. That is, within the 40-MHz band in which the initiating frame is transmitted, NAVs of STAs receiving the frame are configured.

In a situation shown in FIG. 16, the AP having received the 40-MHz initiating frame transmits a trigger frame in a 320-MHz band to attempt to obtain a TXOP, and a Duration/ID field of the trigger frame is configured for duration including a TB PPDU transmitted in response to the trigger frame. Therefore, an NAV for the 320-MHz band is configured through the trigger frame, and the AP may operate the TXOP without being disturbed by other STAs (such as OBSS STAs) within the obtained TXOP.

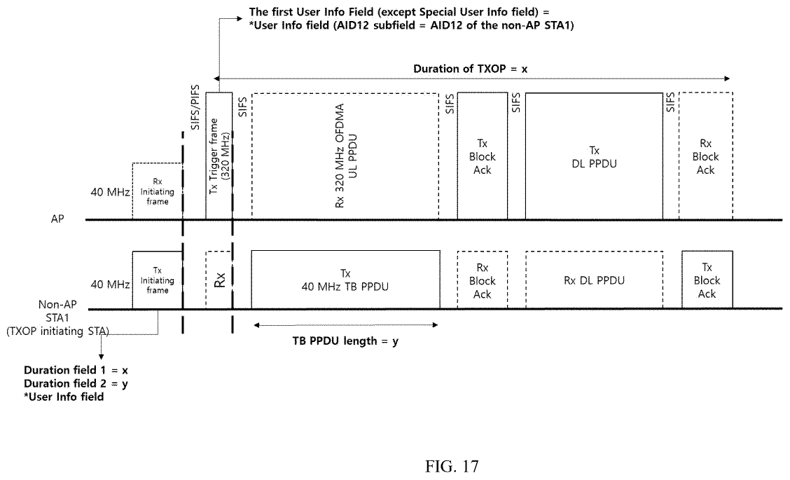

FIG. 17 illustrates an example of a format of an initiating frame and a trigger frame according to an embodiment of the present disclosure.

Referring to FIG. 17, a non-AP STA1 transmits an initiating frame to an AP, and the initiating frame has a configuration including Duration 1 and/or Duration 2 fields. Duration 1 includes information related to the length of a TXOP obtainable by the AP having received the initiating frame. Therefore, the AP obtains a TXOP, based on information identified in the Duration 1 field of the received initiating frame. The embodiment of FIG. 17 shows a situation in which the duration of the TXOP of the AP is determined as x when the Duration 1 field is indicated as x considering that the Duration 1 field directly indicates the length of the obtainable TXOP. However, the information indicated in the Duration 1 field may be information related to an access category (AC) used by the STA having transmitted the initiating frame for channel access or other types of information. Further, the AP may obtain only a TXOP with a shorter length than a TXOP length identified based on the Duration 1 field.

In addition, the initiating frame may have a configuration including a User Info field. The User Info field included in the initiating frame may be a field including information related to a configuration of a TB PPDU that the non-AP STA having transmitted the initiating frame intends to transmit. That is, the User Info field may be a field including information related to a MCS to be applied to the TB PPDU, size and/or location information about an RU for transmitting the TB PPDU, the number of antennas (spatial streams) to be used, and the like. Here, the name of each field used in the present disclosure is only for illustration, and the field actually has a different name, or each of pieces of information described as included in the field may be indicated through a separate field. In addition, information related to the length of the TB PPDU to be transmitted may be included, and the Duration field 2 illustrated in the embodiment of FIG. 17 may be a field including information related to the response length of the TB PPDU. Here, the information related to the response length of the TB PPDU may be a direct time length or the amount (queue size, buffer status, or the like) of traffic to be transmitted through the TB PPDU.

As a result, it is possible to indicate two different pieces of duration-related information (information related to the length of the obtainable TXOP and information related to the length of the TB PPDU) through the initiating frame. Here, at least one of the two different pieces of duration-related information may be indicated through a Duration/ID field of a MAC header. Alternatively, the two different pieces of duration-related information may be indicated in a frame body, and the Duration/ID field may be used for other purposes (such as NAV management of an OBSS).

In this case, a value indicated by the Duration 1 field among the two different pieces of duration-related information may be greater than a value indicated by the Duration 2 field.

The AP obtains a TXOP, based on pieces of information included in the received initiating frame, and then transmits a trigger frame. The length of the TXOP obtained by the AP is determined (limited) based on the duration-related information included in the initiating frame. In the embodiment of FIG. 17, the AP obtains a TXOP with a length of x, based on x indicated by the Duration field 1 included in the initiating frame.

The AP transmits the trigger frame to the non-AP STA having transmitted the initiating frame, based on the information included in the initiating frame. In the embodiment of FIG. 17, the AP transmits a trigger frame in which a User Info field corresponding to AID12 of the non-AP STA1 having transmitted the initiating frame is indicated first, and the User Info field is configured based on the information indicated through the initiating frame. As a result, the non-AP STA having transmitted the initiating frame receives the trigger frame, thereby responding with a TB PPDU in a manner requested by the non-AP STA.

### <Two-Step Channel Access Procedure>

According to an embodiment of the present disclosure described above, a non-AP STA may transmit an initiating frame to an AP after completing a backoff procedure, thereby instructing the AP to initiate a procedure of obtaining a TXOP. The procedure for the AP to obtain the TXOP may be appropriately replaced with a procedure for sharing a TXOP with the AP. That is, a series of procedures described above may be changed to a procedure in which the non-AP STA, which is a TXOP holder, shares a TXOP thereof with the AP by transmitting an initiating frame to the AP.

A method for applying the TXOP sharing procedure is briefly described as a series of processes in which the non-AP STA obtains a TXOP after completing the backoff procedure and shares the obtained TXOP with the AP thereof by transmitting an initiating frame.

The AP is allowed to perform an operation as if the AP is the TXOP holder during the shared TXOP. That is, the AP may perform an operation, such as transmitting a DL MU PPDU, transmitting a trigger frame to respond to a UL MU PPDU, or transmitting an RTS/MU-RTS frame to protect a subsequent frame exchange sequence during the shared TXOP. To this end, a series of operations defined in the existing Wi-Fi that the TXOP holder is able to perform may be allowed to be performed by the AP with which the TXOP is shared. That is, the AP may also transmit a CF-end frame to terminate the TXOP during the shared TXOP.

Therefore, a method for transferring an opportunity to obtain a TXOP illustrated above may be appropriately changed to a TXOP sharing procedure as below.
1. A non-AP STA attempts to obtain a TXOP after performing a backoff procedure through DCF or EDCA.
2. Upon obtaining a TXOP, the non-AP STA transmits, to an associated AP, a pre-agreed frame (hereinafter, a TXOP sharing frame) transmitted to share the obtained TXOP with the AP (the associated AP refers to an AP of a BSS to which the non-AP belongs as a member).
3. Upon receiving the TXOP sharing frame from the non-AP STA, the AP attempts TXOP BW extension for a channel identified as idle as a result of CCA within an operating BW of the AP.
4. The AP transmits a trigger frame or a DL (MU) PPDU by using an extended BW during the shared TXOP.
5. The AP may generate a new backoff counter after the shared TXOP expires.

Since operations in which the non-AP STA obtains the TXOP and shares the TXOP with the AP and applied restrictions in steps 1 to 5 are the same as/similar to the foregoing TXOP transfer method, a redundant description is omitted. However, since the operations are performed in a situation where the AP is not a TXOP holder, an additional management method for the operations performed in the situation where the AP is the TXOP holder may be applied as follows.

Non-AP STAs (such as second and third STAs) able to recognize that another non-AP STA (first STA) in the BSS is a TXOP holder may process frames transmitted by the AP after the TXOP is shared by the same method as frames received during the TXOP in which the AP is a TXOP holder. That is, the non-AP STAs may ignore an NAV (intra-BSS NAV) during the TXOP shared with the AP. Also, the AP may ignore an NAV configured by non-AP STA having transmitted a TXOP sharing frame.

More specifically, the non-AP STAs (such as the second and third STAs), which are not TXOP holders, may respond to an RTS/MU-RTS frame transmitted by the AP even though configuring an NAV by a frame transmitted by the other non-AP STA (first STA). That is, the non-AP STAs (such as the second or third STAs) receiving the RTS/MU-RTS frame transmitted during the TXOP with which the other non-AP STA (such as the first STA) shares with the AP may perform a CTS response to the RTS/MU-RTS frame even though the TXOP holder recognized by the non-AP STAs is not the AP. Here, a method for determining whether a non-AP STA performs a response when receiving a frame requesting a response, such as an RTS/MU-RTS/trigger frame received from an AP, may be determined based on whether a virtual CCA result identified by a basic NAV is idle. That is, a non-AP STA of which a basic NAV is identified as idle (basic NAV is 0) may respond to a RTS/MU-RTS/trigger frame transmitted by the AP even though an intra-BSS NAV is identified as busy (intra-BSS NAV is not 0) and the TXOP holder is identified to be another STA other than the AP, which may be an additional exception of the existing Wi-Fi CTS frame response condition that allows a first STA having received an RTS frame to respond with a CTS frame only when a second STA having transmitted the RTS frame is identified as a TXOP holder or when an NAV is 0 (i.e., the NAV indicates idle).

For reference, an intra-BSS NAV refers to an NAV configured after receiving a PPDU classified as an intra-BSS PPDU, and a basic NAV refers to an NAV configured after receiving a PPDU not classified as an intra-BSS PPDU. An intra-BSS PPDU refers to a PPDU classified as an inter-BSS PPDU according to intra-BSS and inter-BSS PPDU classification rules, and a method using information, such as a BSS color or an address field of a frame included in the PPDU is defined as a classification method. Since an intra-PPDU classification method is not related to TXOP transfer/sharing for an AP that the present disclosure intends to provide, a detailed description is omitted.

In summary, the TXOP holder of the TXOP is the non-AP STA, and the non-AP STA may transmit the frame in the pre-agreed format to the AP to share the obtained TXOP with the AP. The AP receiving the frame in the pre-agreed format from the non-AP STA may be allowed to perform an operation as if the AP is the TXOP holder during the TXOP of the non-AP STA. That is, the AP may perform an operation, such as transmitting a DL MU PPDU or transmitting a trigger frame, during the TXOP of the non-AP STA. Further, when the AP receives the frame in the pre-agreed format from the non-AP STA, the AP may attempt to access an additional idle subchannel other than a BW in which the non-AP STA obtains the TXOP. Here, a channel access procedure performed by the AP after receiving the frame in the pre-agreed format (TXOP sharing frame) may be understood as a secondary channel access procedure for BW extension. That is, a primary channel access procedure may refer to a process in which the non-AP STA obtains the TXOP after completing the backoff procedure, and the secondary channel access procedure may refer to a BW extension procedure performed by the AP that receives the frame from the STA having acquired the TXOP. Since it may be easily understood that the CCA procedure performed for BW extension and the operation of the AP performed during the shared TXOP may be similar to those in the foregoing TXOP transfer, a detailed description is omitted.

In addition, the procedure described above may be utilized to share a TXOP with an AP not only when a non-AP STA completes a backoff procedure but also when another AP completes a backoff procedure. For example, AP1 may transmit an initiating frame (or another frame transmitted for TXOP sharing) after completing a backoff procedure, thereby instructing AP2 to perform a sharing operation during the same time period as a TXOP obtained by AP1. Here, AP2 may perform an operation as if AP2 is a TXOP holder through the sharing operation. That is, AP2 may perform an operation, such as transmitting a DL PPDU or a trigger frame to associated STAs thereof during the time period shared by AP1. Accordingly, even though the foregoing or following embodiments of the present disclosure are described as an operation procedure performed by a non-AP STA with an AP thereof after completing a backoff procedure, it should be understood that a similar operation procedure may be equally applied between APs.

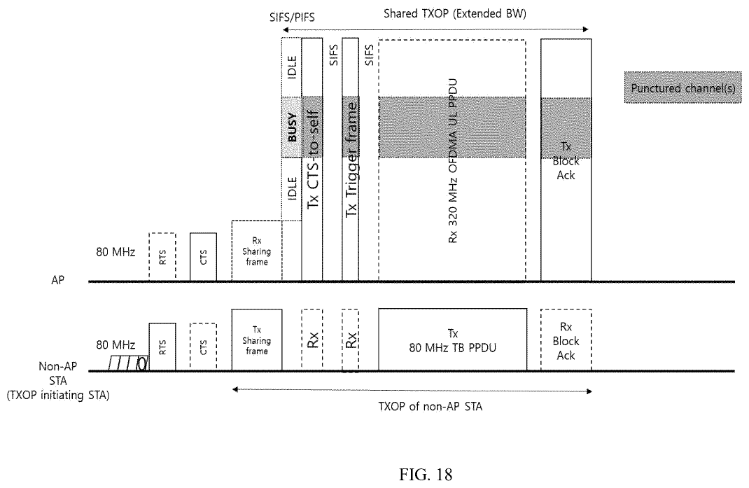

FIG. 18 illustrates an example of TXOP sharing between STAs and a bandwidth (BW) extension procedure according to an embodiment of the present disclosure.

Referring to FIG. 18, a non-AP STA transmits an RTS frame to an AP after completing a backoff procedure, and receives a CTS frame in response, thus becoming a TXOP holder. Subsequently, the non-AP STA transmits a TXOP sharing frame to the AP to share an obtained TXOP. Upon receiving the TXOP sharing frame, the AP performs CCA for operating channels thereof, and attempts BW extension for subchannels determined as idle. Here, although the has not obtained the TXOP, the AP performs an operation as if the AP is the TXOP holder. The drawing illustrated in the embodiment of FIG. 18 shows a procedure in which the AP transmits a CTS-to-self frame and transmits a trigger frame to request a response of a UL MU PPDU.

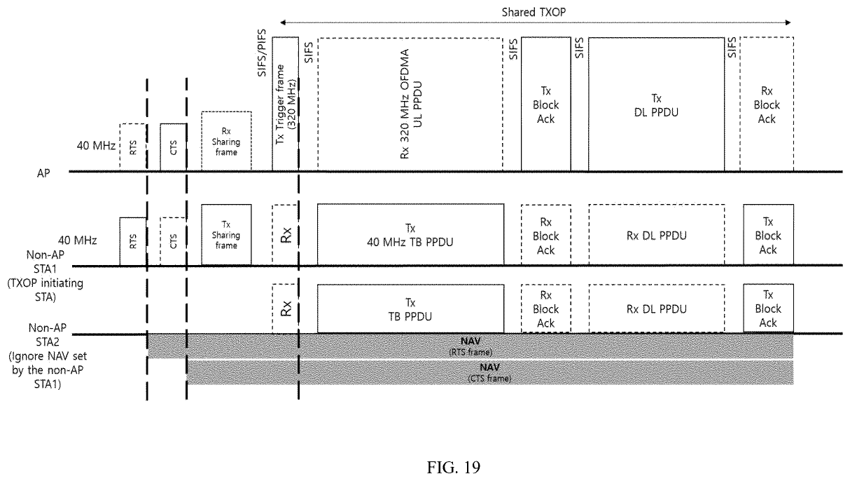

FIG. 19 illustrates an example of a TXOP sharing procedure and a TXOP holder operation of an STA according to an embodiment of the present disclosure.

Referring to FIG. 19, non-AP STA1 transmits an RTS frame to an AP after completing a backoff procedure, and receives a CTS frame in response, thus becoming a TXOP holder. Subsequently, non-AP STA1 transmits a TXOP sharing frame to the AP to share a TXOP.

Non-AP STA2 and OBSS STAs may recognize that the TXOP holder is non-AP STA1 after receiving the RTS transmitted by non-AP STA1 or the CTS frame transmitted by the AP. An NAV is configured to a time when the TXOP of non-AP STA1 expires.

After receiving the TXOP sharing frame from non-AP STA1, the AP transmits a trigger frame, which is one operation performed as a TXOP holder. The trigger frame is a trigger frame for requesting a response with a TB PPDU not only from non-AP STA1 but also from non-AP STA2, and non-AP STA2 responds with a TB PPDU even though identifying that the TXOP holder is non-AP STA1. That is, non-AP STA2 may respond to the frame received from the AP while ignoring the NAV of non-AP STA1 of the TXOP holder.

A time period in which the AP performs a frame exchange during the shared TXOP is protected by the NAV of the OBSS STAs configured through the frames exchanged in the process of non-AP STA1 becoming the TXOP holder.

### <Frame Format Used in TXOP Initiating/Sharing Procedure>

According to the foregoing embodiments of the present disclosure, when a non-AP STA completes a backoff procedure, the non-AP STA may transmit a frame for transferring an opportunity to obtain a TXOP to an AP. In addition, after obtaining a TXOP, the non-AP STA may transmit a frame for sharing the obtained TXOP with the AP.

An operation of the non-AP STA transferring the opportunity to obtain the TXOP to the AP or sharing the obtained TXOP may not be an advantageous operation in terms of the operation of the non-AP STA. From the perspective of the non-AP STA, it is an advantageous operation for the non-AP STA to obtain the TXOP and finish transmission of frames that the non-AP STA wants to transmit as quickly as possible during the TXOP, and an additional sequence performed to transfer or share the TXOP may be an unreasonable operation with no expected gain. Therefore, sufficient compensation needs to be given to the non-AP STA that transfers the opportunity to obtain the TXOP to the AP or shares the obtained TXOP with the AP.

A first consideration is that the non-AP STA having completed the backoff procedure needs to be guaranteed the same frame throughput as when the non-AP STA obtains and directly utilizes the TXOP. That is, even though the non-AP STA transfers the opportunity to obtain the TXOP to the AP or shares the obtained TXOP, the non-AP STA needs to be able to process the same amount of traffic as when the non-AP STA directly obtains and utilizes the TXOP. To this end, traffic that the non-AP STA wants to process and/or information related to the amount of the traffic needs to be indicated to the AP, and the AP may need to allocate sufficient resources to the non-AP STA, based on the indicated information.

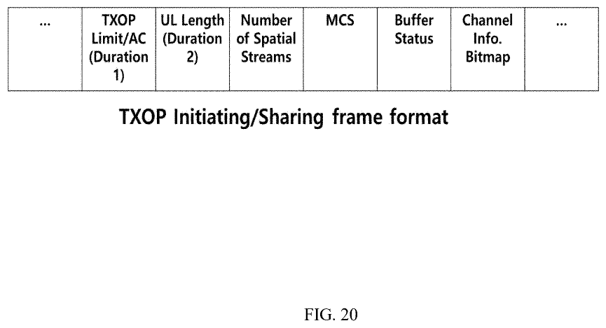

FIG. 20 illustrates an example of a format for a frame for transferring a right to obtain a TXOP or sharing a TXOP according to an embodiment of the present disclosure.

Referring to FIG. 20, an initiating frame may include a subfield related to a TXOP limit or an AC. The subfield related to the TXOP limit or the AC may be a field configured based on an access category for which a non-AP STA transmitting the corresponding frame has completed a backoff procedure. An AP may determine the length of an obtained TXOP, based on the information indicated by the corresponding field. When included in a TXOP sharing frame, the TXOP limit field may be a field used to indicate duration of the TXOP that the non-AP STA wants to share with the AP. A time indicated by the corresponding field needs to be the same as or earlier than the end time of the TXOP obtained by the non-AP STA.

A UL Length field is a field indicating the frame length of a TB PPDU to be transmitted by the non-AP STA transmitting the corresponding frame. The AP that transmits a trigger frame to the non-AP STA after receiving the TXOP initiating/sharing frame may transmit the trigger frame with a UL Length field configured to the same value as indicated in the UL Length field of the TXOP initiating/sharing frame.

A Number of Spatial Streams field indicates the number of spatial streams to be used by the non-AP STA transmitting the TXOP initiating/sharing frame when transmitting the TB PPDU. The AP that transmits the trigger frame to the non-AP STA after receiving the TXOP initiating/sharing frame may need to transmit the trigger frame allocating to the non-AP STA as many spatial streams as the number of spatial streams indicated in the Number of Spatial Streams field of the TXOP initiating/sharing frame. That is, when transmitting the trigger frame, the AP needs to configure an SS Allocation subfield of a User Info field having an AID12 value indicating the non-AP STA to the same value as the Number of Spatial Streams field included in the TXOP initiating/sharing frame transmitted by the non-AP STA.

A MCS field indicates a modulation and coding scheme (MCS) to be used by the non-AP STA transmitting the TXOP initiating/sharing frame when transmitting the TB PPDU. The AP that transmits the trigger frame to the non-AP STA after receiving the TXOP initiating/sharing frame may need to transmit the trigger frame allocating to the non-AP STA as many spatial streams as the number of spatial streams indicated in the Number of Spatial Streams field of the TXOP initiating/sharing frame. That is, when transmitting the trigger frame, the AP needs to configure a (HE/EHT/UHR) MCS field of the User Info field having an AID12 value indicating the non-AP STA to the same value as the MCS field included in the TXOP initiating/sharing frame transmitted by the non-AP STA.

A Buffer Status field indicates information related to the amount of buffered traffic possessed by the non-AP STA transmitting the TXOP sharing/initiating frame. Alternatively, the field may be replaced with a field including information related to the size and/or location of a BW or RU in which the non-AP STA responds with the TB PPDU. The AP may configure an RU Allocation subfield (and PS 160 and PS 320 subfields) of the User Info field corresponding to the non-AP STA transmitting the TXOP initiating/sharing frame in the trigger frame transmitted after receiving the TXOP initiating/sharing frame, based on the information indicated by the Buffer Status field of the TXOP initiating/sharing frame.

A Channel Info. Bitmap field is a field indicating whether subchannels identified when the non-AP STA transmitting the TXOP initiating/sharing frame performed channel access are idle/busy. Each bit of the Channel Info. Bitmap field corresponds to each different subchannel, is configured to 1 (or 0) when the corresponding subchannel is identified as idle, and is configured to 0 (or 1) when the corresponding subchannel is identified as busy. Among the bits of the Channel Info. Bitmap field, bits corresponding to subchannels for which the non-AP STA configuring the field is unable to determine idle/busy states are configured in a preset manner. A method for configuring the bits corresponding to the subchannels for which the idle/busy states may not be determined may be configuring the bits to the same value as a set value of a bit corresponding to a busy subchannel. That is, when the Channel Info. Bitmap field includes 16 bits to each correspond to 16 20-MHz subchannels included in a 320-MHz band, the non-AP STA performing an 80-MHz operation configures the idle/busy states of four subchannels (or three subchannels excluding a primary 20-MHz subchannel) to 1/0, and configures the idle/busy states of the remaining 12 subchannels to 0, thereby indicating the Channel Info. Bitmap field. The AP needs to allocate only an RU included in a subchannel that the non-AP STA transmitting the corresponding frame determines as idle to the non-AP STA in the trigger frame transmitted after receiving the TXOP initiating/sharing frame.

A second consideration is that non-AP STAs following a TXOP transfer/sharing procedure provided by the present disclosure need to be sufficiently obtained. When there is no non-AP STA capable of performing the TXOP transfer/sharing procedure among non-AP STAs that are members of a BSS, the BSS may not obtain effects to be provided by the present disclosure. Therefore, the AP may preferentially perform a service for non-AP STAs capable of supporting the TXOP transfer/sharing procedure among the non-AP STAs that are the members of the BSS, thereby inducing the non-AP STAs to actively support the TXOP transfer/sharing procedure. In this process, the AP may preferentially perform scheduling (for a DL/UL frame exchange) for the non-AP STAs supporting the TXOP transfer/sharing procedure during a TXOP obtained (shared) through the TXOP transfer/sharing procedure. That is, the AP may be allowed to apply preferential scheduling to the non-AP STAs supporting the TXOP transfer (transferring the opportunity to obtain the TXOP after the non-AP STA completes the backoff procedure) or TXOP sharing (sharing the TXOP obtained by the non-AP STA) procedure.

The above-described embodiments of the present disclosure are described in consideration of transmission of a TXOP initiating/sharing frame to an associated AP by a non-AP STA, but the same operation can be performed between APs. In other words, after acquiring a TXOP, a first AP may transmit a TXOP sharing frame to share the TXOP to a second AP. In this process, extension of a BW by AP 2 is also possible. In addition, when a BW in which the first AP acquires the TXOP is less than an operating bandwidth of the second AP, the first AP may derive, through an initiating frame that the first AP transmits, the second AP to perform frame exchanging in a band in which the first AP fails to acquire the TXOP. In this case, the TXOP sharing frame transmitted to the second AP by the first AP may be a frame classified as an MU-RS type. In this case, the TXOP sharing frame transmitted to the second AP by the first AP may be a frame indicating, to the second AP, an RU not included in the BW in which the first AP acquires the TXOP.

The frame transmitted to the AP by the non-AP STA to share the TXOP may be an MU-RTS TXS (MU-RTS TXOP sharing) trigger frame. In this case, the MU-RTS TXS trigger frame may indicate a trigger frame in which a triggered TXOP sharing mode subfield included in a common info field of the trigger frame is not 0. The non-AP STA needs to include only one user info field when transmitting the MU-RTS TXS trigger frame to the AP. In this case, the user info field may indicate TB PPDU-related parameters that the non-AP STA wants to receives from the AP as it is considered in the above-described embodiments of the present disclosure.

### <Channel Access Procedure for Bandwidth (BW) Extension>

As described above, according to an embodiment of the present disclosure, when receiving a control frame (an initiating frame and/or a sharing frame) transmitted by the non-AP STA after acquiring a channel access right, the AP may attempt channel access to a band wider than a band in which the control frame is received. In other words, the AP having received the control frame (initiating frame and/or sharing frame) transmitted by the non-AP STA may attempt access to a subchannel not occupied by the control frame.

However, the AP accessing an additional subchannel other than the subchannel occupied by the control frame may need to perform a procedure of acquiring an access right for the subchannel.

It has been considered in the above-described embodiments that in a case where the AP accesses an additional subchannel other than the subchannel on which the control frame is received, when each subchannel is determined to be idle as a result of CCA performed during an SIFS or a PIFS, additional access to the corresponding subchannel is performed. Accordingly, the procedure of performing access to the additional subchannel, based on the result of CCA performed during the SIFS or the PIFS may be considered to be similar to a procedure in which an STA having completed a backoff procedure in a primary channel accesses secondary channels, but this may cause a fairness issue with heterogeneous devices.

More specifically, for access to each 20 MHZ subchannel, some heterogeneous devices perform independent listen before talk (LBT) (similar to a backoff procedure of Wi-Fi) for each subchannel, and then perform channel access only for subchannels for which a channel access right has been acquired by the LBT. Accordingly, the operation in which the AP receives the control frame, only performs SIFS/PIFS CCA, and then accesses an additional subchannel may be considered to be a more aggressive channel access method than the corresponding heterogeneous devices.

In addition, similar to the case where Wi-Fi accesses a BW exceeding 20 MHz, the heterogeneous devices use a channel access method of accessing additional subchannels determined to be idle when completing LBT in a specific 20 MHz subchannel (primary channel) (when acquiring a channel access right). However, a condition that heterogeneous devices access additional subchannels is limited to the case where the channel access right is acquired in the specific 20 MHz subchannel, and accordingly, the behavior of accessing the additional subchannels when the AP receives the control frame may be considered as an aggressive channel access method even compared with the heterogeneous devices.

Accordingly, for a harmonious operation with heterogeneous devices using an unlicensed band together, according to an embodiment of the present disclosure, the AP receiving the control frame from the non-AP STA and accessing the additional subchannel may also need to access the additional subchannel after completing the backoff procedure.

The channel access method for BW extension below is a specific method in which the AP accesses not only a subchannel occupied by the control frame received from the non-AP STA but also an additional subchannel, and is thus a method that can be performed without the fairness issue with heterogeneous devices. In this case, the meaning of the BW extension includes both acquiring a channel access right for a BW wider than a BW of a PPDU including the control frame, and acquiring a channel access right for an additional subchannel other than the subchannel occupied by the control frame. That is, even though the BW acquired by the AP having received the control frame is identical to the BW of the PPDU including the control frame, it may be considered that the BW has been extended when the number of subchannels on which the channel access right is acquired is greater than the number of subchannels occupied by the control frame.

According to an embodiment of the present disclosure, when an entire bandwidth includes one primary channel block (or a primary channel) and one or more secondary channel blocks (or secondary channels), a station (non-AP STA or AP) may select one secondary channel block from among the one or more secondary channel blocks rather than a primary subchannel included in the primary channel block, perform a channel access procedure through a secondary subchannel included in the selected secondary channel block, and acquire a TXOP. That is, the station may perform a channel access through a secondary subchannel rather than a primary subchannel and acquire a TXOP.

In another embodiment of the present disclosure, when the TXOP is acquired through the secondary subchannel according to the method above, the frequency range in which the TXOP is acquired may be limited within the secondary channel block including the secondary subchannel in which the channel access procedure is performed. That is, the station having performed the channel access procedure through the secondary subchannel may perform transmission or reception only within a secondary channel including the secondary subchannel within the acquired TXOP.

In another embodiment of the present disclosure, when a station (e.g., an AP or a non-AP STA) receives a TXOP (first TXOP) shared from another station (e.g., a non-AP STA or an AP), the station may perform a channel access procedure through the shared TXOP. However, when a primary subchannel of a primary channel block is occupied by another station (e.g., an OBSS STA) within the shared TXOP, the station cannot perform the channel access procedure in the primary subchannel. In this case, the station may select one secondary channel block from among secondary channel blocks supported among the entire bandwidth rather than the primary subchannel of the primary channel, and perform a channel access procedure through a secondary subchannel included in the selected secondary channel block, and may acquire a TXOP (second TXOP). In this case, the first TXOP may be used for frame transmission or reception up to a frequency range supported by another station having shared the first TXOP on the frequency axis, but the frequency range in which the second TXOP is acquired may be limited to the secondary channel including the secondary subchannel in which the channel access is performed.

In another embodiment of the present disclosure, the second TXOP acquired through the method above may end at the same time point as the first TXOP, and the second TXOP may be considered as extension of the first TXOP on the frequency axis. That is, when the first TXOP is shared, the station may extend the frequency axis range of the first TXOP to the second TXOP through the channel access procedure through the secondary subchannel. In this case, another station may not support the secondary channel for acquisition of the second TXOP. For example, the total bandwidth may be 320 MHz, and the total bandwidth may include one 80 MHz primary channel and 80 MHz and 160 MHz secondary channels. In this case, the 160 MHz secondary channel may be divided into a low 80 MHz channel and a high 80 MHz channel. In this case, one of the four 80 MHz bands may be a primary bandwidth (or primary channel) including a primary subchannel for channel access, and the remaining three may be secondary bandwidths (or secondary channels). A first station (e.g., an AP or a non-AP STA) may support up to 320 MHz, and a second station may support up to 160 MHz. The second station may perform a channel access procedure (a first channel access procedure) through a primary subchannel of a primary bandwidth, and may acquire a TXOP (a first TXOP) through the first channel access procedure and share the same to the first station. The first station may transmit or receive a frame through the shared first TXOP. However, when the primary subchannel is occupied by another station (e.g., an OBSS station) within the first TXOP, the first station cannot perform channel access and frame transmission and reception through the primary subchannel. Accordingly, the first station may select one secondary bandwidth in which a channel is not occupied by other stations and is idle from among three secondary bandwidths and change the channel to the selected secondary bandwidth, and may perform a channel access procedure (a second channel access procedure) through a secondary subchannel of the changed secondary bandwidth and acquire a TXOP (a second TXOP). In this case, the frequency axis range in which the first TXOP is acquired is up to 160 MHz including a primary bandwidth that can be supported by the second station, and the frequency axis range in which the second TXOP is acquired is up to 80 MHz corresponding to the secondary bandwidth including a subchannel in which the first station has performed the second channel access procedure (or up to a 160 MHz secondary channel including the corresponding secondary bandwidth). In addition, the second TXOP may be considered as extension of the first TXOP, and may end at the same time point as the end time point of the first TXOP.

In another embodiment of the present disclosure, when the first station performs the channel access procedure through the secondary bandwidth that is not supported by the second station (when the second station supports only primary 160 MHz of 320 MHz and the first station performs channel access in the low 80 MHz of the secondary 160 MHz) and acquires the TXOP, the first station may indicate the second station to move to the secondary 160 MHz and operate in order to change an operating channel of the second station. For example, the first station may transmit a frame (e.g., a trigger frame) indicating a change of the operating channel to the second station within the acquired second TXOP, and the second station having received the corresponding frame may move to the channel (e.g., low 80 MHz of the secondary 160 MHz) indicated in the frame and perform an operation of receiving a downlink frame or transmitting an uplink frame, indicated through the frame.

### <1. Performing Backoff Procedure for Each 20 MHz Subchannel>

In the channel access method by the present embodiment, the AP may simultaneously perform a backoff procedure in multiple subchannels (including a primary channel) included in the operating bandwidth (BW), and may perform channel access to a subchannel occupied by a PPDU included a control frame and idle subchannels for which the backoff procedure has been completed when the control frame is received from the non-AP STA. In this case, when the backoff procedure is simultaneously performed in the multiple subchannels may indicate that separate backoff procedures are performed in the multiple subchannels, respectively and are performed in parallel over time.

Specifically, the AP performs the backoff procedure in multiple subchannels included in the operating bandwidth. For example, the AP, the operating bandwidth of which is 80 MHZ, performs the backoff procedure in each of four 20 MHz subchannels included in the 80 MHz bandwidth. In this case, when the AP completes the backoff procedure performed in the primary 20 MHz channel, the AP may acquire a channel access right for subchannels identified to be idle among the four subchannels in the 80 MHz bandwidth according to the conventional Wi-Fi operation.

However, even though the backoff procedure performed in a subchannel other than the primary 20 MHz channel is completed, the AP cannot access the other subchannel. This may be a constraint applied because the AP has not already acquired the channel access right for the primary 20 MHz channel and cannot perform transmission without occupying the primary 20 MHz channel.

Accordingly, the AP may perform a standby operation until an access right for the primary 20 MHz channel is acquired while being in the state in which a channel access right for other subchannels (subchannels other than the primary 20 MHz subchannel) for which the backoff procedure has been completed is acquired (in the state in which the backoff procedure has been completed). In this case, when a backoff counter of the backoff performed in a subchannel other than the primary 20 MHz subchannel becomes 0, the AP may maintain the corresponding backoff counter as 0 until the access right for the primary channel is acquired. That is, the AP may not initiate transmission in the state in which the backoff counter of the subchannel other than the primary 20 MHz subchannel is 0. In this case, the operation of not initiating transmission by the AP may continue until the channel access right for the primary 20 MHz channel is acquired.

As it is considered in the above-described embodiment of the present disclosure, the non-AP STA having acquired the channel access right may share the TXOP that the non-AP STA has acquired to the AP by transmitting a control frame (TXOP sharing frame) to the AP. In this case, the non-AP STA performs the channel access procedure only in the primary 20 MHz subchannel, and thus the channel access right acquired by the non-AP STA includes a channel access right for the primary 20 MHz subchannel. Accordingly, when the non-AP STA shares the channel access right for the primary 20 MHz subchannel to the AP by transmitting the control frame to the AP, the AP may initiate access to the 20 MHz channel.

In this case, the AP accessing the primary channel by using the TXOP shared by the non-AP STA may also initiate channel access to subchannels for which the AP has already acquired the channel access right (for which the backoff procedure has been completed). That is, when the AP accesses the primary channel by using the TXOP acquired by the non-AP STA, the AP may also initiate channel access to additional subchannels for which the backoff procedure has already been completed.

That is, according to the present embodiment, the AP for extending the BW may perform the backoff procedure for each 20 MHz subchannel in parallel, may access, when the channel access right for the primary channel acquired by the non-AP STA is shared from the non-AP STA, the primary channel by using the shared right, and also access other subchannels for which the channel access right has been acquired through the backoff procedure (for which the backoff procedure has been completed, i.e., the backoff counter is 0), thereby complete the channel access procedure for BW extension.

However, the operation of performing parallel backoff for each 20 MHz subchannel may result in causing excessive power consumption by the AP in the channel access process. For example, the AP having the 320 MHz operating bandwidth needs to perform the backoff procedure for each of 16 20 MHz-subchannels for channel access, and thus by simple calculation, the power consumption of the channel access procedures is expected to be 16 times greater. This is because the parallel backoff operation requires determination of an idle/busy state of each subchannel for each slot unlike the operation of the conventional AP performing CCA of different subchannels only when the backoff procedure performed in the primary 20 MHz subchannel has been completed.

Accordingly, the AP can secure the channel access right by performing the parallel backoff for each 20 MHz subchannel, and reduce a period of performing the parallel backoff. In the specific method of reducing a period of performing the parallel backoff performed by the AP, the parallel backoff of the AP is initiated only when the control frame transmitted by the non-AP STA is received at the AP.

More specifically, when the AP receives the control frame from the non-AP STA while performing the backoff procedure only in the primary 20 MHz channel, the AP may initiate/perform each 20 MHz channel access procedure (backoff procedure) for the additional subchannel to acquire the channel access right for the additional subchannel. In this case, the non-AP STA may add padding to the PPDU including the control frame that the non-AP STA transmits, so as to assist in completing the backoff procedure (performed in a subchannel other than the primary channel) of the AP during a time interval secured by the padding. In this case, the amount of included padding may correspond to a pre-configured length, or may be a length configured based on a value indicated by the AP. In this case, padding may be PHY and/or MAC padding. In this case, the meaning of the padding may mean anything that can extend the length of the PPDU, in addition to the control frame transmitted for TXOP sharing. That is, the non-AP STA may dispose the control frame as a first frame and aggregate other frames (UL traffic) so as to derive the other frames to serve a role similar to padding.

As another method, the AP may perform the backoff procedure for a band greater than 20 MH without performing the backoff procedure for each 20 MHz subchannel. For example, in addition to the backoff procedure performed in the primary 20 MHz subchannel, the AP may perform the backoff procedure for secondary 80 MHz, low 80 MHz if secondary 160 MHz, and high 80 MHz of secondary 160 MHz. Accordingly, the AP may acquire a channel access right in units of 80 MHz when accessing a band other than the primary 80 MHz band. This may be a channel access method considered because the number of subchannels included in the operating bandwidth of the Wi-Fi AP may be large and the backoff procedure performed for each 20 MHz subchannel excessively increases the operation complexity at the AP end. That is, the AP may apply a single backoff procedure for a band exceeding 20 MHz, thereby acquiring the channel access right for the band exceeding 20 MHz through the single backoff procedure.

As another method, the AP may select a specific 20 MHz subchannel for a channel access procedure for each predetermined bandwidth, and perform the channel access procedure (backoff procedure) through the corresponding subchannel. More specifically, the AP may select one 20 MHz subchannel for a channel access procedure for each of the four 80 MHz bands existing in a 320 MHz BW. In this case, among the four 80 MHz bands, a primary 20 MHz subchannel may always need to be selected for a primary 80 MHz band. In addition, when the AP is operated on the 6 GHz band, the AP may need to perform the channel access procedure for each 80 MHz band in a channel to be used as a primary channel according to a 6 GHz rule among the respective 80 MHz bands. In this case, the channel to be used as the primary channel according to the 6 GHz rule means a scanning channel (preferred scanning channel (PSD)) preferred by the non-AP STA. In this case, the scanning channel preferred by the non-AP STA corresponds to one 20 MHz subchannel within each 80 MHz BW of the 6 GHz band, and means a subchannel in which the center frequency is (channel starting frequency-55+(80×n)) MHz. In this case, n has a value of 1 to 15.

In this case, when the channel access procedure performed in the specific 20 MHz subchannel of each 80 MHz band is already completed, the AP may additionally access an idle channel of each 80 MHz band when initiating transmission in the primary 20 MHz channel. In this case, the AP operation of initiating the transmission of the primary 20 MHz channel may be performed by utilizing a TXOP shared by the non-AP STA. When the channel access procedure performed in the specific 20 MHz subchannel of the specific 80 MHz band has not been completed, the AP cannot access subchannels of the specific 80 MHz band when initiating transmission in the primary 20 MHz channel. In this case, the method of selecting each specific 20 MHz subchannel (a subchannel in which the channel access procedure is performed) for the 80 MHz band is merely provided as an example, and each specific 20 MHz subchannel may be selected for a 160 MHz band or a 320 MHz band. Even though the specific 20 MHz subchannel in which the channel access procedure is performed is selected for each of other bandwidths rather than for each 80 MHz band, the channel access right for each idle subchannel can be acquired using the same/similar method, and thus a redundant description is omitted.

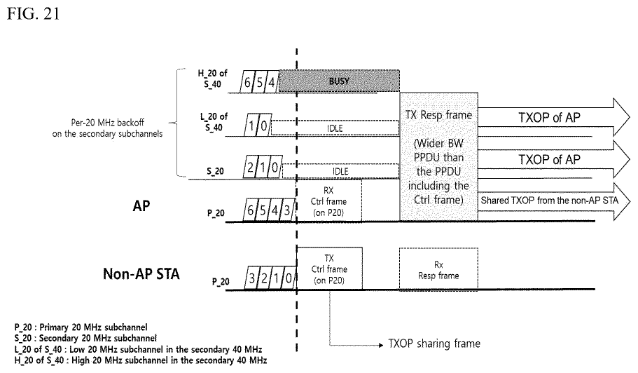

FIG. 21 illustrates an example of a method of performing channel access by using a subchannel according to an embodiment of the present disclosure.

Referring to FIG. 21, after receiving a control frame from a non-AP STA, an AP may access a channel by utilizing an additional subchannel for which a channel access right has been secured.

Specifically, the AP and the non-AP STA perform a backoff procedure in a primary channel for channel access. The non-AP STA having completed the backoff procedure faster than the AP transmits a control frame (Ctrl frame) to the AP. In this case, the control frame is a frame transmitted by the non-AP STA to share a TXOP that the non-AP STA has acquired to the AP.

In this case, the AP has been performing the backoff procedure for channel access for each of the other subchannels as well as the primary channel (P_20), and has already completed the backoff procedure performed in two subchannels (S_20 and L_20 of S_40).

The AP having received the control frame from the non-AP STA in the primary channel responds with a respond frame to additional subchannels (S_20 and L_20 of S_40) for which the channel access right has been already secured (for which the backoff procedure has been completed) as well as the primary channel (P_20) occupied by the control frame. In this case, among the subchannels to which the AP has transmitted the response frame, a TXOP of the AP starts in a subchannel other than the primary channel occupied by the control frame. That is, the AP accesses the primary channel by using a TXOP shared through the control frame transmitted by the non-AP STA, and simultaneously accesses the primary channel and additional subchannels for which the AP has already completed the backoff procedure.

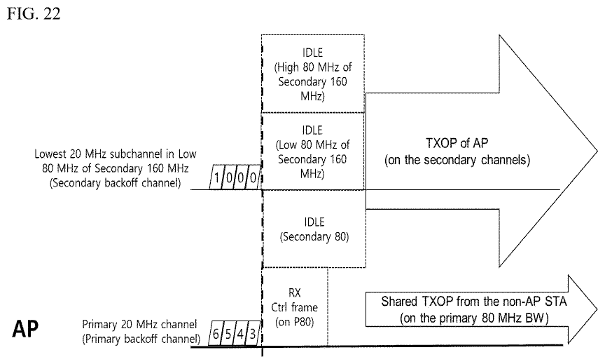

FIG. 22 illustrates another example of a method of performing channel access by using a subchannel according to an embodiment of the present disclosure.

Referring to FIG. 22, after receiving a control frame from a non-AP STA, an AP may access a channel by utilizing an additional subchannel for which a channel access right has been secured.

In order to avoid redundancy, the same description as that made in FIG. 21 can be omitted.

Specifically, the AP performs a backoff procedure in an additional subchannel as well as a primary 20 MHz channel. In this case, the additional subchannel is a part of subchannels included in an operating bandwidth of the AP.

The AP has received the control frame transmitted by the non-AP STA before the backoff procedure performed in the primary 20 MHz channel is completed, and is shared with a TXOP for subchannels occupied by the control frame from the non-AP STA. The AP access the channel by using the shared TXOP and simultaneously accesses an additional subchannel for which the channel access rights has been already secured. In this case, the method of securing the channel access right for the additional subchannel by the AP may be accessing subchannels identified to be idle as a result of CCA performed a PIFS before accessing the additional subchannel for which the backoff procedure has been already completed. That is, the AP accesses the primary channel by using the shared TXOP through the control frame transmitted by the non-AP STA, simultaneously accesses the primary channel and the additional subchannel for which the AP has already completed the backoff procedure, and performs PIFS access for additional subchannels.

Accordingly, the AP accesses, using the TXOP shared by the non-AP STA, a primary 80 MHz band occupied by the PPDU of the control frame transmitted by the non-AP STA, and simultaneously, the AP accesses additional subchannels for which the channel access right has been secured through the backoff procedure performed in the addition subchannel by the AP and PIFS CCA. That is, the AP responds with a Resp frame to the control frame through all the remaining additional subchannels for which the channel access procedure has been completed as well as the P_80 channel (i.e., responds for the 320 MHz band in FIG. 22).

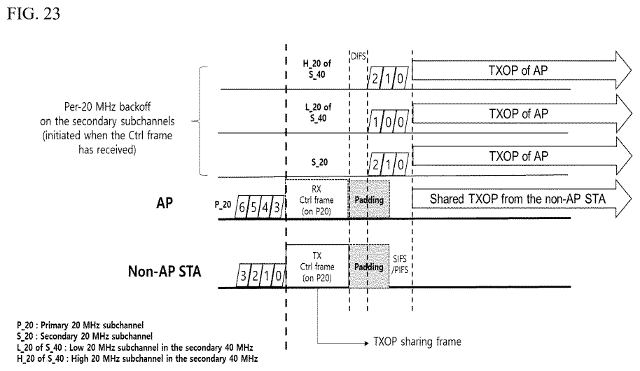

FIG. 23 illustrates an example of a method for initiating a channel access procedure by using a subchannel according to an embodiment of the present disclosure.

Referring to FIG. 23, after receiving a control frame from a non-AP STA, the AP may initiate a channel access procedure to access an additional subchannel.

To avoid redundancy, the same description as those made in FIGS. 21 and 22 can be omitted.

Specifically, the AP and the non-AP STA perform a backoff procedure in a primary channel for channel access. The non-AP STA having completed the backoff procedure faster than the AP transmits a control frame (Ctrl frame) to the AP. In this case, a PPDU including the control frame additionally includes padding.

In order to secure a channel access right for additional subchannels not occupied by the control frame, the AP having received the control frame from the non-AP STA initiates a backoff procedure for each of the additional subchannels. In this case, the backoff procedure initiated in each additional subchannel by the AP has been performed for a time consumed due to padding added to the PDDU including the control frame, and the AP completes the backoff procedures performed in the S_20, L_20 of S_40, and H_20 of S_40 subchannels.

Accordingly, the AP accesses a primary 20 MHz subchannel (P_20) occupied by the PPDU of the control frame transmitted by the non-AP STA by using the TXOP shared by the non-AP STA and simultaneously accesses additional subchannels for which the channel access right has been secured by the AP through the backoff procedure. That is, the AP responds with a Resp frame to the control frame through all the remaining additional subchannels for which the channel access procedure has been completed as well as the P_20 channel (i.e., responds for the 80 MHz band in FIG. 23).

That is, the AP accesses a primary channel by using the TXOP shared through the control frame transmitted by the non-AP STA, and simultaneously accesses the primary channel and additional subchannels for which the backoff procedure has been already completed by the AP.

<2. Performing Channel Access Procedure During TXOP Period Shared from Non-AP STA>

As another method, the AP may perform a channel access procedure (backoff procedure) in a primary 20 MHz subchannel during a TXOP period shared from the non-AP STA, and may access the primary 20 MHz subchannel and additional subchannels identified to be idle when the channel access procedure (backoff procedure) has been completed. That is, the AP may be a TXOP holder of the TXOP including the primary 20 MHz subchannel and the additional subchannels. In this case, when the AP determines whether the additional subchannels rather than the primary 20 MHz subchannels is idle/busy, the determination may be based on a CCA result identified during a PIFS (SIFS (16 μs)+aSlotTime (9 μs), i.e., 25 μs) in each subchannel.

This channel access procedure can be achieved by performing an operation in which the AP ignores an NAV configured by a frame transmitted by the non-AP STA during the TXOP interval shared from the non-AP STA. That is, when receiving the frame sharing the TXOP acquired by the non-AP STA from the non-AP STA, the AP may determine a virtual CCA result (by simply description, a CCA scheme of determining to be busy when the NAV is not 0) of the primary channel to be idle regardless of the NAV value configured due to the frame transmitted by the non-AP STA. That is, the AP may ignore the NAV configured due to the non-AP STA and perform the channel access procedure in the primary 20 MHz channel during the TXOP shared from the non-AP STA.

When the AP completes the channel access procedure (i.e., completes the backoff procedure and acquires the channel access right) in the primary 20 MHz channel during the TXOP shared to the AP by the non-AP STA, the AP may attempt channel access to additional subchannels identified to be idle, including the primary 20 MHz channel. In this case, the TXOP of the non-AP STA may be terminated, and the TXOP of the AP may be initiated. That is, the TXOP acquired by the non-AP STA is terminated when the AP completes the channel access procedure during the shared time interval, and the TXOP of the AP is initiated.

This may be considered as the AP channel access method to which the method identical/similar to the above-described channel access method of accessing, by heterogenous devices, additional subchannels determined to be idle when the LBT is completed in the specific 20 MHz subchannel (primary channel) is applied. However, there is a difference in that the channel access by the AP can be performed within the TXOP acquired by the non-AP STA.

That is, it may be understood that when the non-AP STA shares, to the AP, the TXOP acquired by the non-AP STA, the non-AP STA performs TXOP sharing in consideration of the initiation of the TXOP of the AP after the AP acquires the channel access right in the TXOP acquired by the non-AP STA.

In this case, the control frame (TXOP sharing frame) transmitted to share the TXOP acquired by the non-AP STA to the AP includes a function of deriving Wi-Fi STAs having received the corresponding frame to configure the NAV. Accordingly, other STAs having received the control frame transmitted by the non-AP STA need to determine that the virtual CCA result of the primary 20 MHz channel is busy until the NAV configured due to the corresponding frame is released (or becomes 0), and consequently, channel access is restricted.

In addition, the AP may transmit a response frame when receiving the control frame (the TXOP sharing frame) from the non-AP STA. In this case, the response frame transmitted by the AP includes a function of deriving the STAs having received the corresponding response frame to configure the NAV. Accordingly, other STAs having received the response frame transmitted by the AP need to determine that the virtual CCA result of the primary 20 MHz channel is busy until the NAV configured due to the corresponding frame is released (becomes 0), and consequently, channel access is restricted.

That is, due to the NAV configured through the response frame transmitted by the AP and the control frame transmitted by the non-AP STA, channel access by the STAs of the BSS and the neighboring STAs are restricted, and only the AP may ignore the NAV configured due to the non-AP STA (the STA having transmitted the non-AP STA) and complete the channel access procedure. In this case, the meaning of completing the channel access procedure is invoking the backoff procedure for channel access, and acquiring a channel access right by performing the operation of reducing the backoff counter, etc. (the backoff counter becomes 0).

In this case, the NAV configured due to the control frame transmitted by the non-AP STA can be configured through a method identical/similar to the above-described duration/ID configuration method considered in an embodiment of the present disclosure, and thus a detailed description thereof is omitted. However, when configuring a duration/ID field of the control frame, the non-AP STA may additionally consider a time required for the AP to complete the channel access procedure.

In addition, the AP may invoke/perform the backoff procedure only when the TXOP shared from the non-AP STA is longer than (or equal to or longer than) a predetermined time. That is, when the TXOP shared from the non-AP STA is shorter than (or shorter or equal to) the predetermined time, the AP may be restricted to perform a series of operations of invoking the backoff procedure and acquiring the channel access right. Alternatively, this similar restriction may be applied to the non-AP STA. That is, only when the TXOP that can be shared to the AP by the non-AP STA, the non-AP STA may need to transmit the control frame for sharing the TXOP to the AP.

In this case, when an additional subchannel identified to be idle exists, in addition to subchannels occupied by the control frame received from the non-AP STA, (that is, when it is determined that there is an accessible additional subchannel), the AP may perform a channel access procedure to attempt its TXOP acquisition. In other words, the AP may perform a channel access procedure during a TXOP shared from the non-AP STA only when it is determined that an additional subchannel can be secured through the channel access procedure (backoff procedure invoking, performing, completion, etc.) performed during the shared TXOP. In this case, the method of determining that there is an accessible additional subchannel by the AP may correspond to determining that at least one subchannel other than the subchannel occupied by the control frame received from the non-AP STA is accessible among the subchannels included in its operating bandwidth. That is, when the control frame is received and at least one subchannel other than the subchannels occupied by the control frame is determined to be additionally accessible, the AP may initiate the channel access procedure to acquire the channel access right for the additional subchannel.

In this case, in the method of determining whether there is a subchannel to which the AP can additionally access, the determination is made based on whether a CCA result of each subchannel, identified for a PIFS before the control frame is received, is idle. Alternatively, in the method of determining whether there is a subchannel to which the AP can additionally access, the determination may be made based on whether the CCA result of each subchannel, identified for an SIFS or a PIFS immediately after the control frame is received, is idle. In this case, the AP may apply other rules to determine whether each subchannel is accessible, the important thing is that after determining whether each subchannel is accessible, the channel access procedure is initiated only when it is determined that an additional subchannel other than the subchannel occupied by the control frame is accessible, and a specific method of determining whether each subchannel is accessible may not be important.

As described above, after receiving a control frame for TXOP sharing from the non-AP STA, the AP may determine whether to initiate a channel access procedure.

The AP operate in different methods when access to an additional subchannel is determined by initiating the channel access procedure and when the channel access procedure is determined not to be initiated, thereby enabling the non-AP STA having transmitted the control frame to recognize the same.

More specifically, when the AP determines to access an additional subchannel by initiating the channel access procedure after receiving the control frame, the AP may transmit a first response frame to the non-AP STA, as a response to the control frame. In this case, the first response frame may indicate both a response to the received control frame and informing that the AP having responded with the first response frame will perform the channel access procedure. That is, when the first response frame is received from the AP, the non-AP STA having transmitted the control frame (the TXOP sharing frame) may recognize that the control frame has been normally received by the AP and the AP has started the channel access procedure. Accordingly, the non-AP STA needs to determine that its TXOP has been terminated and should not perform the operation of TXOP recovery, etc. In this case, the first response frame may be an individually addressed frame transmitted to the non-AP STA having transmitted the control frame, or may be a broadcast (group addressed) frame. This may be an addressing method considered because the first response frame may include a function of enabling the operating intention of the AP having transmitted the first response frame to be also recognized by other STAs having received the corresponding frame. That is, the AP having transmitted the first response frame becomes a TXOP holder and has an intention to perform a frame exchange sequence with STAs existing in its BSS, and the non-AP STAs (STAs that are members of the BSS) having received the first response frame transmitted by their APs may recognize that the TXOP of the AP is started and may prepare to participate in the frame exchange soon (maintain an awake state without switching to doze, etc.). Accordingly, the first response frame transmitted by the AP has not only a meaning of a response to the non-AP STA having transmitted the control frame (TXOP sharing frame) but also a function of notifying the existence of its TXOP to be initiated later, and thus the AP may transmit the corresponding frame as a broadcast (group addressed) frame. However, even though the first response frame is transmitted as an individually addressed frame, member STAs of the BSS may recognize, based on the format of the first response frame, that the TXOP of the AP will be initiated soon.

In this case, the format of the first response frame may be CTS or CTS-to-self (RA addressed is configured as MAC addressed of the AP). When the AP responds with the CTS-to-self frame as the first response frame, a TXOP limit is applied to the TXOP acquired later by the AP from a transmission start time point of the CTS-to-self frame.

More specifically, when the AP determines not to initiate the channel access procedure after receiving the control frame, the AP may respond with a second response frame. In this case, when the AP transmits the second response frame, the AP may continue the frame exchange sequence by using only the subchannels occupied by the control frame. This may be because the second response frame is transmitted as a response upon determination that there is no subchannel for which the AP can additionally acquire a channel access right within its operating bandwidth.

Accordingly, when the AP determines not to initiate the channel access procedure after receiving the control frame, the AP may continue the frame exchange sequence by using the subchannels occupied by the control frame, and may notify the non-AP STA of the same by responding with the second response frame. In this case, the second response frame may be a trigger frame indicating a response of a TB PPDU. In this case, the trigger frame may be a trigger frame indicating a TB PPDU response to the non-AP STA having transmitted the control frame (TXOP sharing frame). In this case, the second response frame may be an MU-RTS frame. The STAs having received the MU-RTS frame corresponding to the second response frame may respond with a CTS frame to the MU-RTS frame corresponding to the second response frame transmitted by the AP even though the NAV configured by the control frame is not 0. That is, other non-AP STAs having configured the NAV by a specific non-AP STA having shared the TXOP to the AP may ignore the NAV configured by the specific non-AP STA when responding to the frame transmitted by the AP.

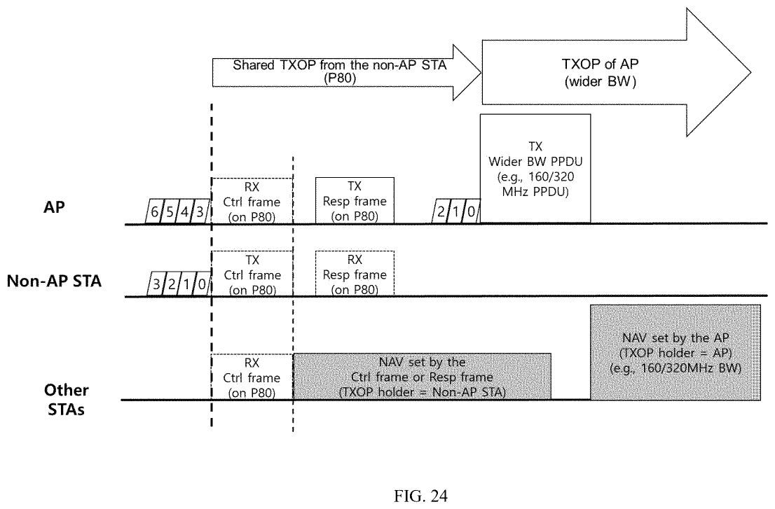

FIG. 24 illustrates an example of a method for acquiring a transmission opportunity (TXOP) by using a shared TXOP according to an embodiment of the present disclosure.

Referring to FIG. 24, when receiving a TXOP shared from a non-AP STA, an AP may perform a backoff procedure within the shared TXOP and acquire a TXOP. In order to avoid redundancy, the same description as those made in FIGS. 21, 22, and 23 can be omitted.

Specifically, each of the AP and the non-AP STA performs a backoff procedure to acquire a channel access right, and the backoff procedure of the non-AP STA is completed first. After completing the backoff procedure, the non-AP STA transmits a control frame to the AP to share the TXOP acquired by the non-AP STA to the AP.

After receiving the control frame transmitted by the non-AP STA, the AP transmits a response frame to derive other STAs to configure an NAV. Thereafter, the AP ignores the NAV configured by the non-AP STA and invokes and completes the backoff procedure during the TXOP shared to the AP.

The AP having completed the backoff procedure during the TXOP shared from the non-AP STA acquires a channel access right for subchannels identified to be idle for a PIFS from a time point at which the backoff procedure is completed, and initiates its own TXOP for the corresponding subchannels.

In this case, the other STAs may recognize that the channel access procedure has been suspended due to the NAV configured by the control frame transmitted by the non-AP STA and/or the NAV configured by the response frame transmitted by the AP and the AP has become a TXOP holder after the AP receives a frame for initiating its own TXOP.

As being considered in the above-described embodiment of the present disclosure, the operations of assisting initiation of the TXOP of the AP after the non-AP STA acquires the channel access right may be understood as a channel reservation or TXOP reservation operation performed by the non-AP STA for the acquisition of the TXOP of the AP.

In addition, in an embodiment of the present disclosure, the frame transmitted to the AP by the non-AP STA to share the TXOP is considered as an MU-RTS TXS frame, but the frame transmitted by the non-AP STA to allow the AP to acquire the TXOP may be a different type of control frame. More specifically, the frame transmitted by the non-AP STA having acquired the TXOP (having acquired the channel access right) to allow the AP to perform the TXOP acquisition procedure may be a new type of trigger frame (a trigger frame having a type not defined in IEEE 802.11be, i.e., EHT).

### <Channel Access Procedure for TXOP Sharing/Initiating Procedure>

According to the procedure provided in the present disclosure, the AP may acquire the TXOP with the assistance of the non-AP STA. That is, when the non-AP STA acquires a channel access right after completing the channel access procedure, the TXOP may be transferred/shared to the AP. The AP being associated with multiple non-AP STAs may acquire a TXOP whenever at least one of the non-AP STAs acquires the channel access right, which may cause a fairness issue with the legacy BSS and other BSSs for which the procedure provided in the present disclosure cannot be used.

In order to solve the fairness issue, when the non-AP STAs perform channel access to initiate a TXOP sharing/initiating procedure, the AP may indicate to apply an EDCA parameter that is different from that used in a normal channel access procedure. That is, in consideration of the existence of other BSS, the number of STAs included in the BSS, etc. the AP may separately designate an EDCA parameter for the TXOP sharing/initiating procedure, and may indicate/derive the non-AP STAs to follow the same.

To this end, the AP may include a TXOP sharing EDCA parameter set element in a management frame (e.g., beacon, a probe response, an association response frame, an operation mode indication, etc.) transmitted by the AP, thereby differentiating the EDCA parameter used when the non-AP STAs access a channel to transmit the TXOP sharing/initiating frame. More specifically, an EDCA parameter to be used when the non-AP STAs having an intention to transmit the AP TXOP sharing/initiating frame perform the channel access procedure may be indicated. The EDCA parameter may include at least one of CWmin, CWmax, and AIFSN. In this case, the CWmin, CWmax, and AIFSN may be indicated for each access category (AC).

The non-AP STA having the intention to transmit the TXOP sharing/initiating frame needs to perform channel access by using CWmin, CWmax, and AIFSN parameters that are different from those in the case where there is no intention to transmit the TXOP sharing/initiating frame.

For example, when the transmission of the TXOP initiating/sharing frame has been indicated from the AP, the non-AP STA may need to update CWmin[AC], CWmax[AC], and AIFSN[AC] by using a value indicated through the TXOP sharing EDCA parameter set element, and when the AP indicates that the TXOP initiating/sharing frame is not to be transmitted, the non-AP STA may need to update CWmin[AC], CWmax[AC], and AIFSN[AC] by using a value indicated through the EDCA parameter set element. However, when MUEDCATimer [AC] of the non-AP STA, corresponding to a time point at which the AP indicates that the TXOP initiating/sharing frame is not to be transmitted, is not 0, the non-AP STA needs to update the CWmin[AC], CWmax[AC], and AIFSN[AC] by using the value indicated through the MU EDCA parameter set element.

In addition, a TXOP limit for each access category may be indicated through the TXOP sharing EDCA parameter set element. In this case, the TXOP limit for each AC means a maximum length of the TXOP acquired through the EDCA of the corresponding AC. However, the non-AP STA having acquired the channel access right through the AC in which the TXOP limit is indicated to be 0 through the TXOP sharing EDCA parameter set element shall transmit the first frame as the TXOP sharing/initiating frame. That is, the non-AP STA having the EDCA of the AC in which the TXOP limit is 0, as the TXOP holder, needs to support TXOP initiation of the AP (share the TXOP of the AP) through the first frame.

In addition, the non-AP STA having transmitted the TXOP initiating/sharing frame to the AP may attempt a TXOP recovery procedure when a response (e.g., a CTS frame) to the frame transmitted by the non-AP STA is not received. That is, when the AP has not responded to the TXOP initiating/sharing frame, the non-AP STA may perform PIFS recovery, perform a new backoff procedure, or perform a procedure of standby until a TXNAV timer expires, etc. This may be understood as a recovery procedure performed by the non-AP STA as a TXOP holder because a time point at which responding to the TXOP initiating/sharing frame transmitted by the non-AP STA is not performed by the AP corresponds to a time point at which the non-AP STA is still the TXOP holder.

### <Signaling Related to TXOP Sharing/Initiating Procedure>

As described above, a procedure in which the non-AP STA acquires a TXOP and then transfers the TXOP to the AP (i.e., a procedure of transmitting a TXOP sharing/initiating frame, etc.) may be an operation performed only when the AP requires the operation. This is because if there is not much traffic queued at the AP, or the AP has no intention of performing coordination with other APs, the AP may not have an intention to perform transmission by using the TXOP acquired by the non-AP STA or acquire the TXOP. Accordingly, the AP may notify the non-AP STAs that the AP has an intention to acquire the TXOP or use the shared TXOP, thereby deriving the non-AP STAs to allow or disallow transmission of the TXOP sharing/initiating frame to the AP.

That is, the AP may indicate, to the STAs of BSS, whether the AP wants to receive the transferred TXOP (i.e., whether the AP wants to receive the TXOP sharing/initiating frame), which needs to be performed in a predetermined method between the AP and the STAs.

The method in which the AP indicates the non-AT STAs to perform the TXOP sharing/initiating procedure may be a method of including at least one of the following methods.
The AP may indicate, through a beacon frame, whether non-AP STAs having received the channel access right need to transmit the TXOP sharing/initiating frame during a time interval up to the next target beacon transmission time (TBTT). In this case, when the AP has not indicated, through a specific beacon frame, whether or not to transmit the TXOP sharing/initiating frame, it may be understood that the indication performed through the beacon frame transmitted before the specific beacon frame is maintained. That is, instead of indicating whether the transmission of the TXOP sharing/initiating frame is required through each beacon frame, the AP may also perform the corresponding indication through a beacon frame only when there is an intention to change the indication on whether the transmission is required. Accordingly, when the indication related to whether or not to transmit the TXOP sharing/initiating frame is included through a first beacon frame and the indication on whether to transmit the TXOP sharing/initiating frame is not included in a second beacon frame, the non-AP STA needs to understand that the same indication as that made through the first beacon frame is continuously maintained.
The AP may indicate whether to transmit the TXOP sharing/initiating frame through a probe response frame and/or an association response frame. The non-AP STA having received, through the probe response/association response frame received from the AP, the indication that the TXOP sharing/initiating frame is transmitted needs to transmit, to the AP, the TXOP sharing/initiating frame when receiving the channel access right after completing the channel access procedure.
The AP may indicate, to the non-AP STA through a response frame transmitted to the non-AP STA, to transmit the TXOP sharing/initiating frame.
For example, when receiving an RTS frame from the non-AP STA, the AP may configure a specific bit of a CTS frame to the RTS frame with a specific value (e.g., 1) and respond, thereby indicating the non-AP STA having transmitted the RTS frame to transmit the TXOP sharing/initiating frame. That is, when the specific bit of the CTS frame received as a response to the RTS frame transmitted to the AP is configured with the specific value, the non-AP STA needs to transmit the TXOP sharing/initiating frame to the AP. In this case, the specific bit of the CTS frame may be a bit included in a frame control field of the CTS frame. In this case, the specific bit may be one of bits corresponding to To DS, From DS, More Fragments, Retry, Power Management, More Data, Protected frame, and +HTC subfield.
In another example, the AP may configure a specific bit of an Ack/BlockAck frame transmitted as a response to a frame received from the non-AP STA, with a specific value (e.g., 1), thereby indicating the non-AP STA to transmit the TXOP sharing/initiating frame. That is, when the specific bit of the Ack/BlockAck frame transmitted from the AP as a response is configured with the specific value, the non-AP STA needs to transmit the TXOP sharing/initiating frame to the AP. In this case, the specific bit may be configured for the above-described purpose only when the non-AP STA is a TXOP holder. In this case, the specific bit of the Ack/BlockAck frame may be a bit included in a frame control field. In this case, the specific bit may be one of bits corresponding to To DS, From DS, More Fragments, Retry, Power Management, More Data, Protected frame, +HTC subfield.
The AP may transmit an AP priority access enable frame to indicate the non-AP STAs to transmit the TXOP sharing/initiating frame. The AP priority access enable frame is a frame transmitted when the AP has an intention to proactively manage the TXOP acquired within the BSS, and the non-AP STAs having received the corresponding frame from the associated AP need to perform a procedure of transferring the TXOP to the AP (transmitting the TXOP sharing/initiating frame, etc.) when acquiring the channel access right (TXOP). Thereafter, the AP may transmit an AP priority access disable frame to indicate the non-AP STAs not to transmit the TXOP sharing/initiating frame. In this case, information related to a time in which the transmission of the TXOP sharing/initiating frame is required may be included in the AP priority access enable frame and indicated. For example, when 100 ms is indicated through the AP priority access enable frame transmitted by the AP, the non-AP STAs may need to transmit the TXOP sharing/initiating frame to the AP when acquiring a channel access right within 100 ms after receiving the corresponding frame. The AP priority access disable frame is a frame transmitted when the AP does not require assistance from the non-AP STAs, and the non-AP STAs having received the corresponding frame from the associated AP do not perform the procedure of transferring the TXOP to the AP when the channel access right (TXOP) is acquired. In this case, the AP priority access enable/disable frame is a frame named for convenience of description, and other frames having the same/similar function may be used for the same/similar purpose.

Upon the operational purpose, the AP may indicate/request the non-AP STAs of the BSS to transmit or not to transmit the TXOP sharing/initiating frame. The non-AP STAs may determine whether to transmit the TXOP sharing/initiating frame according to the most recently received indication among the indications from the AP.

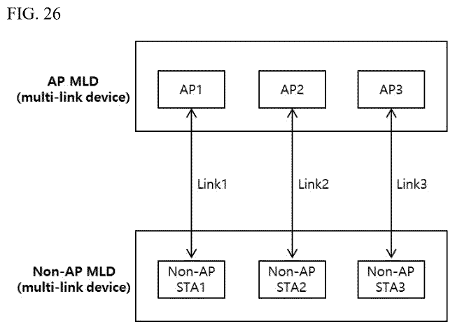

In addition, when each of the AP and the non-AP STA is a device belonging to a multi-link device (MLD), the above-described indication of the AP may be made through another AP of the MLD to which the AP belongs. For example, whether STAs associated with AP 1 need to transmit the TXOP sharing/initiating frame may be indicated through a beacon frame transmitted by AP 2 belonging to the same MLD as AP 1. In this case, non-AP STA 1 associated with AP 1 may decide/determine whether to transmit the TXOP sharing/initiating frame to AP 1, based on information acquired through non-AP STA 2 corresponding to another STA in the MLD. The concept of MLD is described in more detail through an embodiment of FIG. 26.

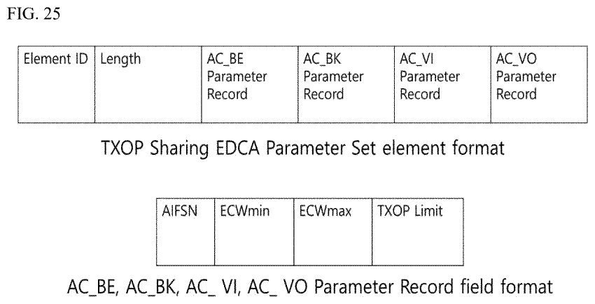

FIG. 25 illustrates an example of a format of a parameter set element for TXOP sharing according to an embodiment of the present disclosure.

Referring to FIG. 25, a TXOP sharing EDCA parameter set element transmitted by the AP may include AC_BE Parameter Record, AC_BK Parameter Record, AC_VI Parameter Record, and AC_VO Parameter Record fields. In this case, the AC_BE Parameter Record, AC_BK Parameter Record, AC_VI Parameter Record, and AC_VO Parameter Record fields of the TXOP sharing EDCA parameter set element include AIFSN, CWmin, CWmax, and TXOP limit information to be used by the non-AP STA having an intention to transmit the TXOP sharing/initiating frame performs a channel access procedure.

CWmin and CWmax values are indicated through 4-bit ECWmin and ECWmax subfields, respectively, and ECWmin is configured to be a CWmin value to be indicated by a value of 2\hat{ }(ECWmin)−1. That is, the ECWmin subfield of the Parameter Record field in which CWmin is indicated as 15 is indicated as 4. Similarly, ECWmax is configured to be a CWmax value to be indicated by a value of 2\hat{ }(ECWmax)=1. That is, the ECWmax subfield of the Parameter Record field in which CWmax is indicated as 1023 is indicated as 10.

The TXOP Limit subfield indicates a maximum length of a TXOP acquired using a value of the corresponding parameter set value.

FIG. 26 illustrates an example of configuration and a connection state of an AP MLD and a non-AP MLD according to an embodiment of the present disclosure.

An MLD is a logical entity with which one more STAs are affiliated. A device in which each STA affiliated with the MLD functions as an AP is an AP MLD, and a device in which each affiliated STA functions as a non-AP STA is a non-AP MLD.

The respective STAs included in the MLD may operate in different links (channels). That is, the STAs included in the MLD may operate in different multiple channels. For example, STAs included in the MLD may operate using channels in different bands such as 2.4 GHz, 5 GHZ, and 6 GHz. Accordingly, the MLD can acquire gain in the channel access and increase the entire network performance.

In addition, the operation of the MLD may be referred to as a multi-link operation, an MLD operation, a multi-band operation, etc. The conventional wireless LAN operates in a single link, but the MLD acquire more channel access opportunities by utilizing multiple links, or can efficiently operate in multiple links in consideration of a channel condition.

As illustrated in FIG. 26, two MLDs may be connected through multiple links. An AP MLD including AP 1, AP 2, and AP 3 and an MLD non-AP MLD including non-AP STA 1, non-AP STA 2, and non-AP STA 3 may be connected through three links, respectively. When multiple links are connected between MLDs, a connection between the AP and the non-AP STA in each link unit supports the same connection state as a connection state between single-link devices. In addition, information can be exchanged through the MLD between STAs belonging to the same MLD, accordingly, information received by AP 1 can be transmitted to AP 2, and the information received by non-AP STA 1 can be also transmitted to non-AP STA 2.

Accordingly, the AP MLD may transmit a change related to AP 1 to non-AP STA 1 through AP 2. That is, as being considered in an embodiment of the present disclosure, when AP 2 indicates, through link 2, that AP 1 indicates transmission of a TXOP sharing/initiating frame, non-AP STA 1 may transmit the TXOP sharing/initiating frame to AP 1, based on the information acquired by non-AP STA 2 through link 2.

### <Signaling by AP for TXOP Sharing Procedure Initiated by Non-AP>

As described above, the non-AP STA may transmit, to the AP, a type of control frame (which may be a trigger-type frame) which can be referred to as a specific frame (e.g., a TXOP sharing request frame (a sharing request frame)) to share the TXOP acquired by the non-AP STA to the AP.

When there is no traffic to be transmitted by the AP at the AP (i.e., when a transmission queue is empty) and there is a device subject to scheduling (i.e., a non-AP STA which needs to solicit a TB PPDU through a trigger frame), that is recognized by the AP, the AP may have no operation to be performed during the TXOP shared from the non-AP STA. In this case, the TXOP shared to the AP by the non-AP STA cannot be used for the purpose other than TB PPDU transmission of the non-AP STA, and accordingly, it can be understood that unnecessary TXOP sharing is performed.

Accordingly, the AP may make announcement related to whether the AP is in a situation where the AP needs to receive sharing of the TXOP from the non-AP STAs of the BSS or a situation where the AP does not need to receive the sharing. In this case, the announcement of the AP may be understood as an operation by the AP of indicating, to the non-AP STAs, whether to initiate the TXOP sharing procedure.

As a simple method of indicating the non-AP STAs to perform TXOP sharing by the AP, a method in which the AP transmits a specific frame, a specific element, or a specific field to indicate, to the non-AP STAs, whether to use the TXOP sharing procedure may be considered. In this case, when it is indicated through the specific frame, specific element, or specific field received from the AP that the TXOP acquired by the non-AP STAs needs to be shared to the AP, the non-AP STAs may need to share the TXOP acquired by the non-AP STAs to the AP. That is, when it is indicated through the most recently received specific frame/element/field that TXOP sharing is to be performed, the non-AP STA may need to share the TXOP to the AP when acquiring the TXOP. However, in consideration of the latency requirement of traffic to be transmitted by the non-AP STA, the non-AP STA may transmit low latency traffic first through the TXOP acquired by the non-AP STA, and then share the remaining TXOP to the AP. In this case, sharing a TXOP to the AP by the non-AP STA means an operation of transmitting the above-described TXOP sharing/initiating frame to the AP. That is, TXOP sharing is used as a meaning including both transferring a TXOP to the AP by the non-AP STA and initiating a TXOP acquisition procedure of the AP, and also in an embodiment of the present disclosure below, when it is described that the non-AP STA “shares” a TXOP acquired by the non-AP STA to the AP, it needs to be understood that TXOP sharing includes both “transferring” the TXOP to the AP and “initiating” the TXOP of the AP by the non-AP STA. That is, controlling (managing, i.e., transmitting a DL PPDU, requesting a TB PPDU response, etc.) a medium by the AP during a time interval (TXOP) in which a right is acquired upon completion of the channel access procedure by the non-AP STA needs to be understood that the TXOP of the non-AP STA is shared to the AP.

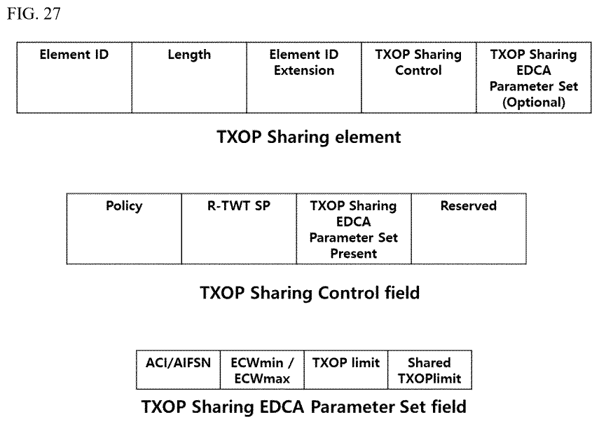

The method of indicating, to the non-AP STAs by the AP, whether the non-AP STA needs to perform TXOP sharing is described in more detail through an embodiment of FIG. 27.

FIG. 27 illustrates an example of an element for sharing a TXOP according to an embodiment of the present disclosure.

An element transmitted to the non-AP STAs for the AP to indicate whether the TXOP acquired by the non-AP STA needs to be shared to the AP may have the format as illustrated in FIG. 27.

Specifically, as illustrated in FIG. 27, a TXOP sharing element includes a TXOP sharing control field. In addition, the TXOP sharing element may further include a TXOP sharing EDCA parameter set field.

In this case, whether the TXOP sharing EDCA parameter set field is further included in the TXOP sharing field is indicated through a TXOP sharing EDCA parameter set bit include in the TXOP sharing control field. More specifically, the TXOP sharing EDCA parameter set field is included in the TXOP sharing element when the TXOP sharing EDCA parameter set bit included in the TXOP sharing control field is configured/indicated as 1.

The TXOP sharing control field includes a policy subfield. The policy subfield indicates whether to share the acquired TXOP to the AP when the non-AP STAs acquire the TXOP. When the policy subfield of the TXOP sharing element transmitted by the AP is indicated by a specific value (e.g., 0), the non-AP STAs may not perform TXOP sharing when acquiring the TXOP. On the other hand, when the policy subfield of the TXOP sharing element transmitted by the AP is indicated by another value (e.g., 1), the non-AP STAs need to perform TXOP sharing to the AP when acquiring the TXOP. That is, the non-AP STAs need to transmit, to the AP, the TXOP sharing/initiating frame described above in the present disclosure. In this case, the non-AP STAs need to determine whether to perform TXOP sharing according to the TXOP sharing element that is most recently received from the AP.

That is, two types of policies indicated through the policy subfield may be understood as a normal policy and an AP priority policy. That is, when the policy subfield is indicated by the specific value (e.g., 0), the “normal” policy is applied, and in this case, the non-AP STAs perform the conventional frame exchange sequence after performing channel access through the conventional channel access method (e.g., EDCA, DCF, or the like). In this case, the conventional frame exchange sequence means an operation of transmitting a UL PPDU by the non-AP STA as a TXOP holder without sharing the TXOP to the AP. On the other hand, when the policy subfield is indicated by the other value (e.g., 1), the “AP priority” policy is applied, and in this case, the non-AP STAs need to share (transfer) the TXOP acquired by the non-AP STAs after acquiring the TXOP.

When the “AP priority” policy is applied, the non-AP STAs may perform a channel access procedure in a method different from that in a case where the “normal” policy is applied. In this case, when the channel access procedure is performed in a different method, it may mean that different values are used for backoff-related parameters used when channel access is performed. That is, when the “normal” policy is indicated, the non-AP STA performs channel access by using a parameter indicted through an EDCA parameter set element or an MU EDCA parameter set element, but when the “AP priority” policy is indicated, the non-AP STA having an intention to initiate the TXOP sharing procedure needs to perform channel access by using a parameter indicated through the TXOP sharing EDCA parameter set field of the TXOP sharing element or the TXOP sharing EDCA parameter set element included in the beacon frame, etc.

In this case, the non-AP STA performing channel access having an intention to initiate the TXOP sharing procedure performs channel access (EDCA) by using a parameter (TXOP sharing EDCA parameter) indicated through the TXOP sharing EDCA parameter set field, regardless of an MU EDCA timer value.

An R-TWT SP subfield is a subfield indicating whether to share the TXOP acquired for an interval overlapping with an R-TWT SP to the AP. In a case where the R-TWT SP subfield is indicated by a specific value (e.g., 0), the non-AP STA may not share the TXOP to the AP when accruing the TXOP for the interval overlapping with the R-TWT SP. However, when the R-TWT SP subfield is configured by other value (e.g., 1), the non-AP STA necessarily shares the TXOP acquired for the interval overlapping with the R-TWT SP to the AP. That is, for the interval overlapping with the R-TWT SP, the non-AP STA needs to guarantee that the AP controls (manages, i.e., transmits a DL PPDU, solicits a TB PPDU, or the like) a medium. Accordingly, when the R-TWT SP subfield is configured by the other value (e.g., 1), the non-AP STA needs to share the TXOP acquired for the interval overlapping with the R-TWT SP to the AP.

In this case, the information indicated through the R-TWT SP subfield may be indicated through the policy subfield. In other words, as in the example of FIG. 27, instead of indicating the policy subfield and the R-TWT SP subfield separately, whether to share the TXOP acquired for the interval overlapping with the R-TWT SP may be indicated through the policy subfield. That is, when the policy subfield is indicated by a specific value (e.g., 2), it may be indicated/understood that the “AP priority” policy is applied during the R-TWT SP. That is, when the policy subfield is indicated by the specific value (e.g., 2), the non-AP STA may need to determine whether to share the TXOP to the AP, based on whether the TXOP acquired by the non-AP STA overlaps with the R-TWT-SP scheduled by the AP. In this case, when the TXOP acquired by the non-AP STA overlaps with the R-TWT SP scheduled by the AP, the non-AP STA performs TXOP sharing to the AP. In this case, when the TXOP acquired by the non-AP STA does not overlap with the R-TWT SP scheduled by the AP, the non-AP STA may not perform TXOP sharing to the AP.

The TXOP sharing EDCA parameter set is a field including an EDCA parameter set that needs to be used by the non-AP STA having an intention to perform TXOP sharing and performing channel access (EDCA). Information included in the TXOP sharing EDCA parameter set field may be similar to information included in the EDCA parameter set element and the MU EDCA parameter set element. More specifically, the TXOP sharing EDCA parameter set field may include an ACI/AIFSN field, an ECWmin/ECWmax field, and a TXOP limit field. In FIG. 27, it is illustrated that the TXOP sharing EDCA parameter set field includes one set of ACI/AIFSN, ECWmin/ECWmax, TXOP limit, and shared TXOPlimit subfields, but the TXOP sharing EDCA parameter set field may include a maximum of four repeated sets of ACI/AIFSN, ECWmin/ECWmax, TXOP limit, and shared TXOPlimit subfields. That is, the TXOP sharing EDCA parameter set field illustrated in FIG. 27 is illustrated to include ACI/AIFSN, ECWmin/ECWmax, TXOP limit, and shared TXOPlimit subfield, only once each, but the same configuration may be repeatedly included up to four times. In this case, the number of times that the ACI/AIFSN, ECWmin/ECWmax, TXOP limit, and shared TXOPlimit subfields repeatedly appear in the TXOP sharing EDCA parameter set field may be indicated through the TXOP sharing control field. For example, a TXOP sharing EDCA parameter set present subfield in an embodiment of FIG. 27 indicates whether a TXOP sharing element including the corresponding subfield includes the TXOP sharing EDCA parameter set field, and may further indicate information related to the size of the TXOP sharing EDCA parameter set field (information related to the number of times that ACI/AIFSN, ECWmin/ECWmax, TXOP limit, and shared TXOPlimit subfields appear).

The ACI/AIFSN subfield and the ECWmin/ECWmax and TXOP limit subfields may be configured/understood in the same method as the field having the same name, included in the conventional Wi-Fi EDCA parameter set element, and thus a detailed description thereof is omitted (see 9.4.2.28 (EDCA Parameter Set element) of Draft P802.11REVme_D2.0).

The shared TXOPlimit subfield indicates information related to a minimum time to be observed when the TXOP acquired through the corresponding AC (an access category indicated by the corresponding ACI/AIFSN subfield) is shared to the AP. For example, when AC_VO is indicated through the ACI/AIFSN subfield and 2 ms is indicated through the corresponding shared TXOPlimit subfield, the non-AP STA needs to share the TXOP acquired using AC_VO to the AP for at least 2 ms or longer. That is, the shared TXOPlimit subfield for a specific AC indicates a minimum time in which the non-AP STA having acquired a TXOP through the specific AC needs to share the TXOP to the AP. When the shared TXOPlimit subfield for a specific AC is configured by 0, the non-AP STA may need to transmit the TXOP sharing/initiating frame when attempting channel access (transmitting the first frame) through the specific AC. That is, the AC in which the shared TXOPlimit subfield is indicated by 0 may mean that the non-AP needs to simultaneously acquire the TXOP through the corresponding AC and share the TXOP to the AP.

The TXOP sharing element described through FIG. 27 may be transmitted through frames transmitted by the AP, and the non-AP STAs need to use a policy and parameters indicated through the most recently received TXOP sharing element.

The variation between the information (each subfield value) of the TXOP sharing element indicated by the AP and the information indicated through the previously transmitted TXOP sharing element may be considered as a critical update on a BSS parameter. That is, when the information indicated through the TXOP sharing element is configured differently from the information previously indicated by the AP, the AP needs to perform an operation in consideration that the difference corresponds to a critical update. That is, the AP needs to increase a value of a check beacon field of the next TIM frame to be transmitted by the AP by 1.

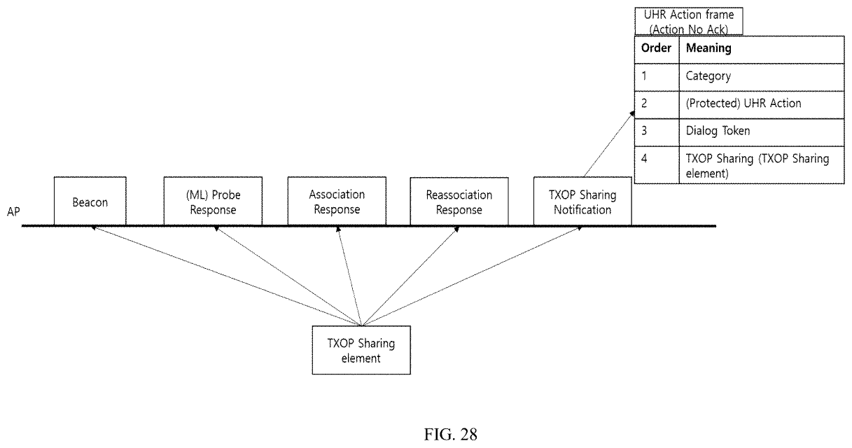

FIG. 28 illustrates an example of a frame including an element for sharing a TXOP according to an embodiment of the present disclosure.

Referring to FIG. 28, the AP may transmit a TXOP sharing element through a beacon, (ML) probe response, (re) association response, and/or TXOP sharing notification frame.

The non-AP STAs need to follow a channel access policy indicated through the most recently received TXOP sharing element, and when the “AP priority” policy is applied, the non-AP STAs need to perform a channel access procedure (EDCA) by using parameter indicated through a TXOP sharing EDCA parameter set field.

A method of including the element in the beacon, (ML) probe response, (re) association response, or TXOP sharing notification frame is identical to the method of including various types of elements in the same frame in the conventional Wi-Fi, and thus a separate description thereof is omitted.

The TXOP sharing notification frame is an action frame, and may be a frame transmitted for the AP to change an indication related to TXOP sharing. In this case, the TXOP sharing notification frame may be an Action No Ack frame. That is, the non-AP STAs having received the corresponding frame may not respond with the response frame.

A category field of the TXOP sharing notification frame is a field indicating that the corresponding action frame is the TXOP sharing notification frame, and when the category field is configured with a specific value, the non-AP STAs may recognize that the corresponding frame is the TXOP sharing notification frame.

The category field of the TXOP sharing notification frame is a field indicating that the corresponding action fame is a (protected) UHR action frame. In this case, the value indicated by the category field may be configured as 38 to indicate the UHR action frame, or may be configured as 39 to indicate the protected UHR action frame.

The (protected) UHR action field of the TXOP sharing notification frame is a field indicating that the corresponding action frame is the TXOP sharing notification frame, and when the (protected) UHR action field is configured with a specific value, the non-AP STAs may recognize that the corresponding frame is the TXOP sharing notification frame.

A dialog token field is configured with a value other than 0, and is used to distinguish a corresponding transaction from other transactions.

A TXOP sharing field includes a TXOP sharing element (see FIG. 27).

### <Various Response Frame Embodiments>

As described above, when the non-AP STA shared a TXOP to the AP through the TXOP sharing/initiating procedure, there may be a case where there is no operation to be performed by the AP by using the shared TXOP. In this case, the AP may transmit a response frame to a control frame (TXOP sharing/initiating frame) received from the non-AP STA, and indicate that that the AP does not need to receive the shared TXOP. In addition, when the AP performs services for multiple non-AP STAs by using the TXOP shared from the non-AP STA, the multiple non-AP STAs may need to prepare an operation in consideration that the AP will perform transmission to the multiple non-AP STAs.

That is, when a control frame for TXOP sharing is received from the non-AP STA, the AP may indicate, to other STAs, advance information related to the operation to be performed using the shared TXOP and/or whether the AP will perform transmission/reception through the shared TXOP. In this case, the indication may be made by the AP through a response frame (TXOP sharing response frame) transmitted as a response to the control frame.

The information indicated by the AP through the response frame may be divided into two types of information: 1. information indicating that the non-AP STA needs to perform a frame exchange sequence by using a shared TXOP; and 2. information indicating that there is no operation to be performed using a TXOP shared by the non-AP STA.

The method of indicating, by the AP through the response frame, whether to perform an operation using a TXOP (hereinafter, referred to as a “shared TXOP”) shared by the non-AP STA may be using a format of the response frame, or configuring a specific subfield (bit) included in the response frame with a specific value.

To describe the indication method using the frame format in more detail, when the AP has an intention to perform a subsequent operation (transmitting a DL MU PPDU, transmitting a trigger frame to request a UL TB PPDU response, etc.) by using the shared TXOP, the AP may transmit the TXOP sharing response frame as a response to the TXOP sharing/initiating frame received from the non-AP STA. In this case, the TXOP sharing response frame may be a trigger frame or an MU-RTS (trigger) frame. Alternatively, the TXOP sharing response frame may be another type of frame having a predetermined format. Accordingly, after transmitting the TXOP sharing/initiating frame to the AP, the non-AP STA having received the TXOP sharing response frame should not perform transmission without triggering of the AP during the remaining TXOP. That is, when the non-AP STA receives a response of the TXOP sharing response frame from the AP, the non-AP STA needs to perform an operation of recognizing that the AP becomes the TXOP holder. That is, an NAV (intra-BSS NAV or basic NAV) needs to be configured based on a duration/ID field value of the frame transmitted by the AP. In this case, when receiving the response of the TXOP sharing response frame from the AP, the non-AP STA may configure an NAV timer having the same as its remaining TXNAV timer so as to suspend a channel access procedure (maintain a virtual NAV as busy). In this case, the non-AP STA may configure its TXNAV as 0 when receiving the TXOP sharing response frame from the AP. The TXNAV means a timer for resetting to a value indicated through a duration/ID field of the frame which has been most recently and successfully transmitted by the TXOP holder. In this case, the successfully transmitted frame means a frame in which the response frame to the frame is received.

When the AP has no intention to perform a subsequent operation (transmitting a DL MU PPDU, transmitting a trigger frame to request a UL TB PPDU response, etc.) using the shared TXOP, the AP may respond with a CTS frame as a response to the TXOP sharing/initiating frame. That is, when receiving the CTS frame as a response to the TXOP sharing/initiating frame transmitted by the non-AP STA, the non-AP STA may recognize that the AP has no intention to use the TXOP shared by the non-AP STA. In this case, the non-AP STA may perform an operation of transmitting a UL PPDU by using its remaining TXOP, transmitting a P2P PPDU, etc. That is, when TXOP sharing to the AP is rejected (suspended), the non-AP STA may perform the operation to be performed by the non-AP STA as a TXOP holder during its TXOP.

To describe the method of using a specific subfield (bit) included in the response frame in more detail, when receiving the TXOP sharing/initiating frame from the non-AP STA, the AP may configure a specific subfield (bit) of the response frame in another method according to whether the AP has an intention to perform the subsequent operation using the shared TXOP. As a simple example, when the AP has an intention to transmit a DL MU PPDU or receiving a response of a UL TB PPDU by using the shared TXOP, the AP may configure the specific subfield with a specific value, and may configure the specific subfield with another value when there is no operation to be performed using the shared TXOP. Accordingly, the non-AP STA may identify whether the AP has an intention to perform the operation using the shared TXOP, based on the specific subfield value of the response frame received as a response after transmitting the TXOP sharing/initiating frame to the AP.

In this case, when it is determined that the AP has no intention to perform the operation using the shared TXOP, the non-AP STA may operation as a TXOP holder, such as transmitting a UL PPDU and/or a P2P PPDU during the remaining TXOP in the same manner as the above-described indication method using the frame format.

In this case, when the non-AP STA has recognized through the specific subfield that the AP has no intention to perform the operation using the shared TXOP, the non-AP STA need to perform an operation such as configuring an NAV based on the frame transmitted by the AP and resetting its TXNAV timer in the same manner as the above-described indication method using the frame format. That is, the non-AP STA having identified, through the specific subfield of the TXOP sharing response frame transmitted by the AP as a response, that the AP has an intention to perform the operation using the shared TXOP need to function as not being a TXOP holder during an interval corresponding to the shared TXOP.

The AP having received the TXOP sharing/initiating frame may indicate, through a response frame to the TXOP sharing/initiating frame, whether the AP will perform an operation utilizing the shared TXOP, and the non-AP STA having transmitted the TXOP sharing/initiating frame may determine, based on the TXOP sharing response frame received as a response, whether the non-AP STA will function as a TXOP holder during the remaining TXOP.

Moreover, the AP may indicate, through the TXOP sharing response frame, target non-AP STAs subject to frame exchanging using the shared TXOP. That is, the AP may perform indication related to the operation to be performed during the shared TXOP to non-AP STAs other than the non-AP STA having transmitted the TXOP sharing/initiating frame, through the TXOP sharing response frame. In this case, the AP may perform the same indication through a frame (the next frame transmitted an SIFS interval from the TXOP sharing response frame) transmitted after the TXOP sharing response frame, rather than the TXOP sharing response frame. The description below is made in consideration that an indication to the non-AP STAs is performed through the TXOP sharing response frame, but it needs to be understood that the same indication can be performed through a frame transmitted after the TXOP sharing response frame.

More specifically, the AP may transmit information indicating non-AP STAs for performing transmission/reception during the shared TXOP through the TXOP sharing response frame. In this case, the information indicating the non-AP STAs may mean a field indicating an association ID (AID) of the non-AP STA. That is, the AP may transmit one or more AID fields through the TXOP sharing response frame, and each of the AID fields indicates an AID (AID11, AID 12, or the like) of a target non-AP STA to which a DL MU PPDU is to be transmitted through the shared TXOP and/or a target non-AP STA from which a TB PPDU response is requested through a trigger frame. Accordingly, the non-AP STAs, the AIDs of which are indicated through the TXOP sharing response frame (a response frame to the TXOP sharing/initiating frame transmitted by a specific non-AP STA) transmitted by the AP may recognize that the AP will transmit a DL PPDU to the non-AP STAs and request a response of a TB PPDU from the non-AP STAs. In this case, the non-AP STAs may perform a standby operation for DL PPDU reception and TB PPDU responding scheduled to be performed, without switching to a power save mode. In this case, the number of AID fields to be included in the TXOP sharing response frame is indicated through another (sub) field included in the TXOP sharing response frame. In this case, the other field may be a control field. Accordingly, the non-AP STAs may recognize the number of AID field included in the corresponding TXOP sharing response frame based on the value indicated in the control field (or another subfield included in the control field (e.g., Number Of AIDs subfield)) of the received TXOP sharing response frame. In this case, the control field may be configured as (the number of AID fields included in the corresponding TXOP sharing response frame-1). That is, a subfield related to the number of AID fields may be configured as 0 through the control field of the TXOP sharing response frame, in which one AID field is included. In this case, the control field may be configured as the number of AID fields included in the corresponding TXOP sharing response frame. That is, the subfield related to the number of AID fields may be configured as 1 through the control field of the TXOP sharing response frame, in which one AID field is included. However, the AID of a specific non-AP STA having transmitted the TXOP sharing/initiating frame may not be indicated through the AID field. This may be an applicable exception because at least one trigger frame will be transmitted to the specific non-AP STA (the non-AP STA having transmitted the TXOP sharing/initiating frame) during the shared TXOP. That is, the non-AP STA having transmitted the TXOP sharing/initiating frame recognizes that at least one trigger frame will be received from the AP during the shared TXOP, and thus the AP does not need to indicate the AID of the non-AP STA through the AID field.

When performing the operation using the shared TXOP, the AP may intend to change the operating channel of some non-AP STAs to a secondary channel in order to increase the utilization of the secondary channel.

As an example of the present disclosure, as described above, a station (e.g., tan AP, etc.) may transmit a specific frame (e.g., a trigger frame, etc.) to change an operating channel of another station (e.g., a non-AP STA, etc.) to a channel not supported by the other station, and the other station having received the specific frame may transmit or receive a frame by changing the operating change to a channel indicated by a specific frame.

For example, when an entire bandwidth is 320 MHz, the AP may support and use all the 320 MHz, but the non-AP STAs may support only a bandwidth of primary 160 MHz (or less), and may not support the remaining secondary 160 MHz. In this case, the operating bandwidth of the non-AP STAs is primary 160 MHz, and the remaining secondary 160 MHz is not supported by the non-AP STAs, and thus the secondary 160 MHz may not be used for the secondary 160 MHz. The AP may transmit a frame indicating a change of the operating bandwidth to the secondary 160 MHz to the non-AP STAs to use the secondary 160 MHz (e.g., to transmit or receive a frame in the secondary 160 MHz), and the non-AP STAs having received the frame may operate by changing the operating bandwidth to the secondary 160 MHz indicated by the frame.

As another embodiment of the present disclosure, in the embodiment above, the AP may acquire a TXOP in a secondary channel through the method described in “channel access procedure for bandwidth extension”, and may perform a procedure for changing the operating bandwidth for the non-AP STAs within the acquired TXOP.

As another embodiment of the present disclosure, the method for changing the operating channel of the non-AP STAs and the method for performing channel access in the secondary channel by the AP may be performed together with the method for sharing the TXOP. Specifically, a first STA (e.g., an AP or a non-AP STA) may receive a TXOP (a first TXOP) shared from a second STA (e.g., a non-AP STA or AP) through the above-described TXOP sharing procedure. In this case, the second STA may support only primary 160 MHz or primary 80 MHz among a total bandwidth of 320 MHz, may perform a channel access procedure (a first channel access procedure) by using a primary subchannel of the primary 160 MHz or the primary 80 MHz, and may thus acquire the first TXOP. The frequency range in which the first TXOP is acquired may be up to a range of the primary 160 MHz or the primary 80 MHz. The first STA may transmit or receive a frame within the shared first TXOP. However, when the primary subchannel of the primary 160 MHz or the primary 80 MHz is occupied by other STA (e.g., an OBSS STA), the channel access procedure cannot be performed through the primary subchannel. Accordingly, the first STA may select one of channels (e.g., secondary 160 MHz, secondary 80 MHz, or the like when the entire bandwidth is 320 MHz) other than the primary 160 MHz or the primary 80 MHz to perform a channel access procedure (a second channel access procedure) through a subchannel of the selected channel, and may acquire a TXOP (a second TXOP). In this case, the frequency range in which the second TXOP is acquired may be limited to a channel (e.g., secondary 160 MHz or secondary 80 MHz) in which the channel access procedure is performed, and the second TXOP may be considered as extension to the frequency band of the first TXOP. Accordingly, the second TXOP may end at the same time point as the first TXOP. In this case, the first STA may transmit, to the other STAs, a specific frame (e.g., a trigger frame, etc.) for changing the operating channel of the other STAs to the secondary 160 MHz or the second 80 MHz in which a second channel access procedure is performed. In this case, the other STAs may support only the primary 160 MHz or the primary 80 MHz the in same or similar manner of the second STA. The other STAs having received the specific frame from the first STA may change the operating bandwidth to the secondary 160 MHz or the secondary 80 MHz as extension of the bandwidth, and may transmit or receive a frame by using the secondary 160 MHz or the secondary 80 MHz.

For example, there may be a case where the AP plans to manage the BW for performing frame exchanging by using the shared TXOP, as 320 MHz. In this case, when all the non-AP STAs to which the AP is to perform transmission are non-AP STAs having configured only the 160 MHz band as the operating BW, the AP cannot utilize the secondary 160 MHz band. In this case, the operating BW of the non-AP STAs is limited to the primary 160 MHz because the operating bandwidth of the non-AP STAs is limited to 160 MHz. In this case, in order to utilize the secondary 160 MHz band, the AP may request some non-AP STAs to change the operating BW to operate for the secondary 160 MHz band. The non-AP STAs having been requested to change the operating BW to the secondary 160 MHz band may receive a DL PPDU or respond with a TB PPDU by using an RU included in the secondary 160 MHz band until a frame exchange sequence performed with the AP ends. That is, the non-AP STAs change the operation mode to support transmission/reception for the secondary channel, without support transmission/reception for the primary channel.

As in the example above, the operation of changing the operating BW of the non-AP STAs to a secondary channel rather than a primary channel of the BSS by the non-AP STAs may be similar to the subchannel selective transmission (SST) operation defined in 11ax. However, the non-AP STAs may have a difference that the non-AP STAs operate in the indicated secondary channel only during consecutive frame exchange sequences including a frame when the AP transmits the frame indicating the change to the secondary channel to the non-AP STAs. In this case, the consecutive frame exchange sequence may mean frame exchange sequences performed within a single TXOP. In this case, the respective frames (PPDUs) of the consecutive frame exchange sequences have an SIFS or PIFS interval.

When the non-AP STA changes the operation mode to support transmission/reception in another band (a band including the secondary channel) not including the primary channel, a time may be needed according to the capability of the non-AP STA. That is, each non-AP STA may spend a time required to switch to the secondary channel operation mode, and the operation mode switching time may be indicated through a capability of the non-AP STA in a process in which the AP and the non-AP STA are associated. In this case, the value indicated by the non-AP STA through the capability may be a transition time required to switch to the secondary channel operating mode and/or the length of a minimum padding field to be included in a frame (the frame transmitted by the AP) indicating switching to the secondary channel operation mode. Accordingly, when indicating switching to the secondary channel operation mode to a specific non-AP STA, the AP needs to operate in consideration of the time required for the specific non-AP STA to switch to the secondary channel operation mode. That is, when the AP indicates the specific non-AP STA to switch to the secondary channel operation mode, a padding field equal to or longer than the minimum padding field length indicated by the specific non-AP STA needs to be included in the frame transmitted to indicate the switching. In this case, the padding field may mean a field included after an AID field indicating the AID of the specific non-AP STA.

Accordingly, the AP may indicate the non-AP STA to switch to the secondary channel operation model, and the non-AP STA may switch to the secondary channel operation mode when the indication is performed by the AP, thereby performing frame exchanging in the secondary channel. To this end, the AP and the non-AP STA may perform negotiation in advance on the secondary channel operation mode. More specifically, the AP may request to activate the secondary channel operation mode to the non-AP STA, and only when the non-AP STA approves the corresponding request, the operation of through the secondary channel operation mode switching of the non-AP STA may be possible. Additionally, the AP may indicate information on a secondary channel to which the non-AP STA needs to switch, and the non-AP STA may approve the secondary channel indicated by the non-AP STA or indicate another secondary channel to the AP. When the negotiation on the secondary channel is completed between the AP and the non-AP STA, the non-AP STA may switch to the state in which the operation can be made for the negotiated secondary channel when switching to the secondary channel operation mode.

Accordingly, when an AID of another non-AP STA operating in the secondary channel operation mode is indicated through a TXOP sharing response frame transmitted after receiving a TXOP sharing/initiating frame received from a specific non-AP STA, the other non-AP STA may switch to an operation mode for the secondary channel negotiated with the AP in advance. That is, the TXOP sharing response frame transmitted by the AP may have not only a function of indicating a target non-AP STA to which the AP is to perform transmission/reception through the shared TXOP but also a function of indicating the indicated secondary channel operation mode switching of the non-AP STA. In this case, to indicate whether the corresponding TXOP sharing response frame indicates switching to the secondary channel operation mode, the AP may configure a specific bit (or a specific subfield) included in the TXOP sharing response frame with a predetermined value. For example, the AP may configure a secondary subfield operation subfield included in a response frame as 1 so as to indicate the non-AP STAs, the AIDs of which are indicated through an AID field included in the TXOP sharing response frame, to switch to the secondary channel operation mode. When the secondary subchannel operation subfield of the TXOP sharing response frame is configured as 1, the non-AP STAs do not switch to the secondary channel operation mode even though their AIDs are indicated through the AID field.

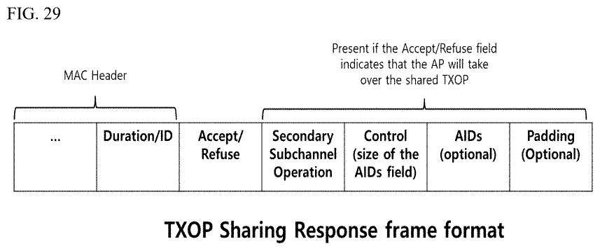

FIG. 29 illustrates an example of a response frame format for a frame for TXOP sharing according to an embodiment of the present disclosure.

A duration/ID field of a TXOP sharing response frame indicates a time point later than a time point indicated by a duration/ID field of a TXOP sharing/initiating frame received from the AP. That is, the time point indicated through the duration/ID field of the TXOP sharing/initiating frame is later in time than the time point indicated through the duration/ID field of the TXOP sharing response frame transmitted as a response to the TXOP sharing/initiating frame. This is a duration/ID field configuration rule proposed for STAs having configured an NAV upon reception of the TXOP sharing/initiating frame to configure again the NAV after receiving the TXOP sharing response frame. The STAs for configuring again the NAV after receiving the TXOP sharing response frame recognize that the STA having transmitted the TXOP sharing response frame, i.e., the AP, is a TXOP holder. To this end, the non-AP STA for transmitting the TXOP sharing/initiating frame need to configure the duration/ID field of the TXOP sharing/initiating frame with a value smaller than a specific value (a maximum value which can be indicated in consideration of the TXOP limit). In this case, the non-AP STA for transmitting the TXOP sharing/initiating frame may need to configure the duration/ID field with a pre-configured value. In this case, the pre-configured value may be a value pre-designated by the standard of the AP so as to be configured for the duration/ID field of the TXOP sharing/initiating frame. However, when the AP transmits the TXOP sharing response frame indicating there is no intention to use the shared TXOP, the duration/ID field of the TXOP sharing response frame may be configured to indicate the same time point as a time point indicated by the duration/ID field of the TXOP sharing/initiating frame.

An Accept/Refuse field is a field indicating whether the AP having received the TXOP sharing/initiating frame has an intention to perform the operation using the shared TXOP. When the Accept/Refuse field is indicated by a specific value (e.g., 1), the value indicates that the AP has a plan to utilize the shared TXOP, i.e., the AP will take over the shared TXOP. When the Accept/Refuse field is indicated by another value (e.g., 0), the value indicates that the AP has no plan to utilize the shared TXOP. In this case, the non-AP STA having transmitted the TXOP sharing/initiating frame may function as a TXOP holder during the remaining TXOP (that is, a function such as transmitting a UL PPDU and/or a P2P PPDU and receiving an Ack/BlockAck frame).

The fields below are fields included only in a response frame transmitted to indicate that AP will utilize the shared TXOP.

The secondary subchannel operation field is a field indicating whether the non-AP STAs supporting the secondary channel operation mode need to switch to the secondary channel operation mode among the non-AP STAs, the AIDs of which are indicated through the corresponding TXOP sharing response frame. When the secondary subchannel operation field is indicated by 1, the non-AP STA supporting the secondary channel operation mode among the non-AP STAs, the AIDs of which are indicated through the AID field, needs to switch to the secondary channel operation mode. When the secondary subchannel operation field is indicated by 0, even though the AID of the non-AP STA is indicated through the AID field, the non-AP STA may not switch to the secondary channel operation mode and participate in a frame exchange sequence later. In this case, the secondary subchannel operation field may be a field which can be meaningful only for the non-AP STAs supporting the secondary channel operation mode and having completed the negotiation on the secondary channel operation with the AP. That is, among the non-AP STAs, the non-AP STA not supporting the secondary channel operation mode, has no separate operation to be performed according to the value of the secondary subchannel operation field.

A control field indicates the number of AID fields included in the TXOP sharing response frame. The control field may be configured as (the number of AID fields−1). Alternatively, the control field may be configured as the number of AID fields.

The AID field indicates AIDs of the non-AP STAs to which the AP transmitting the TXOP sharing response frame is to perform transmission or reception during the shared TXOP. Accordingly, the non-AP STAs, the AIDs of which are indicated through the AID field, need to perform an operation in consideration that the AP will transmit at least one DL PPDU or at least one trigger frame (i.e., a TB PPDU response request) to the non-AP STAs during the shared TXOP. That is, the non-AP STAs need to maintain an Awake state without switching to a Doze state during a period corresponding to the shared TXOP.

A padding field is a field configured based on a minimum padding length indicated by the non-AP STAs switching to the secondary channel operation mode. More specifically, the length of the padding field is configured to be a length equal to or longer than the length indicated by the non-AP STA indicating the longest minimum padding length among the non-AP STAs to which switching to the secondary channel operation mode is indicated by the TXOP sharing response frame. For example, when the minimum padding lengths indicated by three non-AP STAs performing the secondary channel operation mode switching by a specific TXOP sharing response frame are 10 μs, 20 μs, and 30 μs, respectively, the AP configures a padding field of the TXOP sharing response frame to have a length equal to or longer than 30 μs.

<BW Extension Rule for Harmonious Operation with Overlapping BSS>

According to the above-described embodiment of the present disclosure, the AP having received the TXOP sharing/initiating frame from the non-AP STA may access subchannels identified to be idle among the subchannels not occupied by the received TXOP sharing/initiating frame. In this case, it has been described that the AP needs to invoke/perform/complete an additional backoff procedure during the shared TXOP in order to acquire an access right to the subchannels identified to be idle.

Even though the AP performs the additional backoff procedure during the shared TXOP to acquire the access right to the idle subchannel, a fairness issue with the operation itself in which the BW is extended during the TXOP is performed may be suggested. As a simple example, an operation in which the AP accesses an additional 80 MHz band (secondary 80 MHz) to perform the operation utilizing a 160 MHz band after the non-AP STA shares a TXOP acquired for an 80 MHz band (primary 80 MHz) to the AP may result in interference with channel access of an overlapping basic service set (BSS) (OBSS) operating in the additional 80 MHz band. According to the above-described embodiment of the present disclosure, the AP performs a procedure for fair contention, such as performing the additional backoff procedure to acquire the access right for the secondary channel and identifying that a CCA result for the additional subchannels is idle, but legacy BSSs having no BW extension opportunity may still consider the operation unreasonable.

Accordingly, in order to minimize performance degradation of the OBSS, the AP for acquiring the channel access right for an additional BW (BW and idle subchannels) during the shared TXOP may perform an operation for more protecting the operating channel of the OBSS. As a simple example, the AP for acquiring the channel access right for the additional BW during the shared TXOP needs to access only subchannels not corresponding to the operating BW of the OBSS among the idle subchannels. That is, the AP performing channel access to the additional BW during the shared TXOP may not be allowed to perform channel access for the subchannel included in the operating BW of the OBSS even though the subchannel is identified to be idle. However, constraints related to the OBSS are not applied to the access by the AP to the channel having been occupied by the TXOP sharing/initiating frame. In this case, the channel access performed during the shared TXOP means a channel access procedure performed after the AP responds with the TXOP sharing response frame.

That is, when the BW is extended during the shared TXOP, the AP may be required not to access subchannels included in the operating BW of the OBSSs. In this case, in order not to access the subchannel included in the operating BW of the OBSS, the AP may perform preamble puncturing. The preamble puncturing means a technique of performing transmission without carrying a specific subchannel (a subchannel not to be occupied) in order not to occupy some of the subchannels included in the PPDU BW. For example, when transmitting a 320 MHz PPDU to which preamble puncturing is applied, the STA may perform transmission in the form of not occupying a specific 80 MHz band among a 320 MHz band that a 320 MHz PPDU spans. In this case, a signal of the 320 MHZ PPDU is not detected in the specific 80 MHz band. The preamble puncturing technique is a conventional technique introduced in 11ax and 11be, and thus a detailed description thereof is omitted.

When the channel access by the AP which extends the BW during the shared TXOP is limited for all subchannels included in the operating BW of the OBSS, the performance gain achieved through the BW extension procedure of the AP may be highly limited.

In order to solve this problem, even though a specific subchannel is a subchannel included in the operating BW of the OBSS, the AP extending the BW during the shared TXOP needs to be allowed to access the subchannel depending on a condition.

For example, the AP extending the BW during the shared TXOP may be allowed to access a subchannel remaining after excluding a primary channel of the OBSS. More specifically, the AP extending the BW during the shared TXOP may access the channel when a secondary channel of the OBSS is identified to be idle. However, access to the primary channel of the OBSS is not allowed even though the channel is identified to be idle as a result of CCA. In this case, the primary channel of the OBSS means a channel including a primary 20 MHz subchannel of the OBSS. That is, the primary channel of the OBSS may be a primary 20 MHz subchannel of the OBSS. That is, the primary channel of the OBSS may be two subchannels corresponding to primary 40 MHz of the OBSS. That is, the primary channel of the OBSS may be four subchannels corresponding to primary 80 MHz of the OBSS.

In another example, the AP extending the BW during the shared TXOP is allowed to access the subchannels included in the operating BW of the OBSS, but a multi-AP coordination operation in consideration of the requirement of the OBSS may be recommended to be performed. In this case, the AP extending the BW during the shared TXOP may perform channel access for the operating BW of the OBSS, and if necessary, the multi-AP coordination operation of sharing a resource unit (RU) or the TXOP to the OBSS needs to be performed. The multi-AP operation means a series of operations of exchanging requirement information, and the like between APs and harmoniously sharing and using a frequency resource and/or TXOP in consideration of their requirements. In this case, the AP for allocating (sharing) the frequency resource or allocating (sharing) the TXOP to another AP may be referred to as a sharing/coordinating AP. The case of the above-described embodiment of the present disclosure may be understood that the operation in which the AP extending the BW during the shared TXOP functions as a sharing/coordinating AP, allocates (shares) a resource unit (RU) (frequency resource) and/or a TXOP to the AP of the OBSS, and performs BW extension in the form of minimizing the performance degradation of the OBSS is applied.

In this case, the AP extending the BW during the shared TXOP may attempt BW extension for an idle subchannel by applying different rules according to whether the OBSS is a legacy BSS or a UHR BSS, such as prohibiting accessing the subchannel included in the operating BW of the legacy BSS when the OBSS is the legacy BSS, and allocating (sharing) the RU/TXOP to the UHR BSS corresponding to the OBSS through the multi-AP operation when the OBSS is the UHR BSS. In addition, even though the OBSS is the UHR BSS, the AP may not be allowed to access the subchannel included in the operation BW of the OBSS when the multi-AP operation is not performed with the OBSS. That is, the UHR BSS in the relationship of not performing the multi-AP operation is the OBSS, the operating BW of the UHR BSS needs to be considered the same as the operating BW of the legacy BSS.

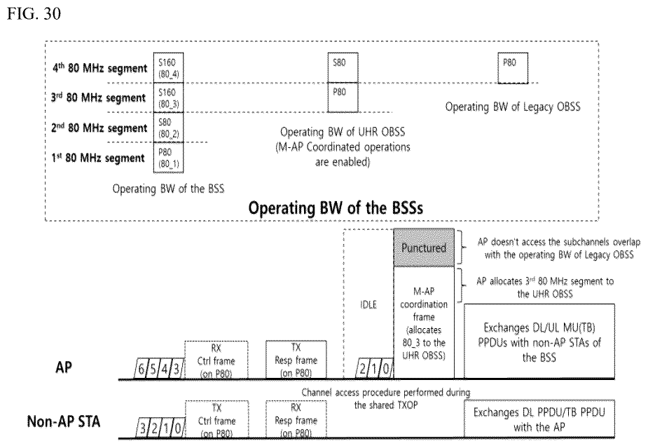

FIG. 30 illustrates an example of a method for minimizing performance degradation of an overlapping basic service set (OBSS) by the AP when a bandwidth of a shared TXOP is extended according to an embodiment of the present disclosure.

Referring to the BSSs of the operation BW of FIG. 30, four 80 MHz segments corresponding to 80_1 to 80_4 are included in the operating BW of the BSS of 320 MHz. In this case, the operating BW of a UHR BSS corresponding to the OBSS corresponds to the 3^{rd} and 4^{th} 80 MHz segments, and the operation BW of the legacy BSS corresponding to the OBSS corresponds to the 4th 80 MHz segment.

The AP receives a Ctrl frame (TXOP sharing/initiating frame) transmitted by the non-AP STA and then responds with a response frame (TXOP sharing response frame). The Ctrl frame occupies only a primary 80 MHz band and the AP initiates an additional channel access procedure (channel access performed during the shared TXOP) to perform the operation using a wider BW during the shared TXOP.

The AP has identified that all the 320 MHz bands included in the operating BW of its operating BSS are idle, but the 4th 80 MHz segment is included in the operating BW of the legacy OBSS, and thus the AP does not access the 4th 80 MHZ segment. In this case, the AP transmits a 320 MHz PPDU and performs puncturing of subchannels corresponding to the 4th 80 MHz segment in order not to access the 4th 80 MHz segment.

The AP transmits an M-AP coordination frame corresponding to the 1^{st}, 2^{nd}, and 3^{rd} 80 MHz segments to acquire a channel access right for the 1^{st}, 2^{nd}, and 3^{rd} 80 MHz segment band. However, the AP allocates (shares) an RU positioned in the primary 80 MHz band of the UHR BSS (the 3^{rd} 80 MHz segment of the BSS) to the AP of the UHR BSS in consideration of the requirement of the UHR OBSS.

As described above, the embodiments provided in the present disclosure are described in consideration that the non-AP STA transmits an TXOP initiating/sharing frame to the associated AP, but the same operation may be performed between APs. In other words, the first AP may acquire a TXOP and then transmit a TXOP sharing frame to share the TXOP to the second AP, and in this process, the BW can be also extended by AP 2. In addition, when the BW in which the first AP acquires the TXOP is smaller than the operating BW of the second AP, the first AP may derive, through the TXOP initiating frame transmitted by the AP, the second AP to perform frame exchanging in a band in which the first AP fails to acquire the TXOP. In this case, the TXOP sharing frame transmitted to the second AP by the first AP may be a frame classified as an MU-RTS type. In this case, the frame transmitted to the second AP by the first AP may be a frame transmitted for a multi-AP operation.

However, when TXOP sharing is performed between two APs, only TXOP sharing for a band in which operating BWs of two APs overlap may be performed. For example, when AP 1 uses a 320 MHz band including a first 160 MHz band and a second 160 MHz band as an operating BW, and AP 2 uses a 320 MHz band including the second 160 MHz band and a third 160 MHz band as an operating BW, a band in which the first AP can share a TXOP to the second AP may be limited to the second 160 MHz band. This may be because the first AP cannot acquire a channel access right for the third 160 MHz band included in the operating BW of the second AP. Accordingly, when TXOP sharing is performed between two APs, only a TXOP for a frequency area in which operating BWs of two APs overlap can be shared. In this case, AP 2 described above may acquire a channel access right for the third 160 MHz band by performing additional channel access during the shared TXOP allocated (shared) from AP 1. The method of performing additional channel access by AP 2 during a time allocated (shared) from AP 1 may be performed in a method identical/similar to performing additional channel access by the AP during a time allocated (shared) from the non-AP STA, and thus a detailed description thereof is omitted.

In addition, a condition that a specific AP can share a TXOP to another AP is that a primary 20 MHz channel of the other AP needs to be present in the operating BW of the specific AP. This is because a frame (e.g., a TXS trigger frame) transmitted by the specific AP cannot be received by the other AP when the primary 20 MHz channel of the other AP is not included in the operating BW of the specific AP.

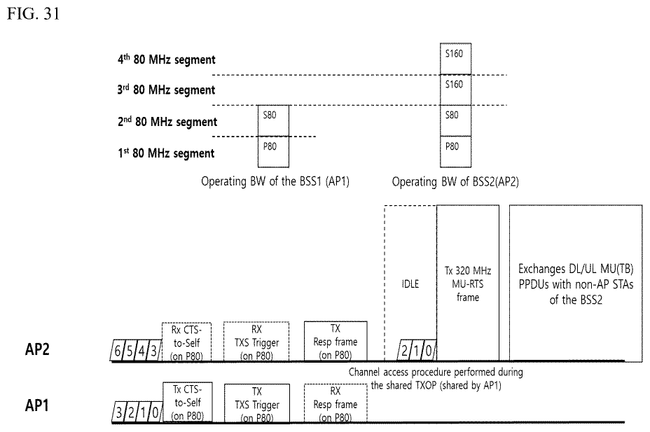

FIG. 31 illustrates an example of an operation of an AP, in which TXOP sharing between APs is performed and BW extension is performed during a shared TXOP according to an embodiment of the present disclosure.

Referring to FIG. 31, an operating BW of AP 1 may be a 160 MHz band corresponding to a 1^{st} 80 MHz segment and a 2^{nd} 80 MHz segment, and an operating BW of AP 2 may be a 320 MHz band including a 1^{st} 80 MHz segment, a 2^{nd} 80 MHz segment, a 3^{rd} 80 MHz segment, and a 4^{th} 80 MHz segment. AP 1 acquires a TXOP by transmitting a CTS-to-self frame for the 1^{st} 80 MHz segment corresponding to its primary 80 MHz band. AP 1 transmits a control frame (the TXS trigger frame of FIG. 31) to share (allocate) the TXOP acquired by AP 1 to AP 2. In this case, the control frame transmitted to AP 2 by AP 1 occupies only the 1^{st} 80 MHz segment and is transmitted, thus AP 2 also responds with a response frame occupying only the 1^{st} 80 MHz segment, and accordingly, a TXOP for 80 MHz corresponding to the 1^{st} 80 MHz segment is allocated to AP 2.

AP 2 invokes/performs/completes a new backoff procedure to acquire an access right for a wider band during the shared TXOP. Accordingly, AP 2 additionally acquires a channel access right for the 2^{nd} 80 MHz Segment, 3^{rd} 80 MHz Segment, 4th 80 MHz segment determined to be idle. AP 2 functions as a TXOP holder for the four 80 MHz segments during the shared TXOP. That is, AP 2 may perform frame exchanging with STAs of its BSS by using the 2^{nd}, 3^{rd}, and 4^{th} 80 MHz segments for which a channel access right has been acquired through a channel access procedure performed by AP 2 by using the shared TXOP as well as the 1^{st} 80 MHz segment in which AP 1 allocates (shares) the TXOP during a time (shared TXOP) allocated by AP 1. In this case, AP 2 may transmit a DL PPDU occupying its entire operation BW (320 MHz) or receive a TB PPDU as a response during the shared TXOP allocated (shared) by AP 1. That is, an RU in the 320 MHz band may be allocated using the trigger frame.

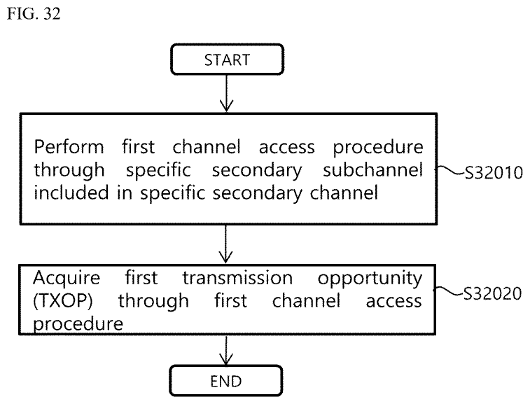

FIG. 32 illustrates an example of an operation of a station according to an embodiment of the present disclosure.

Referring to FIG. 32, a station may perform a channel access procedure through a secondary channel rather than a primary channel.

Specifically, the station may perform a first channel access procedure through a specific secondary subchannel included in a specific secondary channel (S32010). In this case, an entire bandwidth supported by the wireless communication terminal may include one primary channel and one or more secondary channels including the specific secondary subchannel.

Thereafter, the station may acquire a first transmission opportunity (TXOP) through the first channel access procedure (S32020). In this case, the first channel access procedure and the first TXOP may be channel access through the above-described secondary channel and a TXOP, and the frequency range in which the first TXOP is acquired may be limited to the specific secondary subchannel.

The first channel access procedure may be performed when a channel state of a primary subchannel included in the one primary channel is busy and/or the primary subchannel is occupied by an overlapping basic set (OBSS) terminal.

The station may transmit a trigger frame indicating transmission of a frame through multiple subchannels constituting the specific secondary channel to one or more terminals during the TXOP.

When the one or more terminals operate in the one primary channel, the trigger frame may indicate a change from the primary channel to the specific secondary channel. In addition, with respect to the one or more terminals, a bandwidth of the specific secondary channel may not be supported as an operating bandwidth, and the trigger frame may include a field indicating the change from the primary channel to the specific secondary channel.

The station may receive a frame for sharing a second TXOP from a specific terminal, and the second TXOP may be acquired by a second channel access procedure of the specific terminal in the primary subchannel included in the one primary channel.

The frequency range in which the second TXOP is acquired may be the entire bandwidth, and end time points of the first TXOP and the second TXOP may be identical.

The above description of the present disclosure is merely illustrative, and it can be easily understood that those skilled in the art could easily make modifications without departing from the technical concept of the present disclosure or changing essential features. Therefore, the above embodiments should be considered illustrative and should not be construed as limiting. For example, each element described as a single type may be distributed, and likewise, elements described as being distributed may be implemented as a combined form.

The scope of the present disclosure is indicated by the following claims rather than the detailed description, and it should be construed that all changes or modifications derived from the meaning and scope of the claims and their equivalents are included in the scope of the present disclosure.

1. A first terminal comprising:
a transceiver; and
a processor,
wherein the processor is configured to:
receive, from a second terminal, an Initial Control Frame (ICF) to determine whether there is an intention to share a Transmit Opportunity (TXOP) obtained by the second terminal,
transmit, to the second terminal, a response frame in response to the ICF,
wherein the response frame includes a specific field indicating whether there is an intention to participate in the TXOP to perform a frame exchange, and
receive, from the second terminal, a trigger frame for sharing the TXOP when the specific field is set to a value indicating the intention to participate in the TXOP to perform the frame exchange,
wherein a frequency resource to be shared for the TXOP is determined based on an overlapping portion between a first Basic Service Set (BSS) bandwidth of the first terminal and a second BSS bandwidth of the second terminal.

2. The first terminal of claim 1, wherein the processor is further configured to:
perform the frame exchange with one or more stations (STAs) associated with the first terminal within the frequency resource,
wherein the ICF includes Access Category (AC) information indicating an AC used by the second terminal to obtain the TXOP, and
wherein the frame exchange is performed based on the AC information.

3. The first terminal of claim 1,
wherein a first primary 20 MHz channel of the first terminal is included in the second BSS bandwidth of the second terminal.

4. The first terminal of claim 1,
wherein the first primary 20 MHz channel of the first terminal is identical to a second primary 20 MHz channel of the second terminal.

5. The first terminal of claim 1, wherein the processor is further configured to:
perform a negotiation with a STA associated with the first terminal for a specific operation mode to switch an operating subband of the STA from a first subband including a primary channel to a second subband,
wherein the first subband and the second subband are located within the frequency resource of the first BSS bandwidth, and
wherein performing the negotiation includes:
transmitting, to the STA, information offering the second subband, and
receiving, from the STA, a first frame accepting the offered second subband or a second frame requesting a different subband within the frequency resource of the first BSS bandwidth.

6. The first terminal of claim 5,
wherein the first frame accepting the offered second subband is transmitted by the STA on the condition that the STA is ready to operate in the offered second subband.

7. The first terminal of claim 1,
wherein the specific operation mode is enabled after the first frame accepting the offered second subband is transmitted by the STA.

8. The first terminal of claim 5, wherein the processor is further configured to:
receive, from the STA, capability information indicating a minimum padding field length required for the STA to switch to the second subband according to the specific operation mode.

9. A method performed by a first terminal, the method comprising:
receiving, from a second terminal, an Initial Control Frame (ICF) to determine whether there is an intention to share a Transmit Opportunity (TXOP) obtained by the second terminal;
transmitting, to the second terminal, a response frame in response to the ICF,
wherein the response frame includes a specific field indicating whether there is the intention to share the TXOP to perform a frame exchange; and
receiving, from the second terminal, a trigger frame for sharing the TXOP when the specific field is set to a value indicating the intention to share the TXOP to perform the frame exchange,
wherein a frequency resource to be shared for the TXOP is determined based on an overlapping portion between a first Basic Service Set (BSS) bandwidth of the first terminal and a second BSS bandwidth of the second terminal.

10. The method of claim 9, the method further comprising:
performing the frame exchange with one or more stations (STAs) associated with the first terminal within the frequency resource,
wherein the ICF includes Access Category (AC) information indicating an AC used by the second terminal to obtain the TXOP, and
wherein the frame exchange is performed based on the AC information.

11. The method of claim 9,
wherein a first primary 20 MHz channel of the first terminal is included in the second BSS bandwidth of the second terminal.

12. The method of claim 9,
wherein the first primary 20 MHz channel of the first terminal is identical to a second primary 20 MHz channel of the second terminal.

13. The method of claim 9, the method further comprising:
performing a negotiation with a STA associated with the first terminal for a specific operation mode to switch an operating subband of the STA from a first subband including a primary channel to a second subband,
wherein the first subband and the second subband are located within the frequency resource of the first BSS bandwidth, and
wherein performing the negotiation includes:
transmitting, to the STA, information offering the second subband; and
receiving, from the STA, a first frame accepting the offered second subband or a second frame requesting a different subband within the frequency resource of the first BSS bandwidth.

14. The method of claim 13,
wherein the first frame accepting the offered second subband is transmitted by the STA on the condition that the STA is ready to operate in the offered second subband.

15. The method of claim 14,
wherein the specific operation mode is enabled after the first frame accepting the offered second subband is transmitted by the STA.

16. The method of claim 13, the method further comprising:
receiving, from the STA, capability information indicating a minimum padding field length required for the STA to switch to the second subband according to the specific operation mode.

17. The first terminal of claim 8, wherein the processor is further configured to:
transmit, to the STA within the frequency resource of the first BSS bandwidth, a frame instructing the STA to perform the specific operation mode,
wherein the frame includes a padding field having a length equal to or greater than the minimum padding field length.

18. The first terminal of claim 17, wherein the processor is further configured to:
perform the frame exchange with the STA on the second subband within the frequency resource of the first BSS bandwidth after the specific operation mode is performed.

19. The method of claim 16, the method further comprising:
transmitting, to the STA within the frequency resource of the first BSS bandwidth, a frame instructing the STA to perform the specific operation mode,
wherein the frame includes a padding field having a length equal to or greater than the minimum padding field length.

20. The method of claim 19, the method further comprising:
performing the frame exchange with the STA on the second subband within the frequency resource of the first BSS bandwidth after the specific operation mode is performed.
